(19) United States
(12) Patent Application Publication
(10) Pub. No.: US 2016/0292957 A1
(43) Pub. Date: Oct. 6, 2016

(54) GAMING MACHINE WITH PAYLINES SELECTABLE BY BET OPERATION

(71) Applicants: Universal Entertainment Corporation, Tokyo (JP); Aruze Gaming America, Inc., Las Vegas, NV (US)

(72) Inventors: Yukinori INAMURA, Tokyo (JP); Kenji ENOKIDO, Tokyo (JP); Hiromoto YAMAUCHI, Tokyo (JP); Takaki NARITA, Tokyo (JP)

(21) Appl. No.: 15/084,646

(22) Filed: Mar. 30, 2016

(30) Foreign Application Priority Data
Mar. 31, 2015 (JP) 2015-072991
Mar. 31, 2015 (JP) 2015-072992

(51) Int. Cl. G07F 17/32; G07F 17/34

(52) U.S. Cl. CPC G07F 17/3213; G07F 17/34

(57) ABSTRACT

Provided is a gaming machine that achieves a uniform pay rate for the player with any number of activated paylines even though the gaming machine shows a symbol over a plurality of reel strips. The gaming machine selects a kind of element symbols from a plurality of kinds of element symbols based on the number of paylines activated with an input device, reconfigures symbol arrays to be displayed by replacing to-be replaced symbols included in the symbol arrays with the selected kind of element symbols, starts scrolling the to-be displayed symbol arrays while showing the selected kind of element symbols in the second display manner.

### CROSS-REFERENCE TO RELATED APPLICATIONS

This application claims the benefit of Japanese Patent Application No. 2015-072991 filed on Mar. 31, 2015, Japanese Patent Application No. 2015-072992, filed on Mar. 31, 2015, which applications are incorporated herein by reference in their entirety.

### TECHNICAL FIELD

The present invention relates to a gaming machine with paylines selectable by a bet operation.

### BACKGROUND ART

In gaming machines, whether a winning pattern is completed is determined with the kinds and arrangement of symbols rearranged after being scrolled. If a winning pattern is completed, a prize is provided to the player. Accordingly, players expect completion of winning patterns as many as possible in playing games.

There exists a gaming machine having a reel strip with a same kind of symbols disposed consecutively to show the consecutive symbols in rearrangement (for example, refer to US Patent Application Publication No. 2014/094250). Rearranging the consecutive symbols produces possibility of simultaneous completion of winning patterns on multiple paylines. Completion of winning patterns on multiple paylines leads to more prizes; the players feel more expectation.

There exists another gaming machine having a reel strip with a symbol longer than normal symbols to show the entire long symbol in rearrangement, instead of showing consecutively disposed same kind of symbols (for example, refer to US Patent Application Publication No. 2014/094251). Although showing a symbol longer than normal symbols visually attracts the player's interest, completion of a winning pattern is determined based on the paylines passing through the plurality of normal-sized symbols obtained by dividing the long symbol. Accordingly, there is no difference from the case of showing the symbols originally having the normal size.

### SUMMARY OF INVENTION

### Technical Problem

As described above, the winning patterns when a long symbol is shown on a reel strip are the same as the winning patterns when a plurality of normal-sized consecutive symbols are shown, achieving no distinction. However, showing a long symbol visually attracts the player's interest; an approach to show a wide symbol over a plurality of reel strips can be conceived of.

Each payline to determine whether a winning pattern is completed is also defined over a plurality of reel strips. Accordingly, the symbol lying over a plurality of reel strips has more chance to overlap with the extending directions of paylines. As described above, gaming machines have a plurality of paylines to provide more prizes. Increasing paylines increases paylines overlapping with other paylines. A symbol lying over a plurality of reel strips equals the same kind of symbols aligned in a horizontal direction; the symbol lying over a plurality of reel strips increases the chance to simultaneously complete multiple winning patterns on a plurality of paylines.

As described above, increasing paylines increases paylines overlapping with other paylines. Depending on the manner or extent of overlapping of the paylines, paylines are grouped into paylines that easily complete a winning pattern and paylines that hardly complete a winning pattern. The paylines that easily complete a winning pattern provides high pay rates to the players and the paylines that hardly complete a winning pattern provides low pay rates to the player. Accordingly, employing a symbol disposed over a plurality of reel strips leads to existence of paylines with high pay rate for the players and paylines with low pay rate for the players.

In the meanwhile, there exists another gaming machine in which the number of paylines to be activated is selectable with a bet operation. The paylines to be selected are predetermined in association with bet operations. Accordingly, the unbalance between the paylines that easily complete a winning pattern and the paylines that hardly complete a winning pattern might become larger depending on the grouping of paylines to be selected. As a result, the difference in the pay rate for the players might become larger between the paylines with high pay rate and the paylines with low pay rate.

The present invention has been accomplished in view of the foregoing issues; an object of the present invention is to provide a gaming machine that achieves a uniform pay rate for the player with any number of activated paylines even though the gaming machine shows a symbol over a plurality of reel strips.

### Solution to Problem

The first aspect of the present invention is a gaming machine comprising:

a symbol display device capable of displaying a game result by rearranging a plurality of types of symbols using a first display manner to show a symbol on a scroll line and a second display manner to show a plurality of symbols as one symbol over a plurality of scroll lines,

a controller capable of executing a game by controlling the symbol display device to scroll symbol arrays including a plurality of symbols,

an input device capable of inputting an instruction to select one or more paylines to be activated from a plurality of paylines associated with the symbol display device, and

a memory holding data of symbols included in the symbol arrays. The plurality of types of symbols include element symbols that are capable of completing a winning pattern and to-be replaced symbols that are to be replaced by element symbols; and

the controller is programmed to perform the following processing of:

(1-1) symbol lottery processing to determine to-be stopped symbols,

(1-2) element symbol lottery processing to select a kind of element symbols from a plurality of kinds of element symbols based on a number of paylines activated with the input device,

(1-3) symbol array reconfiguration processing to configure symbol arrays to be displayed by replacing the to-be replaced symbols included in the symbol arrays with the element symbols selected in the element symbol lottery processing of the processing (1-2),

(1-4) starting scrolling the to-be displayed symbol arrays while showing element symbols of the kind selected in the element symbol lottery processing of the processing (1-2) in the second display manner, and

(1-5) providing a prize based on a payline that completes a winning pattern.

A kind of element symbols are selected from a plurality of kinds of element symbols based on the number of activated paylines and displayed in the second display manner. Since the element symbols are displayed in the second display manner to show one element symbol, many paylines can run through the element symbol. Increasing the paylines increases the probability of completion of a winning pattern.

Furthermore, selection of a kind of element symbols is based on the number of paylines. The selected element symbols are capable of completing multiple winning patterns on a plurality of paylines. Even if the gaming machine has paylines to easily complete a winning pattern and paylines to hardly complete a winning pattern, specifying the prizes for the winning patterns of this element symbol as appropriate eliminates the gap among the paylines and achieves a uniform pay rate for the player.

Still further, the element symbols are displayed in the second display manner to show one symbol over a plurality of scroll lines, which visually attracts the player's interest.

The second aspect of the present invention is the gaming machine in the first aspect of the present invention, in which,

the scroll lines include a scroll line of a first type for showing a symbol array in the first display manner and scroll lines of a second type for showing symbol arrays in the second display manner; and

the memory further holds a symbol selection probability table that specifies probabilities to select a combination of a kind of element symbols for the first type of scroll line and a kind of element symbols for the second type of scroll lines depending on the number of paylines.

A combination of a kind of element symbols for the first type of scroll line and a kind of element symbols for the second type of scroll lines is selected together through one element symbol lottery. The lottery processing is simplified. Even if the paylines to complete winning patterns are increased because of the symbols shown in the second display manner, specifying the prizes for the winning patterns related to the individual combinations of a kind of element symbols for the first type of scroll line and a kind of element symbols for the second type of scroll line as appropriate eliminates the gap among the paylines, achieving a uniform pay rate for the player.

The third aspect of the present invention is the gaming machine in the second aspect of the present invention, in which,

the to-be replaced symbols include:
a first kind of to-be replaced symbols disposed on the first type of scroll line and to be shown in the first display manner, and
a second kind of to-be replaced symbols disposed on the second type of scroll line and to be shown in the second display manner; and

the symbol array reconfiguration processing of the processing (1-3) includes:
replacing the first kind of to-be replaced symbols on the first type of scroll line with the selected kind of element symbols shown in the first display manner, and
replacing the second kind of to-be replaced symbols on the second type of scroll line with the selected kind of element symbols shown in the second display manner.

The to-be replaced symbols are applicable to both of the first display manner or the second display manner. Replacing a to-be replaced symbol with an element symbol increases the paylines to complete winning patterns.

The fourth aspect of the present invention is the gaming machine in the first aspect of the present invention, in which,

the plurality of types of symbols further include blank symbols that are involved with neither completion of winning patterns nor symbol replacement;

the symbol arrays include symbol arrays of a first type including element symbols and symbol arrays of a second type including blank symbols and to-be replaced symbols;

the symbol array reconfiguration processing of the processing (1-3) is to configure the second type of symbol arrays to be displayed by replacing the to-be replaced symbols on the second type of symbol arrays with element symbols selected in the element symbol lottery processing of the processing (1-2); and

the scrolling the symbol arrays in the processing (1-4) includes:
stacking the symbols on the first type of symbol arrays and the symbols on the second type of symbol arrays to-be displayed in scrolling the symbol arrays,
selectively showing an element symbol on a to-be displayed symbol array of the second type in a case where an element symbol on a symbol array of the first type and the element symbol on the to-be displayed symbol array of the second type are stacked, and
selectively showing an element symbol on a symbol array of the first type in a case where the element symbol on the symbol array of the first type and a blank symbol on a to-be displayed symbol array of the second type are stacked.

Element symbols are selected through the element symbol lottery processing and the symbols on the first type of symbol arrays and the symbols on the second type of symbol arrays to be displayed are stacked in displaying the symbol arrays. Displayed symbol arrays can be different in each unit game to prevent completed winning patterns from becoming monotonous. Furthermore, since the element symbols on the second type of symbol arrays are shown selectively, the gap among the paylines can be eliminated by symbol replacement to achieve a uniform pay rate for the player.

### Advantageous Effects of Invention

A gaming machine of the present invention achieves a uniform pay rate for the player independently from the number of activated paylines even if the gaming machine shows a symbol over a plurality of reel strips.

### BRIEF DESCRIPTION OF DRAWINGS

FIG. 1A is a diagram for illustrating a general configuration of a gaming machine;

FIG. 1B is a diagram for illustrating a general configuration of a gaming machine;

FIG. 2 is an elevation view of a slot machine;

FIG. 3 is a perspective view of the slot machine;

FIG. 4 is a perspective view of a control panel;

FIG. 5 is a block diagram of a circuitry of the slot machine;

FIG. 6 is a block diagram of a circuitry of the slot machine;

FIG. 7 is a block diagram of a circuitry of the slot machine;

FIG. 8 is a diagram of a general configuration of a game system;

FIG. 9 is a block diagram of the game system;

FIG. 10 is a block diagram of a PTS system;

FIG. 11 is a diagram for illustrating state transitions in the gaming machine;

FIG. 12 is an example of a payline definition table;

FIG. 13 is an example of a payout table;

FIG. 14A is a chart for illustrating a reel strip configuration;

FIG. 14B is a chart for illustrating a reel strip configuration;

FIG. 15 is a chart for illustrating a reel strip configuration;

FIG. 16 is a chart for illustrating a reel strip configuration;

FIG. 17A is a chart for illustrating a reel strip configuration;

FIG. 17B is a chart for illustrating a reel strip configuration;

FIG. 17C is a chart for illustrating a reel strip configuration;

FIG. 18A is a chart for illustrating a reel strip configuration;

FIG. 18B is a chart for illustrating a reel strip configuration;

FIG. 18C is a chart for illustrating a reel strip configuration;

FIG. 19A is a chart for illustrating a reel strip configuration;

FIG. 19B is a chart for illustrating a reel strip configuration;

FIG. 19C is a chart for illustrating a reel strip configuration;

FIG. 20 is a flowchart for providing an outline of symbol replacement and appeal rewrite;

FIG. 21 is a flowchart of main control processing in the gaming machine;

FIG. 22 is a flowchart of coin-insertion/start check processing;

FIG. 23 is a flowchart of symbol lottery processing;

FIG. 24 is a flowchart of replacement symbol lottery processing;

FIG. 25 is a flowchart of appeal rewrite processing;

FIG. 26 is a flowchart of symbol display control processing

FIG. 27 is a flowchart of payout determination processing;

FIG. 28 is a flowchart of free game mode processing;

FIG. 29 is a flowchart of re-spin feature game mode processing;

FIG. 30 is a table for providing patterns of multipliers for prizes;

FIG. 31 is a table for indicating the number of paylines to be activated depending on the operation button;

FIG. 32A-1 is a table for providing a replacement symbol determination table;

FIG. 32A-2 is a table for providing a replacement symbol determination table;

FIG. 32B-1 is a table for providing a replacement symbol determination table;

FIG. 32B-2 is a table for providing a replacement symbol determination table;

FIG. 32C-1 is a table for providing a replacement symbol determination table;

FIG. 32C-2 is a table for providing a replacement symbol determination table;

FIG. 32D-1 is a table for providing a replacement symbol determination table;

FIG. 32D-2 is a table for providing a replacement symbol determination table;

FIG. 32E-1 is a table for providing a replacement symbol determination table;

FIG. 32E-2 is a table for providing a replacement symbol determination table;

FIG. 32F-1 is a table for providing a replacement symbol determination table;

FIG. 32F-2 is a table for providing a replacement symbol determination table;

FIG. 32G-1 is a table for providing a replacement symbol determination table;

FIG. 32G-2 is a table for providing a replacement symbol determination table;

FIG. 32H-1 is a table for providing a replacement symbol determination table;

FIG. 32H-2 is a table for providing a replacement symbol determination table;

FIG. 32I-1 is a table for providing a replacement symbol determination table;

FIG. 32I-2 is a table for providing a replacement symbol determination table;

FIG. 32J-1 is a table for providing a replacement symbol determination table;

FIG. 32J-2 is a table for providing a replacement symbol determination table;

FIG. 32K-1 is a table for providing a replacement symbol determination table;

FIG. 32K-2 is a table for providing a replacement symbol determination table;

FIG. 32L-1 is a table for providing a replacement symbol determination table;

FIG. 32L-2 is a table for providing a replacement symbol determination table;

FIG. 32M-1 is a table for providing a replacement symbol determination table;

FIG. 32M-2 is a table for providing a replacement symbol determination table;

FIG. 32N-1 is a table for providing a replacement symbol determination table;

FIG. 32N-2 is a table for providing a replacement symbol determination table;

FIG. 32O-1 is a table for providing a replacement symbol determination table;

FIG. 32O-2 is a table for providing a replacement symbol determination table;

FIG. 32P-1 is a table for providing a replacement symbol determination table;

FIG. 32P-2 is a table for providing a replacement symbol determination table;

FIG. 33A-1 is a table for providing a replacement symbol determination table;

FIG. 33A-2 is a table for providing a replacement symbol determination table;

FIG. 33B-1 is a table for providing a replacement symbol determination table;

FIG. 33B-2 is a table for providing a replacement symbol determination table;

FIG. 33C-1 is a table for providing a replacement symbol determination table;

FIG. 33C-2 is a table for providing a replacement symbol determination table;

FIG. 33D-1 is a table for providing a replacement symbol determination table;

FIG. 33D-2 is a table for providing a replacement symbol determination table;

FIG. 33E-1 is a table for providing a replacement symbol determination table;

FIG. 33E-2 is a table for providing a replacement symbol determination table;

FIG. 33F-1 is a table for providing a replacement symbol determination table;

FIG. 33F-2 is a table for providing a replacement symbol determination table;

FIG. 33G-1 is a table for providing a replacement symbol determination table;

FIG. 33G-2 is a table for providing a replacement symbol determination table;

FIG. 33H-1 is a table for providing a replacement symbol determination table;

FIG. 33H-2 is a table for providing a replacement symbol determination table;

FIG. 33I-1 is a table for providing a replacement symbol determination table;

FIG. 33I-2 is a table for providing a replacement symbol determination table;

FIG. 34 is a diagram for illustrating stop positions of symbols;

FIG. 35A is a diagram for illustrating examples where a mighty symbol is displayed;

FIG. 35B is a diagram for illustrating examples where a mighty symbol is displayed;

FIG. 35C is a diagram for illustrating examples where a mighty symbol is displayed;

FIG. 36A is a diagram for illustrating an example where WILD symbols are displayed;

FIG. 36B is a diagram for illustrating an example where WILD symbols are displayed;

FIG. 37A is a diagram for illustrating an example where a mighty symbol is displayed;

FIG. 37B is a diagram for illustrating an example where a mighty symbol is displayed;

FIG. 37C is a diagram for illustrating an example where a mighty symbol is displayed;

FIG. 38 is a diagram for illustrating a state where a normal reel strip 3n and a replacement reel strip 3x are stacked;

FIG. 39 is a conceptual diagram for illustrating a process of replacing symbols;

FIG. 40 is a diagram for illustrating a concept of appeal rewrite in re-spin feature game mode;

FIG. 41 is a diagram for illustrating a process of appeal rewrite;

FIG. 42A is replacement symbol determination tables to be referred to in free game mode;

FIG. 42B is replacement symbol determination tables to be referred to in free game mode;

FIG. 42C is replacement symbol determination tables to be referred to in free game mode;

FIG. 42D is replacement symbol determination tables to be referred to in free game mode;

FIG. 42E is replacement symbol determination tables to be referred to in free game mode;

FIG. 43 is a table to be referred to when “random” is selected; and

FIG. 44 is a replacement symbol determination table to be referred to in free game mode.

### DESCRIPTION OF EMBODIMENTS

Hereinafter, embodiments are described based on the drawings.

### Aspects 1-1 to 1-4 of Present Invention

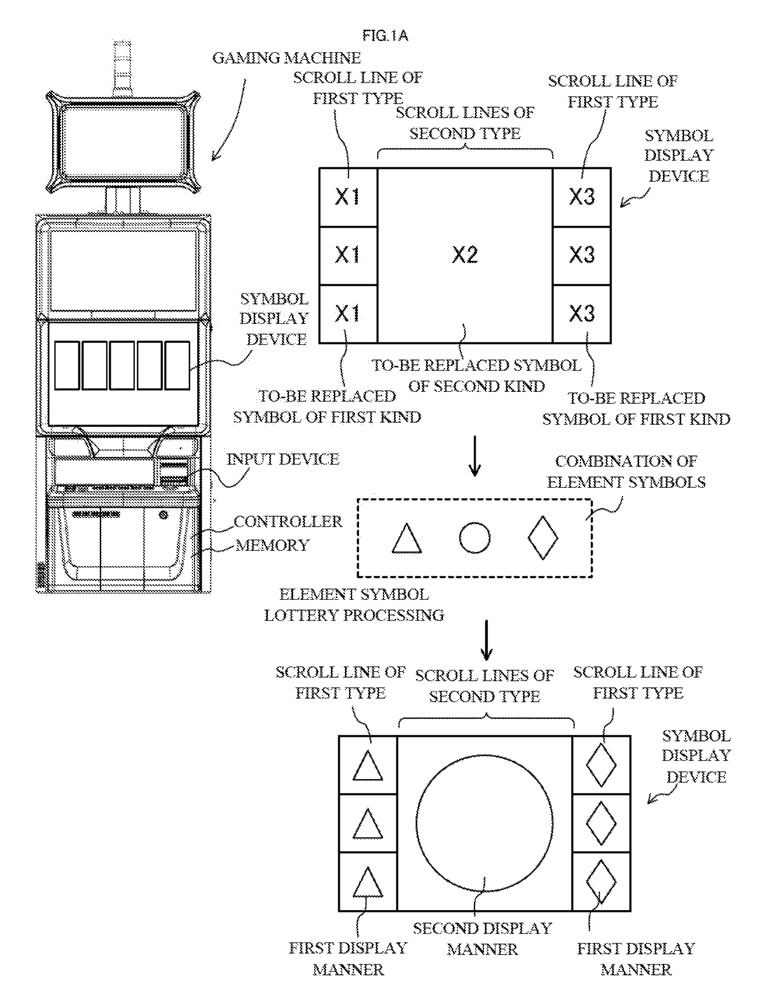

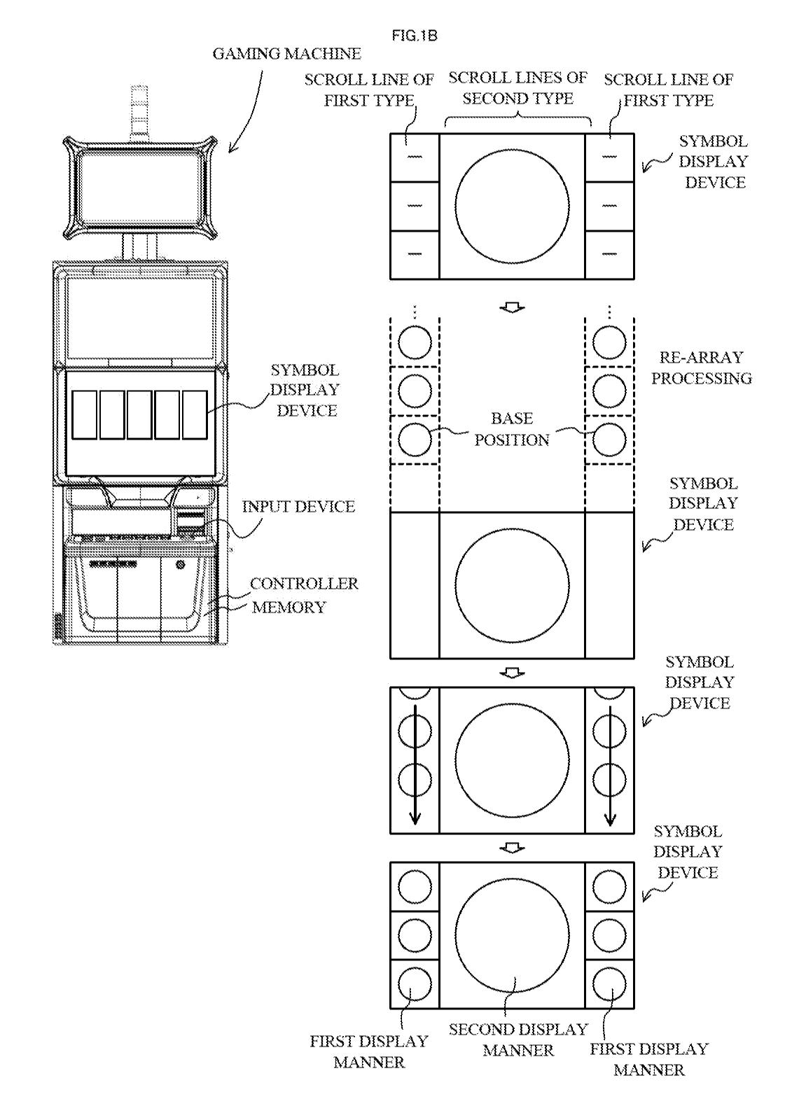

FIG. 1A is a diagram for illustrating a general representation of aspects 1-1 to 1-4 of the present invention.

The aspect 1-1 of the present invention is a gaming machine (e.g., a slot machine 10 to be described later) comprising:

a symbol display device (e.g., a lower display device 141 to be described later) capable of displaying a game result by rearranging a plurality of types of symbols using a first display manner (e.g., a normal size for one frame) to show a symbol on a scroll line and a second display manner (e.g., a size of 3×3 of nine frames) to show a plurality of symbols as one symbol over a plurality of scroll lines,

a controller (e.g., a controller 100 or a processor AM10 to be described later) capable of executing a game by controlling the symbol display device to scroll symbol arrays including a plurality of symbols,

an input device (e.g., five operation buttons CP2 to CP6 to be described later) capable of inputting an instruction to select one or more paylines to be activated from a plurality of paylines associated with the symbol display device, and

a memory (e.g., a main RAM 210 to be described later) holding data of symbols included in the symbol arrays.

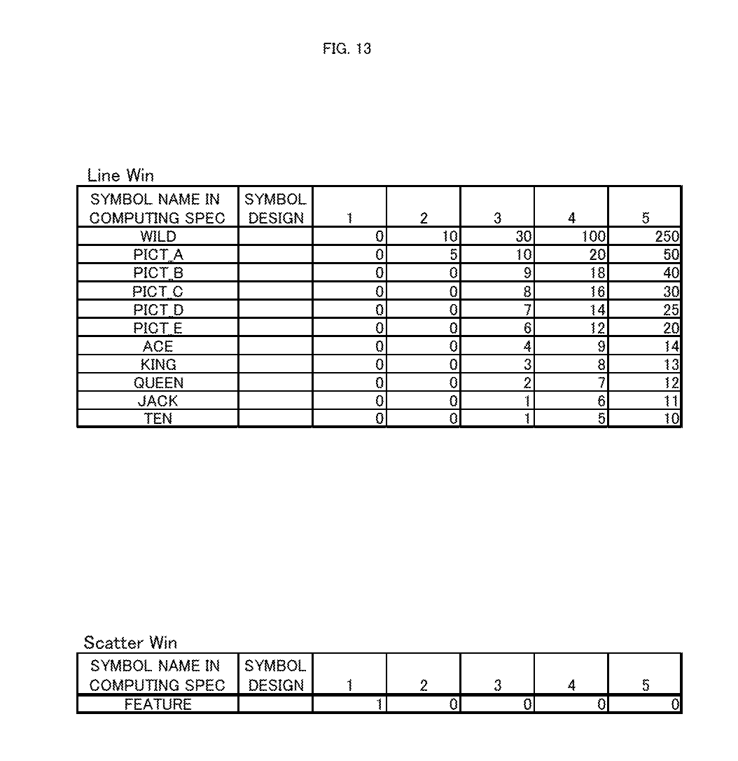

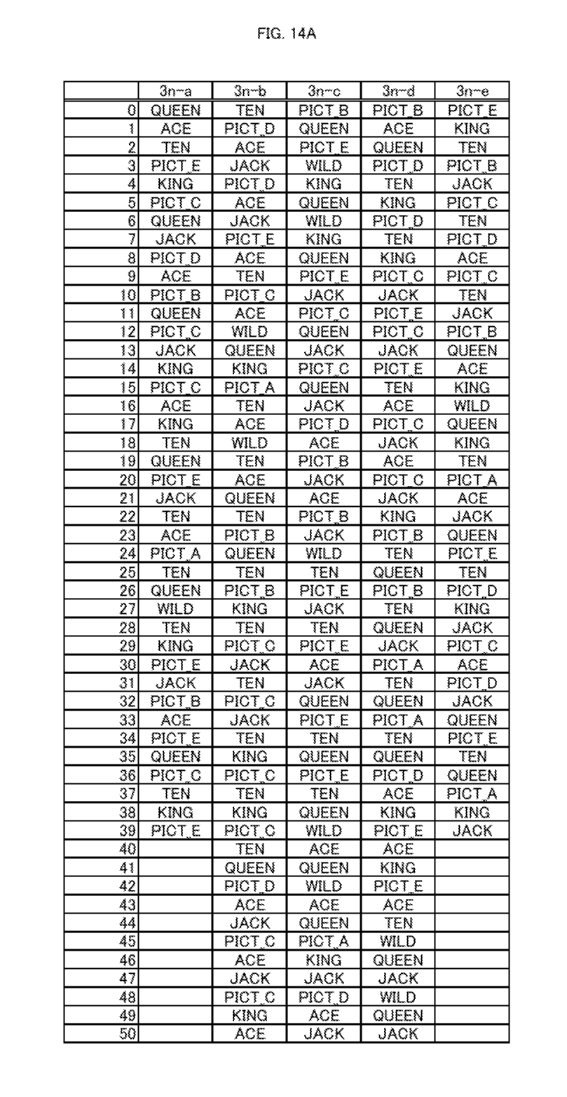

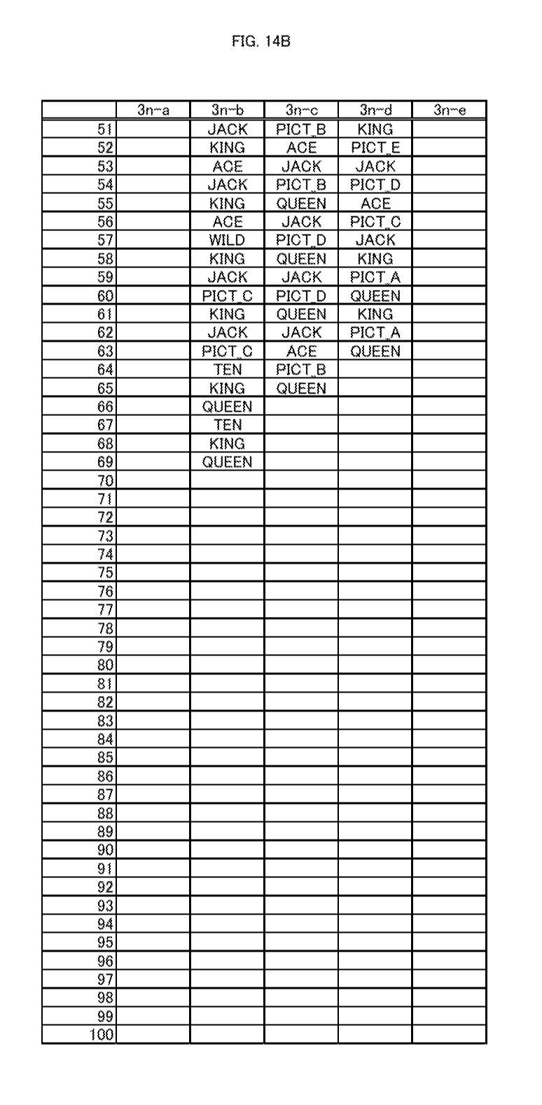

The plurality of types of symbols include element symbols (e.g., WILD, PICT_A, PICT_B, PICT_C, PICT_D, PICT_E, ACE, KING, QUEEN, JACK, TEN, and FEATURE symbols to be described later) that are capable of completing a winning pattern (e.g., a pattern in FIG. 13 to be described later) and to-be replaced symbols (e.g., CHANGE and M_CHANGE symbols to be described later) that are to be replaced by element symbols; and

the controller is programmed to perform the following processing of:

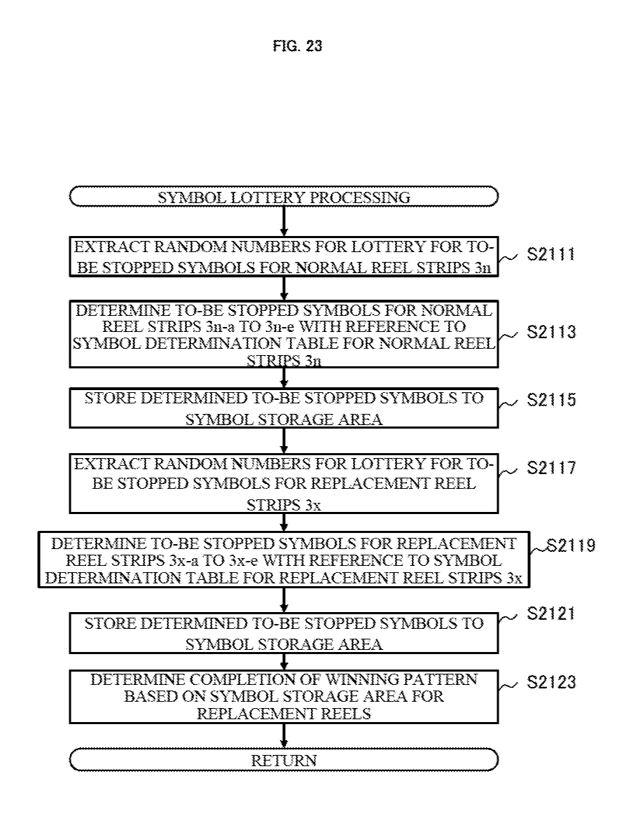

(1-1) symbol lottery processing (e.g., symbol lottery processing in FIG. 23 to be described later) to determine to-be stopped symbols,

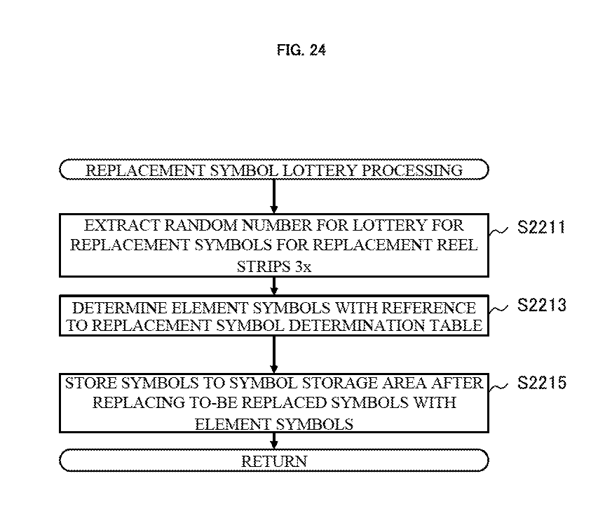

(1-2) element symbol lottery processing (e.g., steps S2211 and S2213 in FIG. 24 to be described later) to select a kind of element symbols from a plurality of kinds of element symbols based on a number of paylines activated with the input device,

(1-3) symbol array reconfiguration processing (e.g., step S2215 in FIG. 24 to be described later) to configure symbol arrays to be displayed by replacing the to-be replaced symbols included in the symbol arrays with the element symbols selected in the element symbol lottery processing of the processing (1-2),

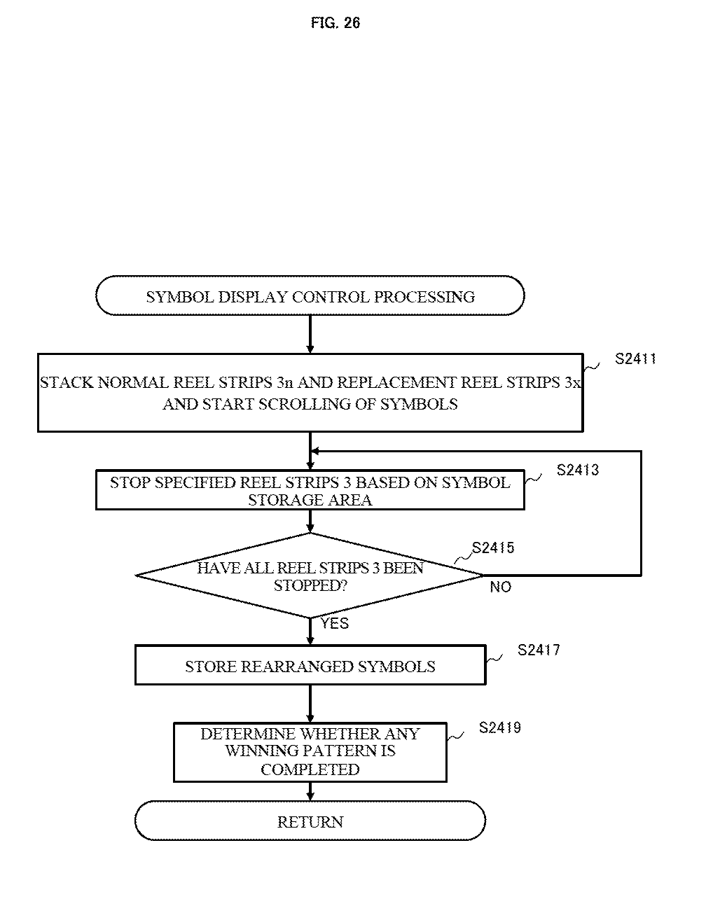

(1-4) starting scrolling the to-be displayed symbol arrays while showing element symbols of the kind selected in the element symbol lottery processing of the processing (1-2) in the second display manner (e.g., symbol display control processing in FIG. 26 to be described later), and

(1-5) providing a prize based on a payline that completes a winning pattern (e.g., step S1925 to be described later).

As illustrated in FIG. 1, the gaming machine includes a symbol display device, a controller, an input device, and a memory.

The symbol display device displays a game result by rearranging a plurality of types of symbols. The plurality of types of symbols are displayed using a first display manner and a second display manner.

The first display manner shows a symbol on a scroll line. The first display manner displays each symbol to be shown within the scroll line. The second display manner shows a plurality of symbols as one symbol over a plurality of scroll lines. The second display manner shows a symbol extending off a scroll line to occupy the adjoining scroll line(s) as well. The requirement for the number of scroll lines for the symbol to occupy is to be a plural number. The second display manner shows a symbol in a shape extending in a lateral (horizontal) direction.

The controller executes a game by controlling the symbol display device to scroll symbol arrays including a plurality of symbols.

The input device is a device for a player to input an instruction to select one or more paylines to be activated from a plurality of paylines. For example, a device capable of inputting the instruction through the player's operation is preferred. A plurality of paylines are associated with the symbol display device. Each payline is a line to determine an alignment of symbols out of the symbols rearranged in the symbol display device. Whether any winning pattern is completed is determined with the symbols aligned along a payline.

The memory holds data of symbols included in the symbol arrays. For example, the memory holds data of designs of the symbols and data for identifying the symbols. The symbols include element symbols and to-be replaced symbols. The element symbols are capable of completing a winning pattern. The to-be replaced symbols are to be replaced by element symbols. A symbol array is composed of a plurality of symbols arrayed in a specific order. For example, element symbols and to-be replaced symbols are disposed to form a symbol array.

Displaying a symbol array moving along a scroll line corresponds to scrolling the symbols. The scroll line corresponds to a reel such as a so-called video reel or mechanical reel. The symbol array corresponds to a plurality of symbols disposed on a reel.

The controller performs symbol lottery processing (1-1) to determine to-be stopped symbols. The to-be stopped symbols are symbols included in the rearranged symbols; stopping the to-be stopped symbols at predetermined positions results in showing all the symbols to be rearranged in a stopped state on the symbol display device.

The controller selects a kind of element symbols from a plurality of kinds of element symbols by lottery (1-2). The element symbols are determined based on the number of activated paylines. The element symbols to be selected can be configured differently between in the case where a small number of paylines are activated and in the case where a large number of paylines are activated.

The controller configures symbol arrays to be displayed (1-3) by replacing the to-be replaced symbols included in the symbol arrays with the element symbols selected in the element symbol lottery processing of the processing (1-2). The to-be replaced symbols are not to be seen by the player but to be replaced by element symbols. In order to be seen by the player, the to-be displayed symbol arrays are configured by replacing the to-be replaced symbols with the element symbols.

The controller starts scrolling the to-be displayed symbol arrays while showing the element symbols in the second display manner (1-4) and provides a prize based on a payline that completes a winning pattern (1-5).

According to the above-described configuration, a kind of element symbols are selected from a plurality of kinds of element symbols based on the number of activated paylines (1-2) and displayed in the second display manner (1-4), so that an element symbol is shown over a plurality of scroll lines. Since one element symbol is shown over a plurality of scroll lines in the second display manner, many paylines can run through the element symbol. Increasing the paylines increases the probability of completion of a winning pattern.

Furthermore, a kind of element symbols are selected based on the number of paylines (1-2). These element symbols are capable of completing multiple winning patterns on a plurality of paylines. Even if the gaming machine has paylines to easily complete a winning pattern and paylines to hardly complete a winning pattern, specifying the prizes for the winning patterns of this element symbol as appropriate eliminates the gap among the paylines and achieves a uniform pay rate for the player.

Still further, the element symbols are displayed in the second display manner to show one symbol over a plurality of scroll lines, which visually attracts the player's interest.

The aspect 1-2 of the present invention is the gaming machine in the aspect 1-1 of the present invention, in which,

the scroll lines include a scroll line of a first type (e.g., video reels 3a or 3e to be described later) for showing a symbol array in the first display manner and scroll lines of a second type (e.g., video reels 3b to 3d to be described later) for showing symbol arrays in the second display manner; and

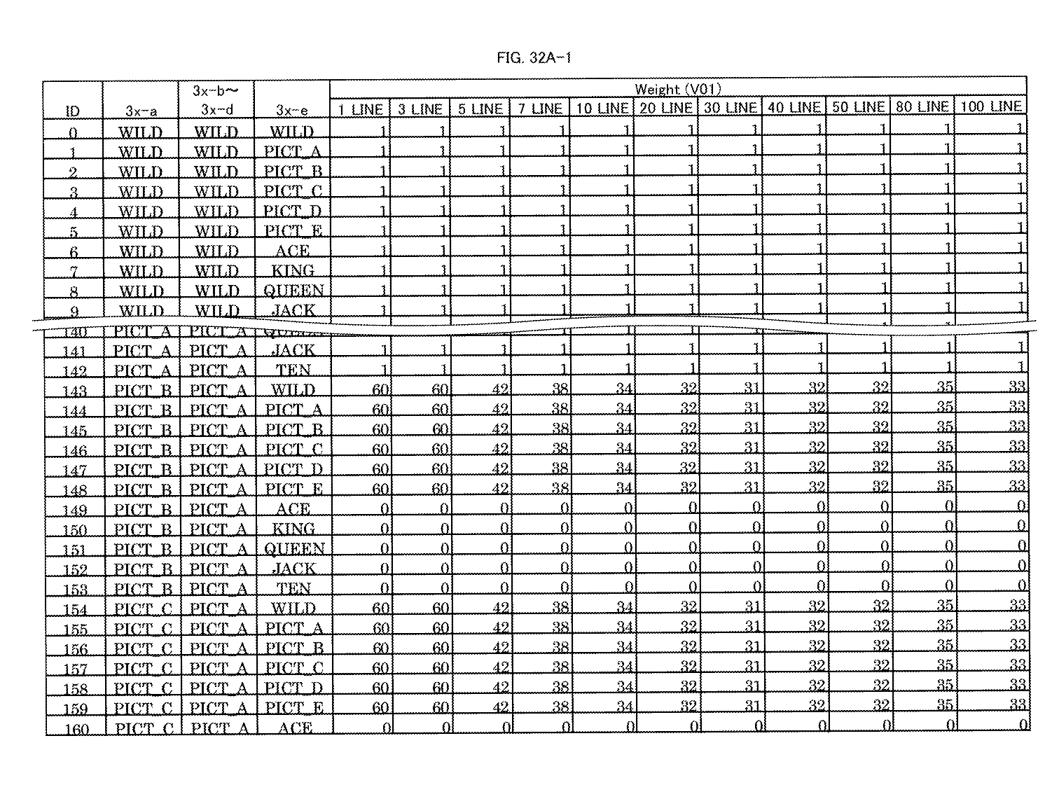

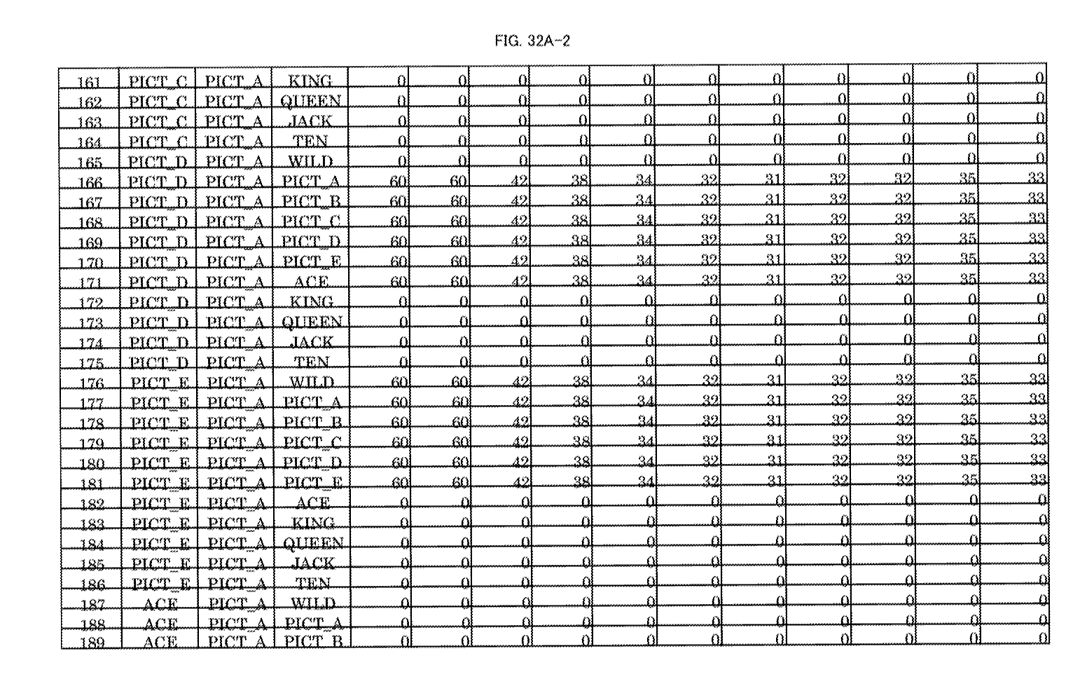

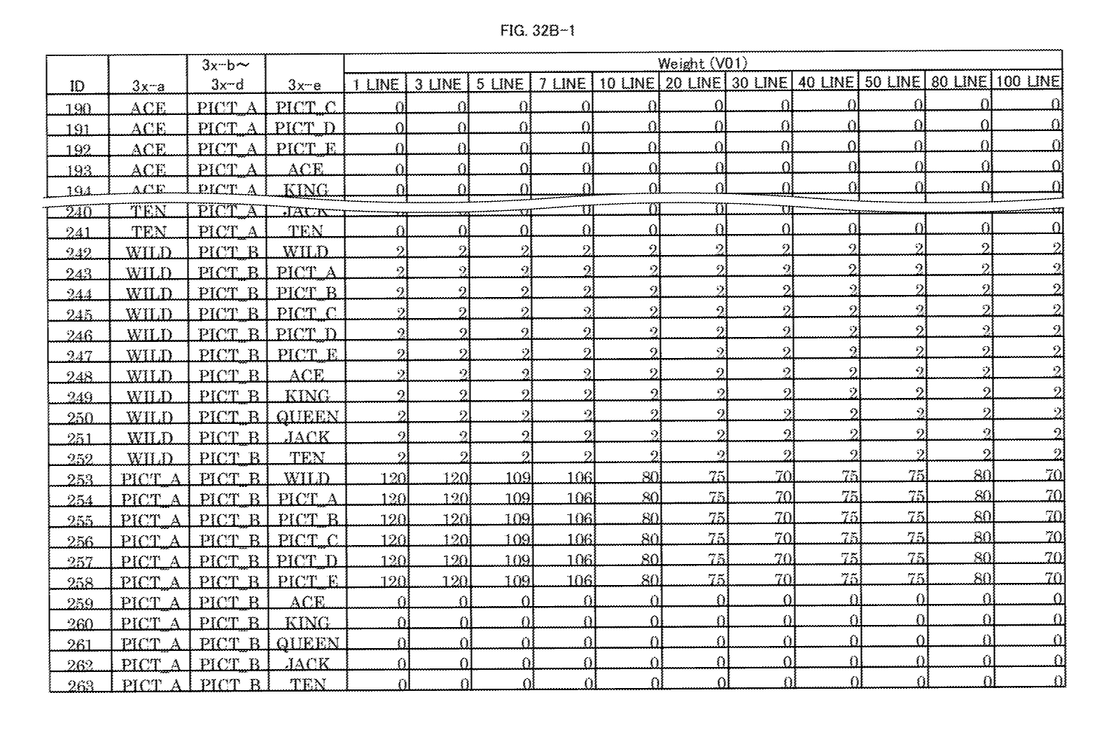

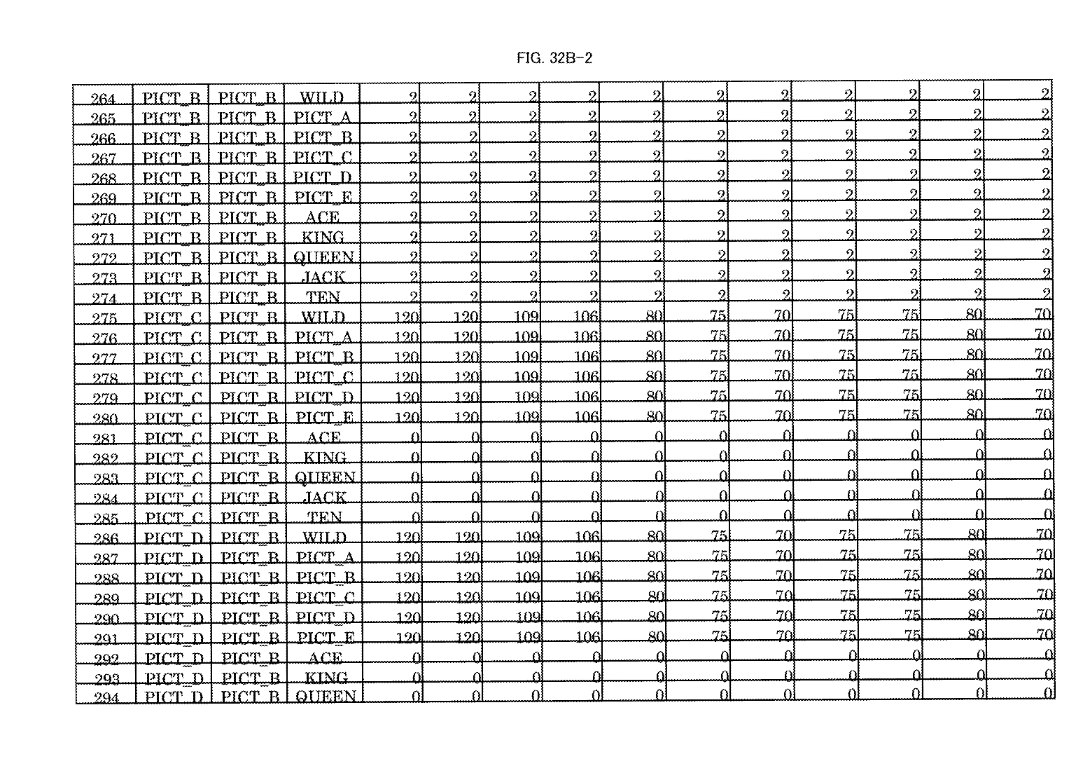

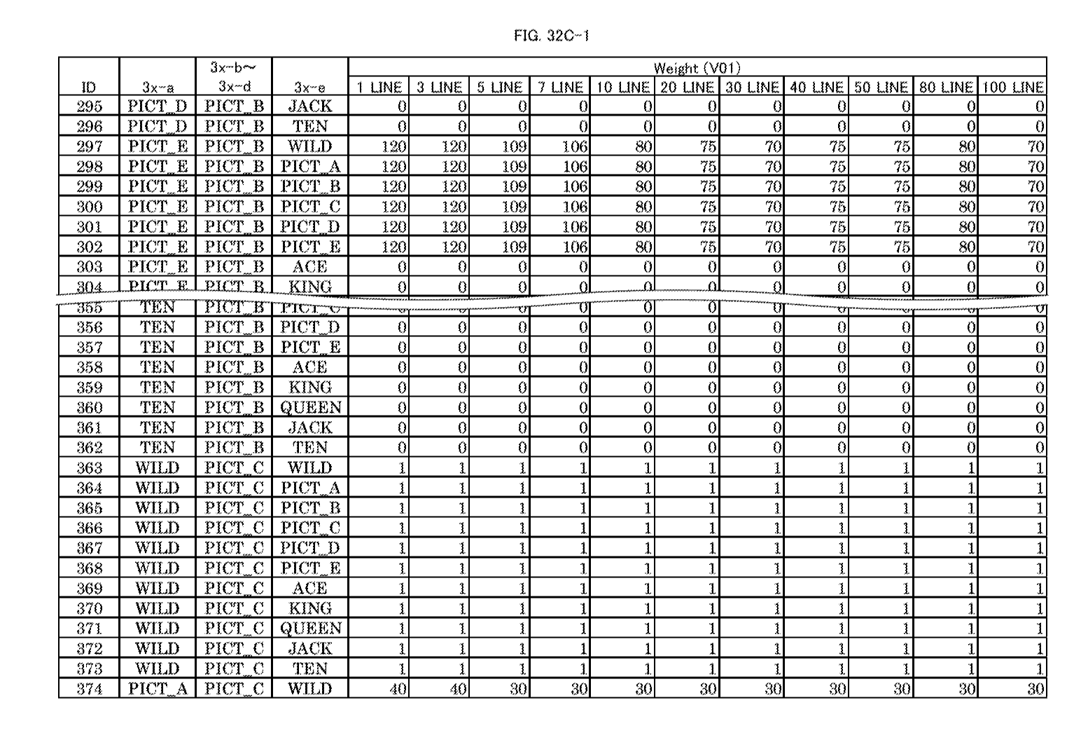

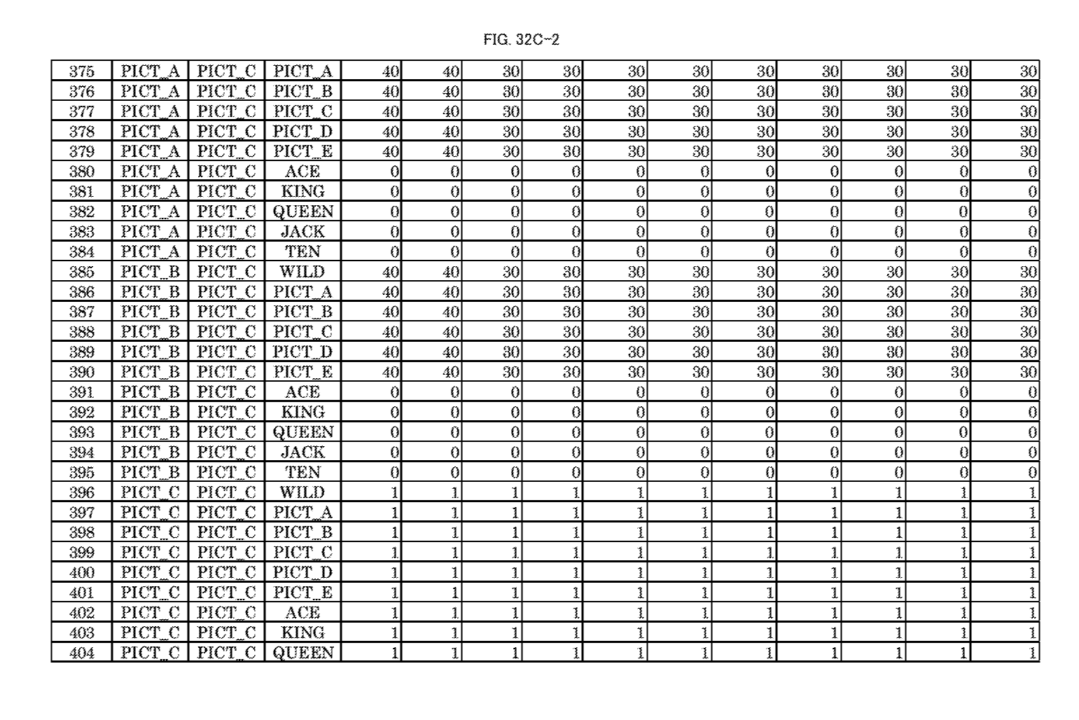

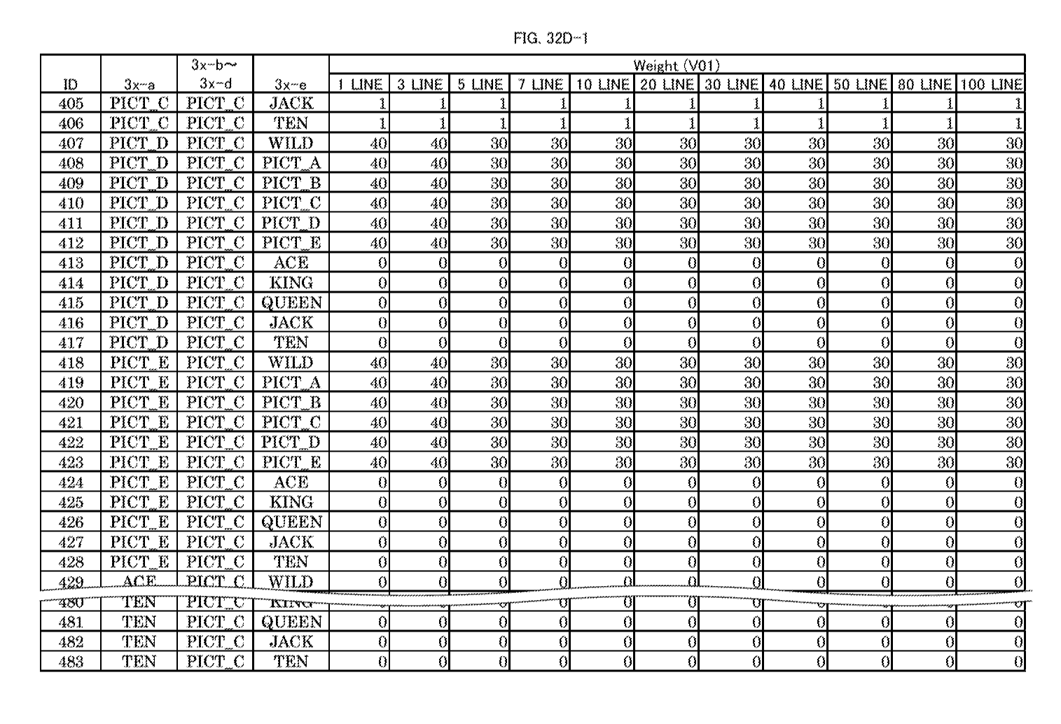

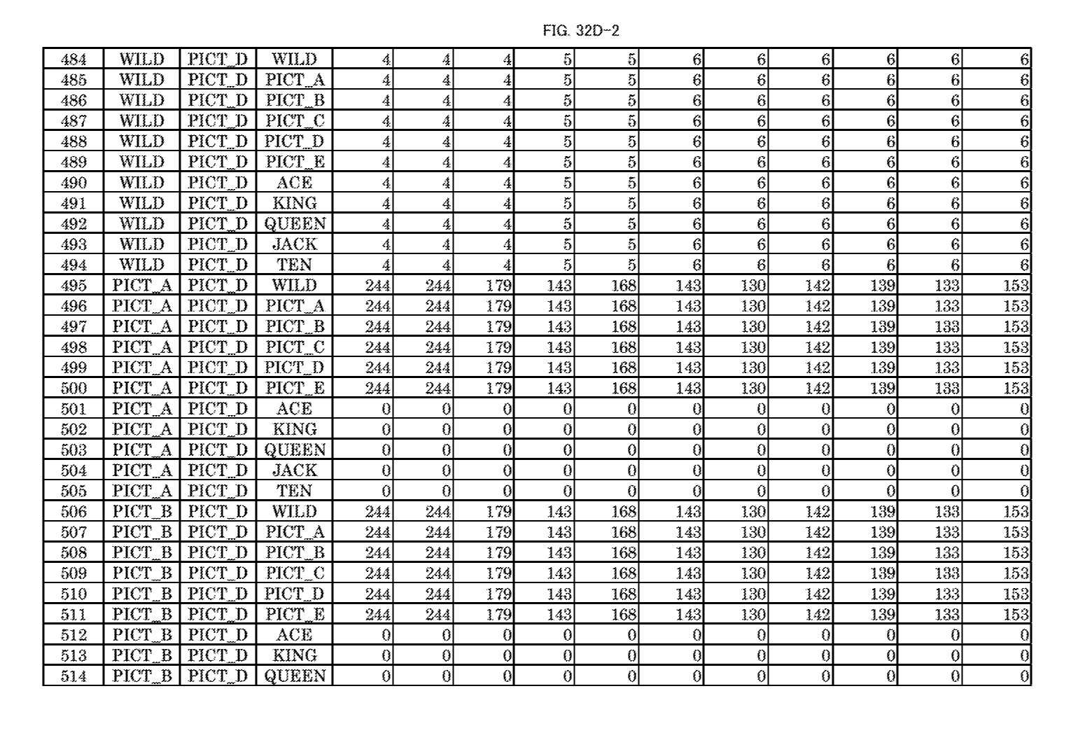

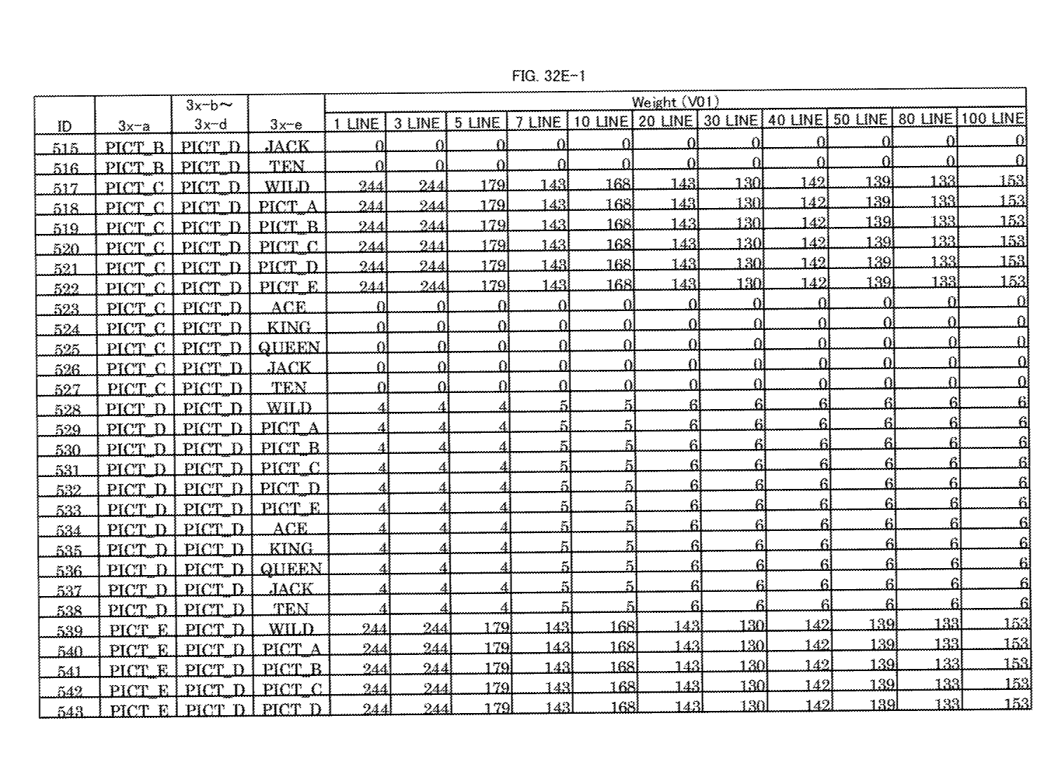

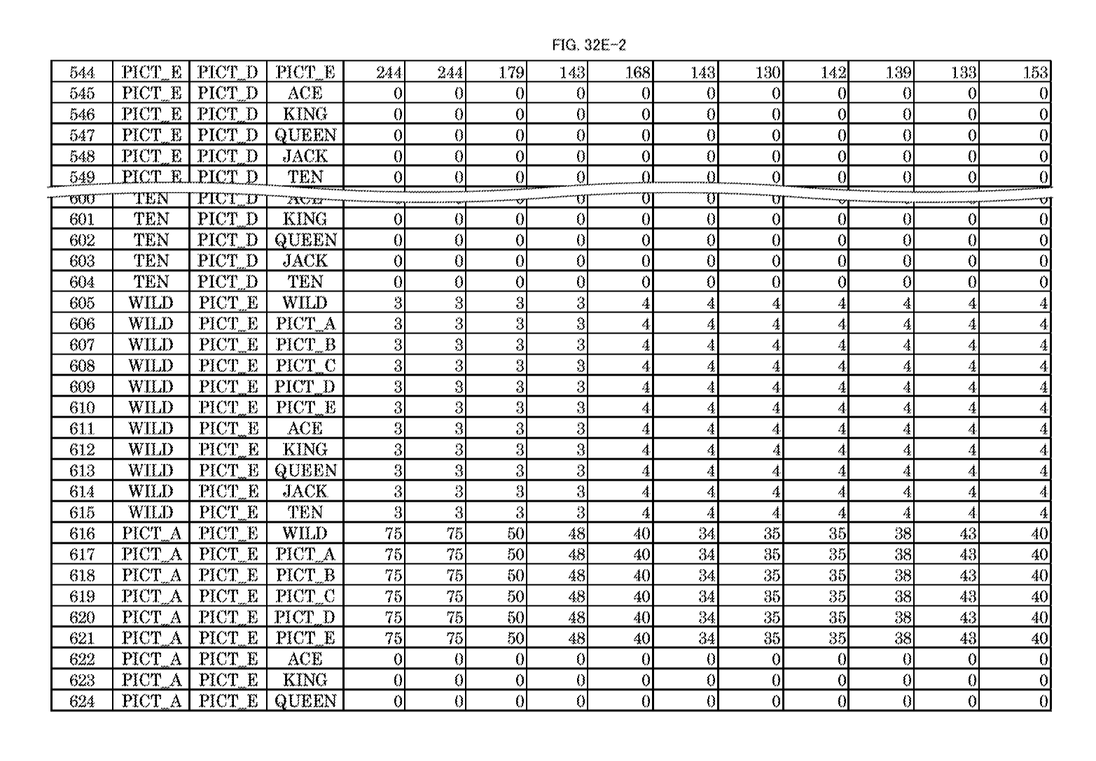

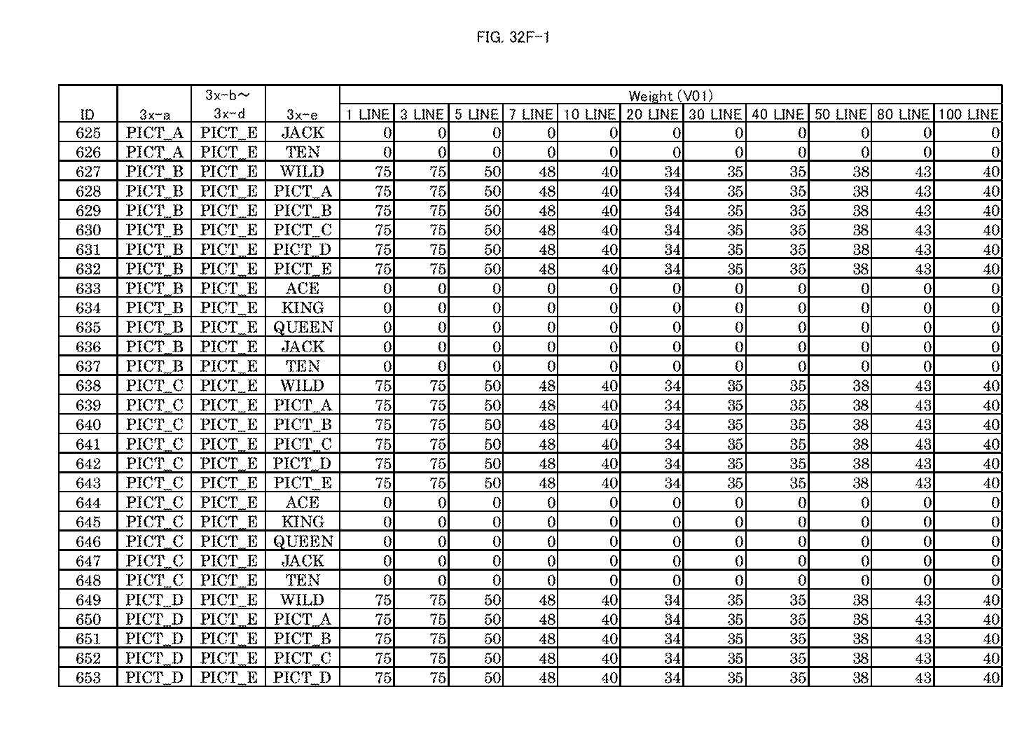

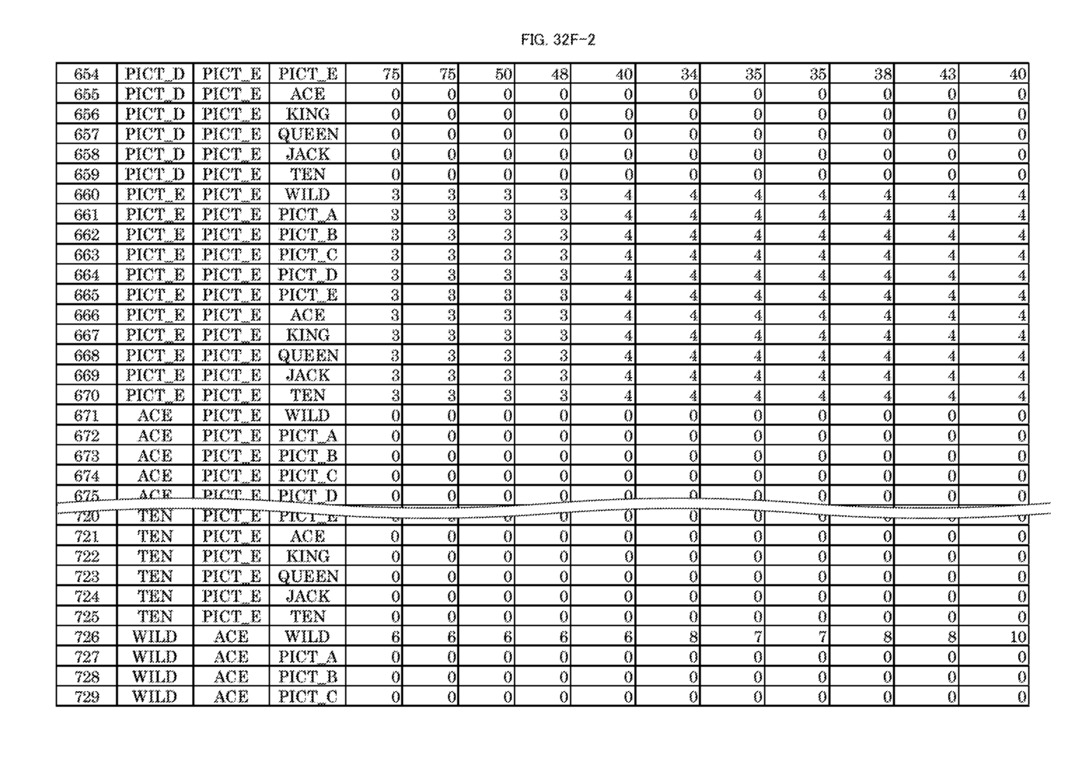

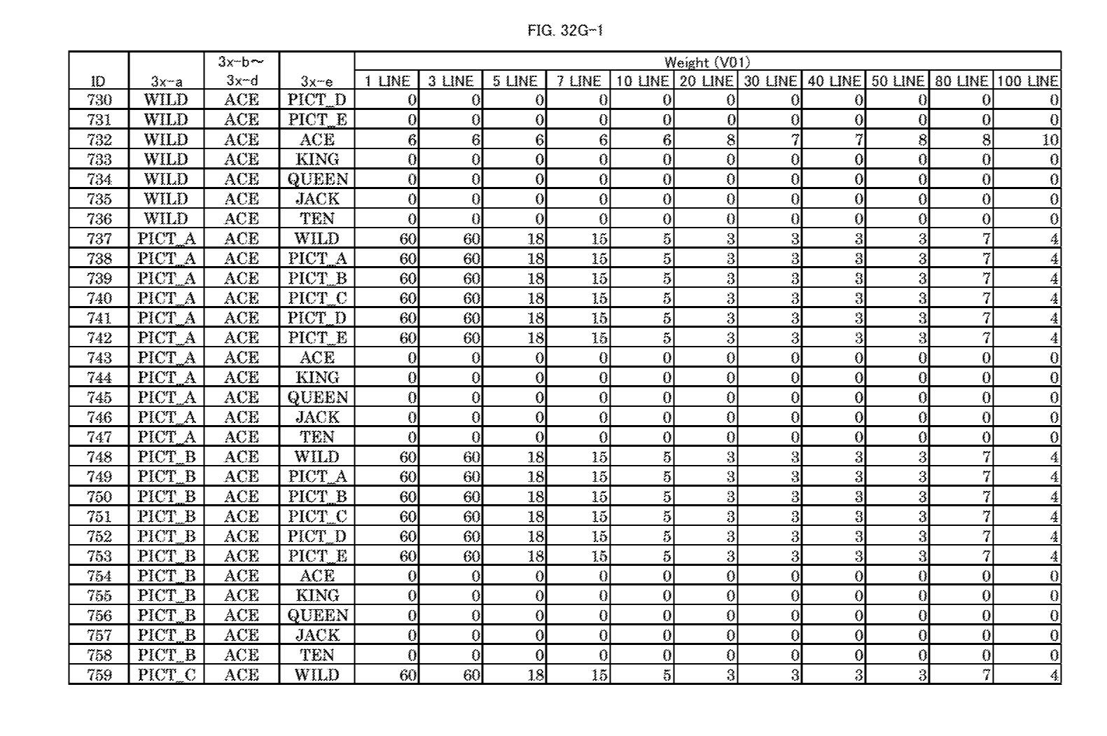

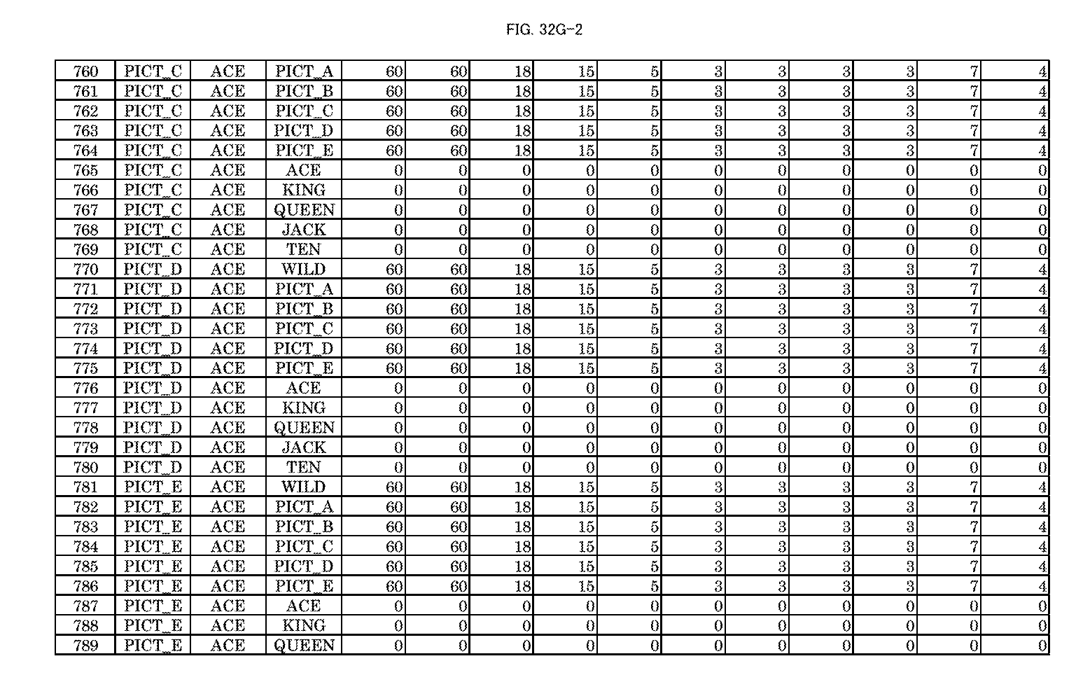

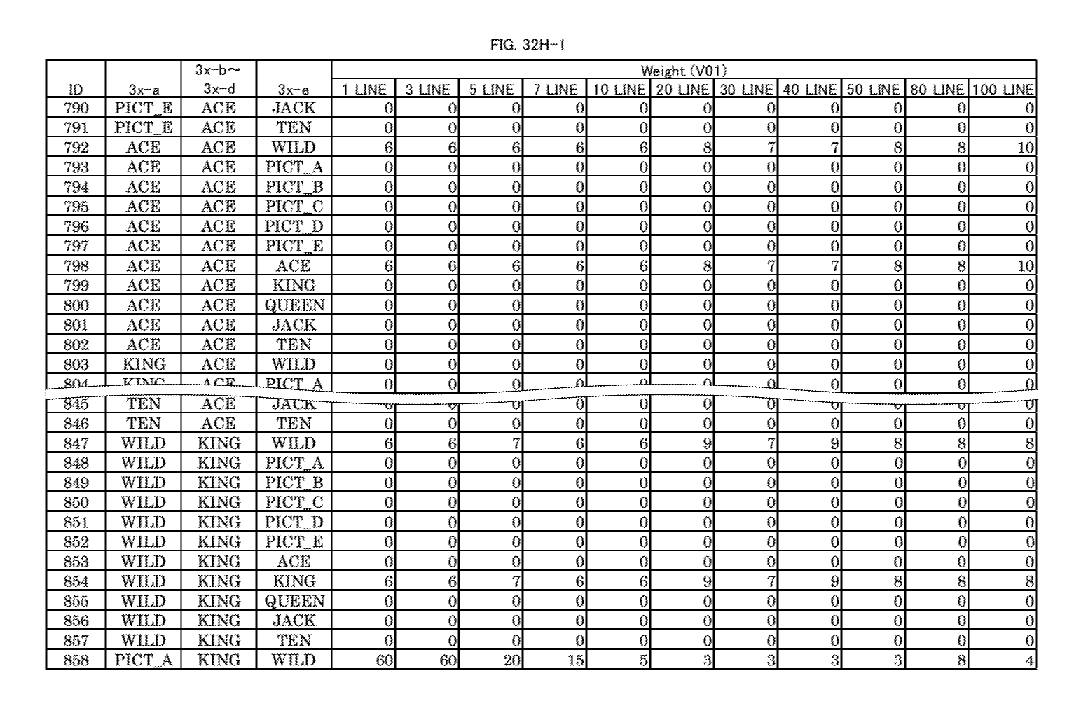

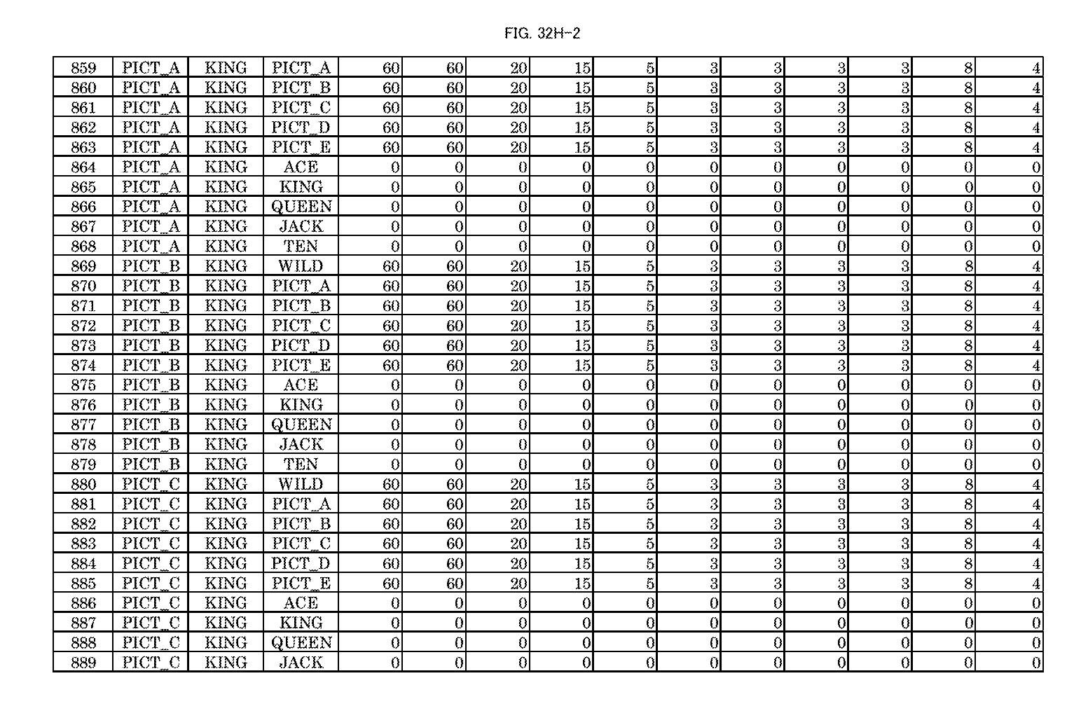

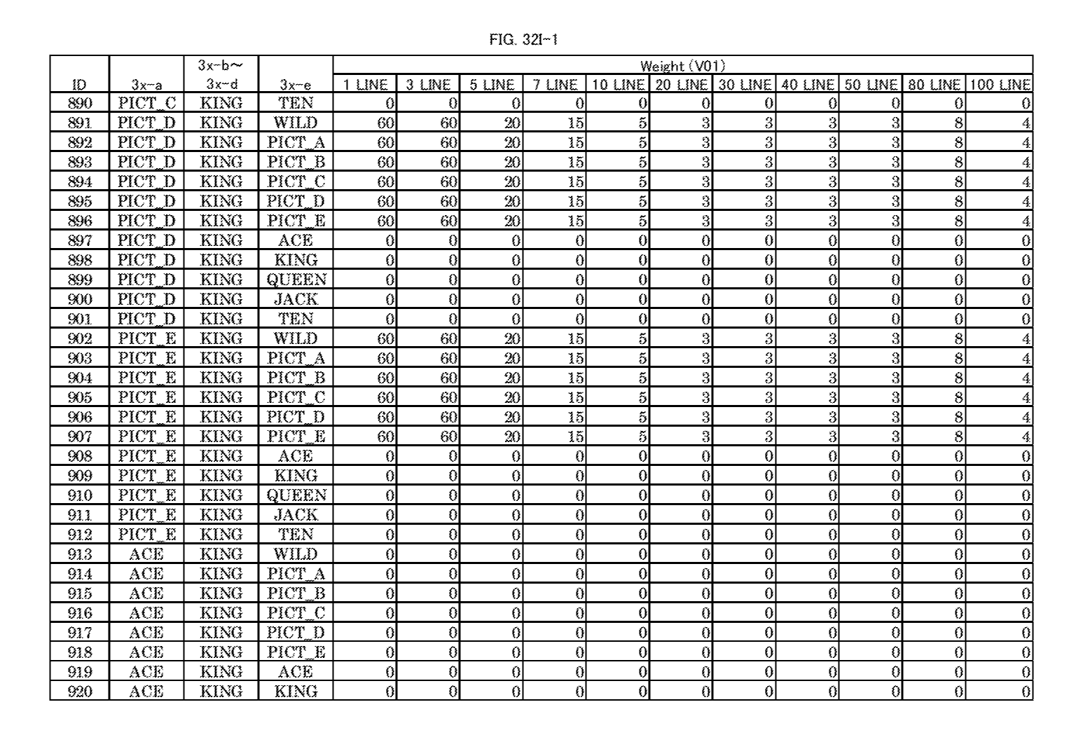

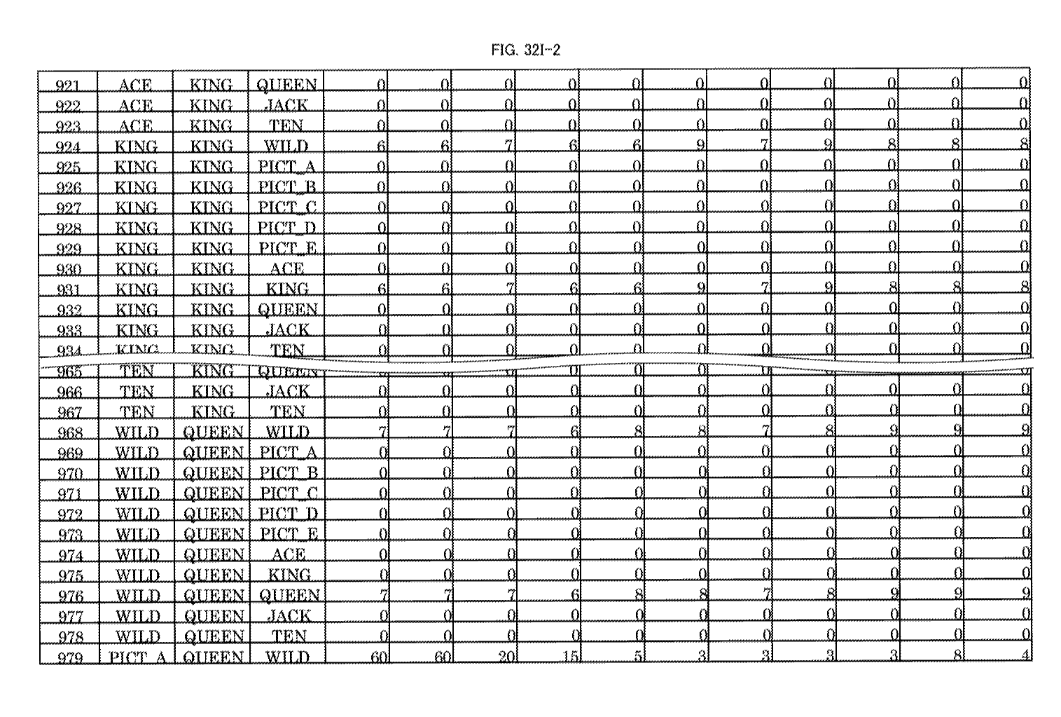

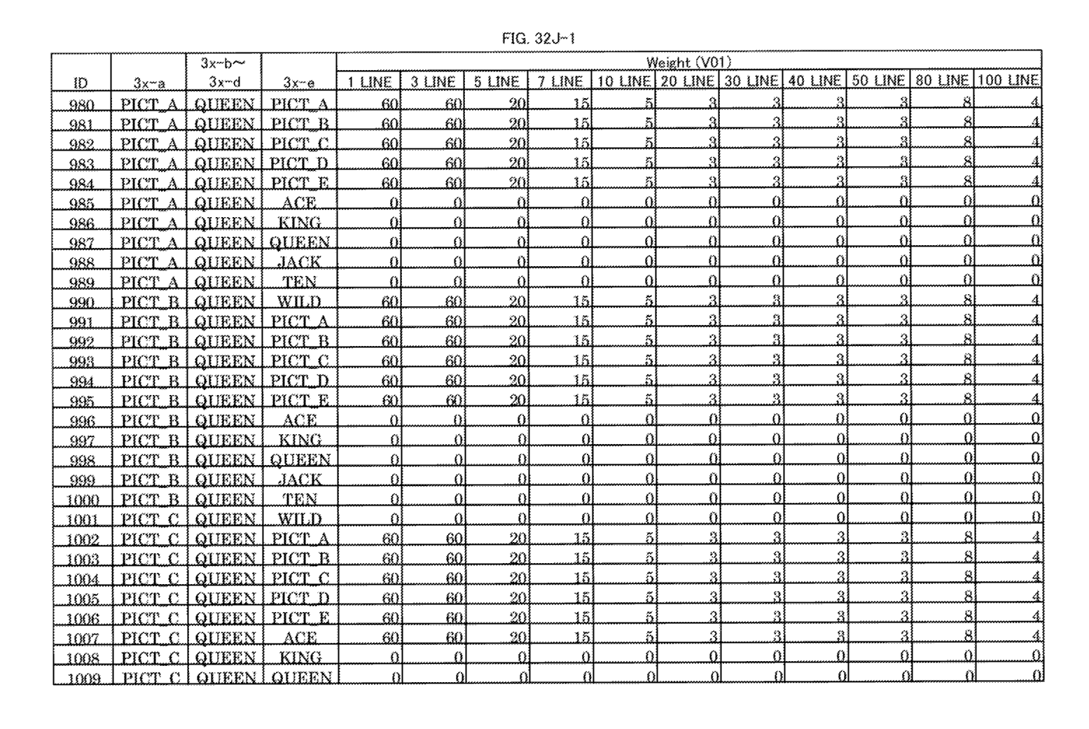

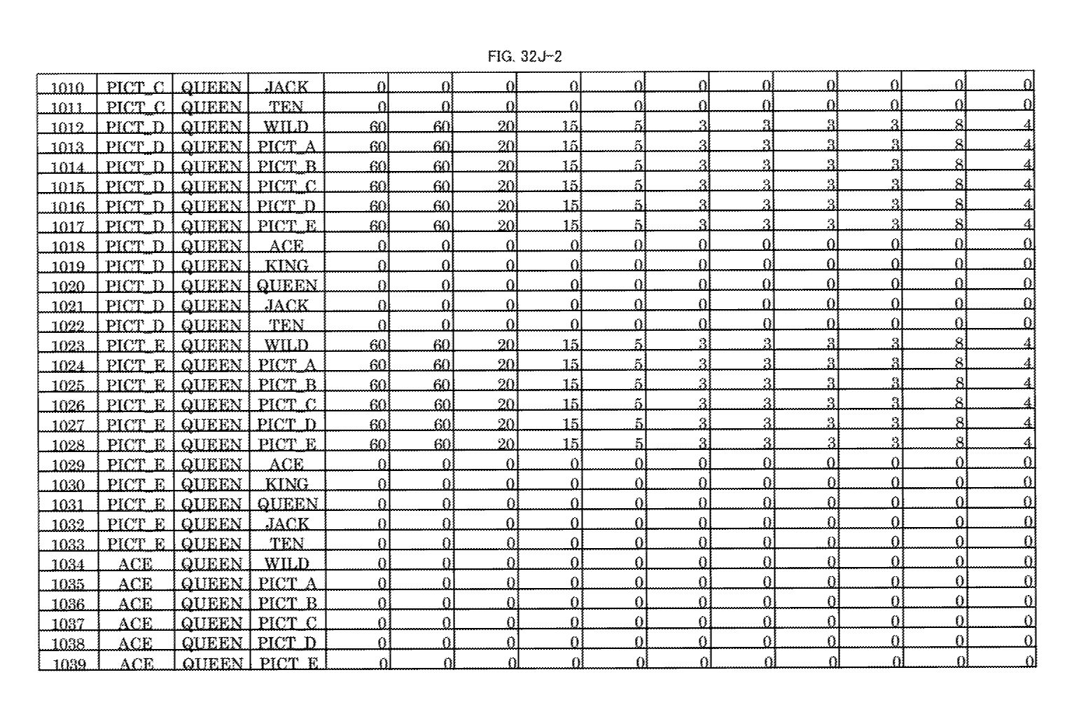

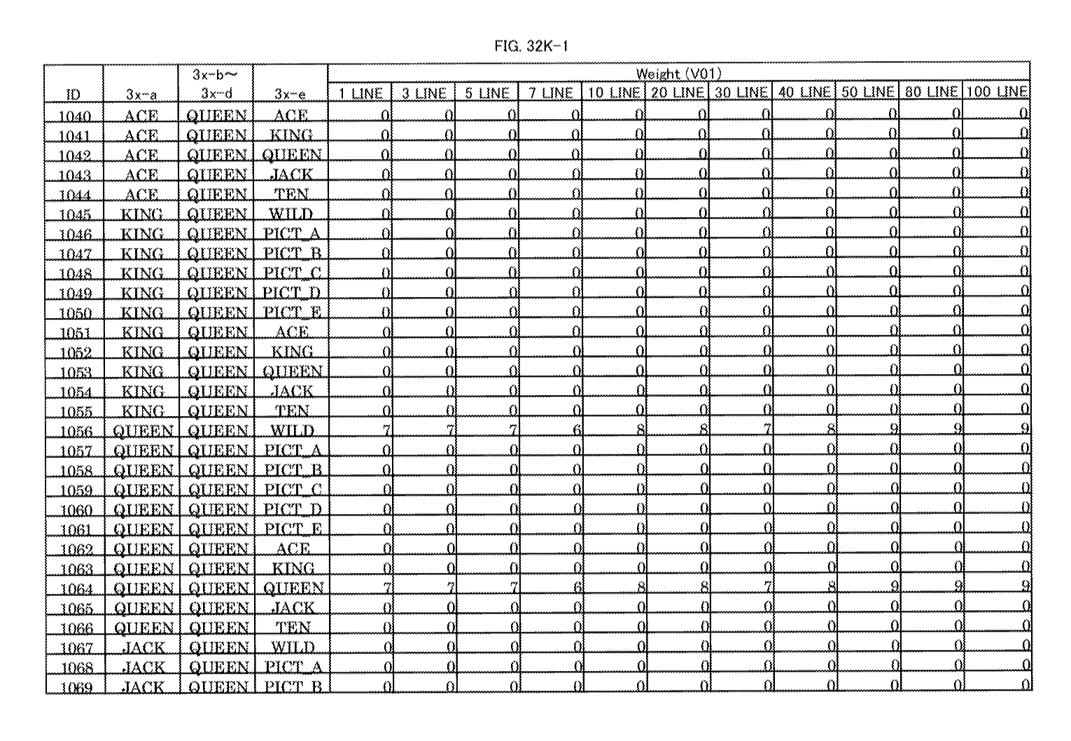

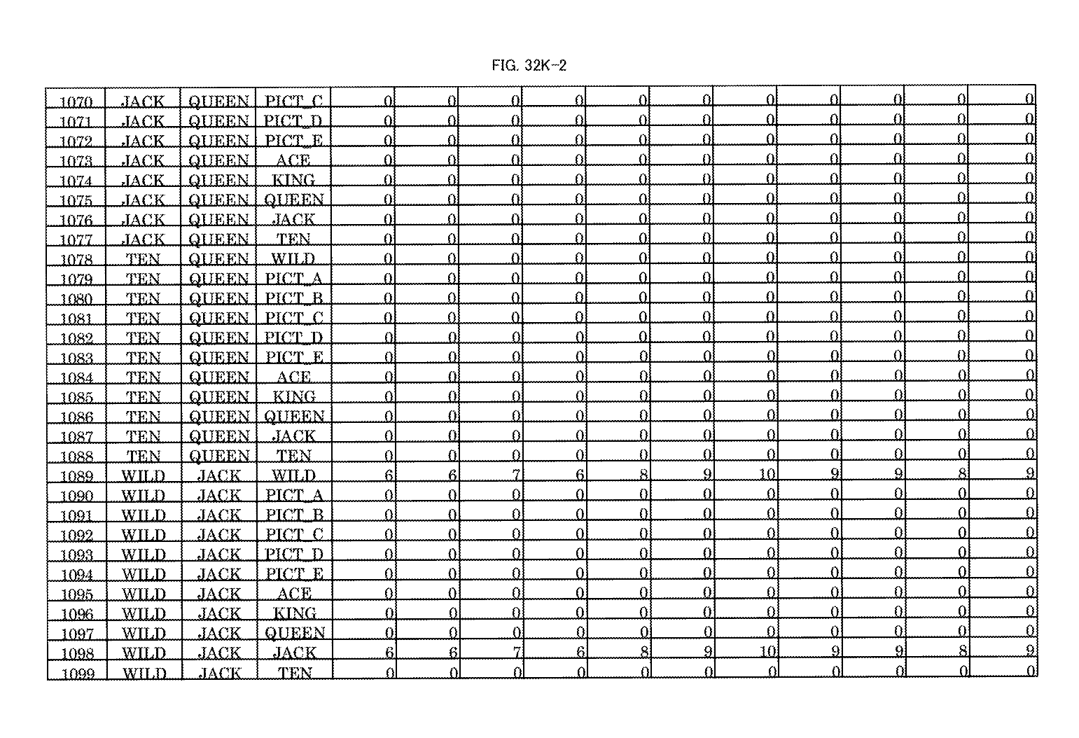

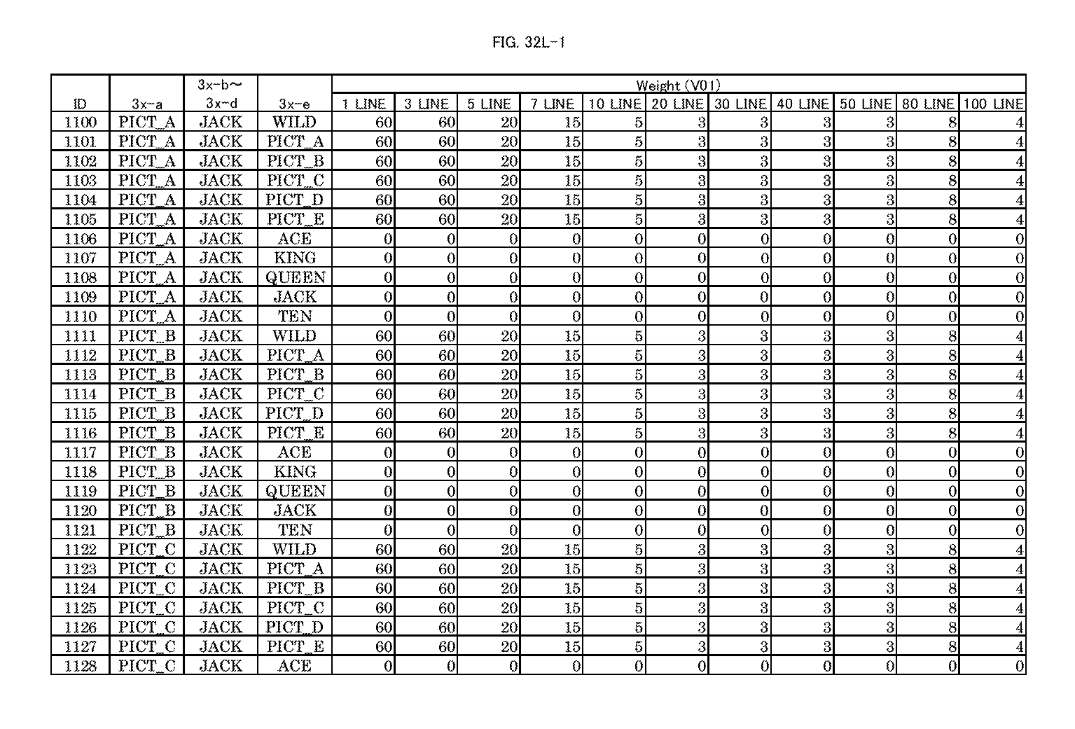

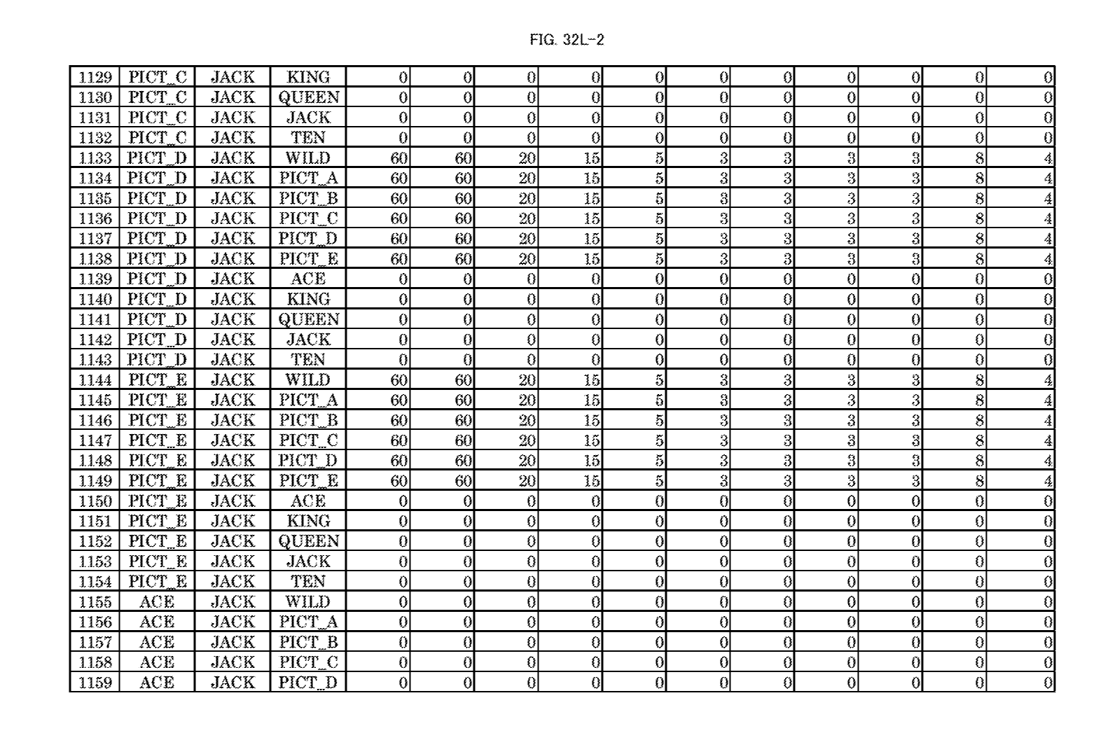

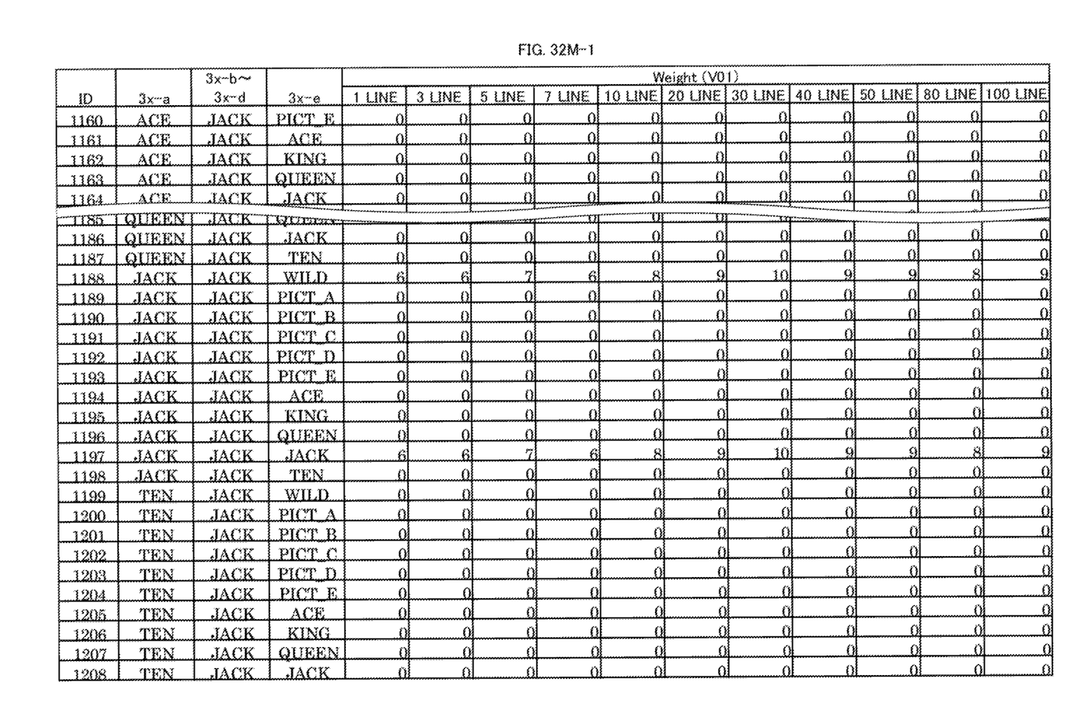

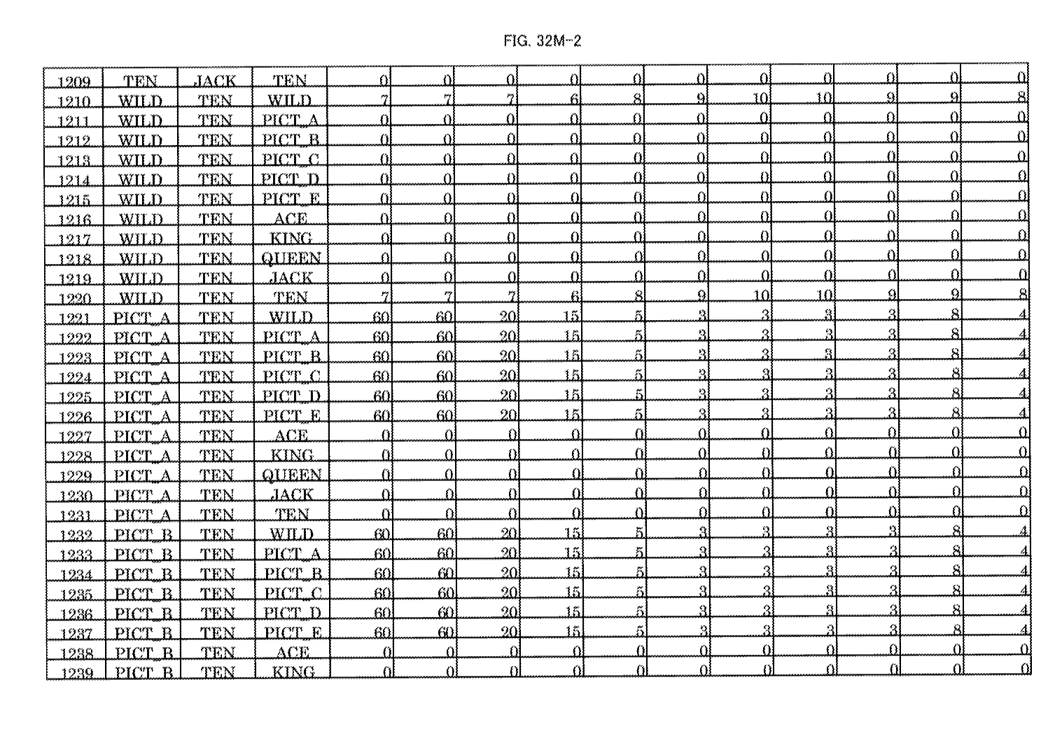

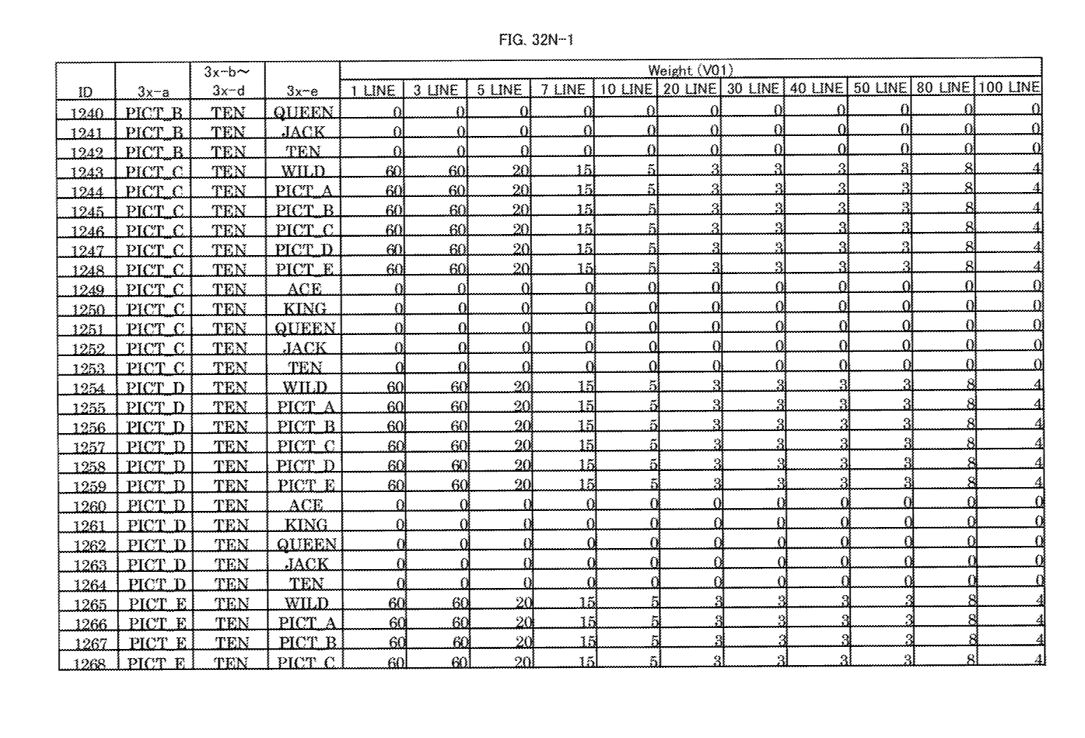

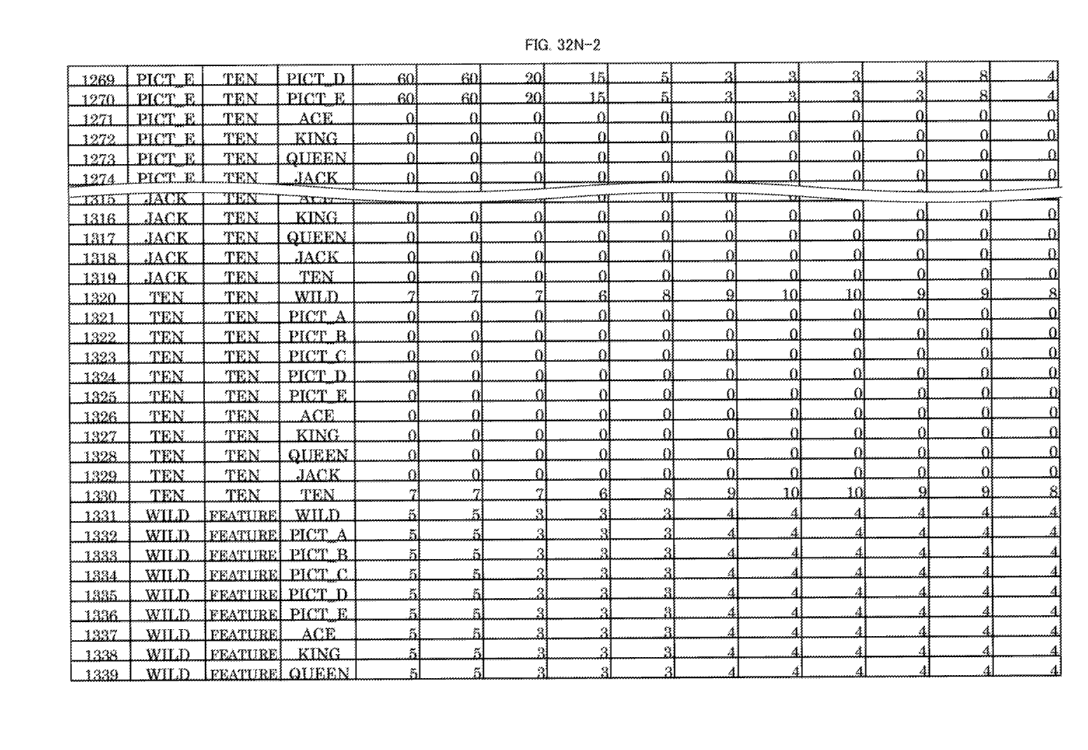

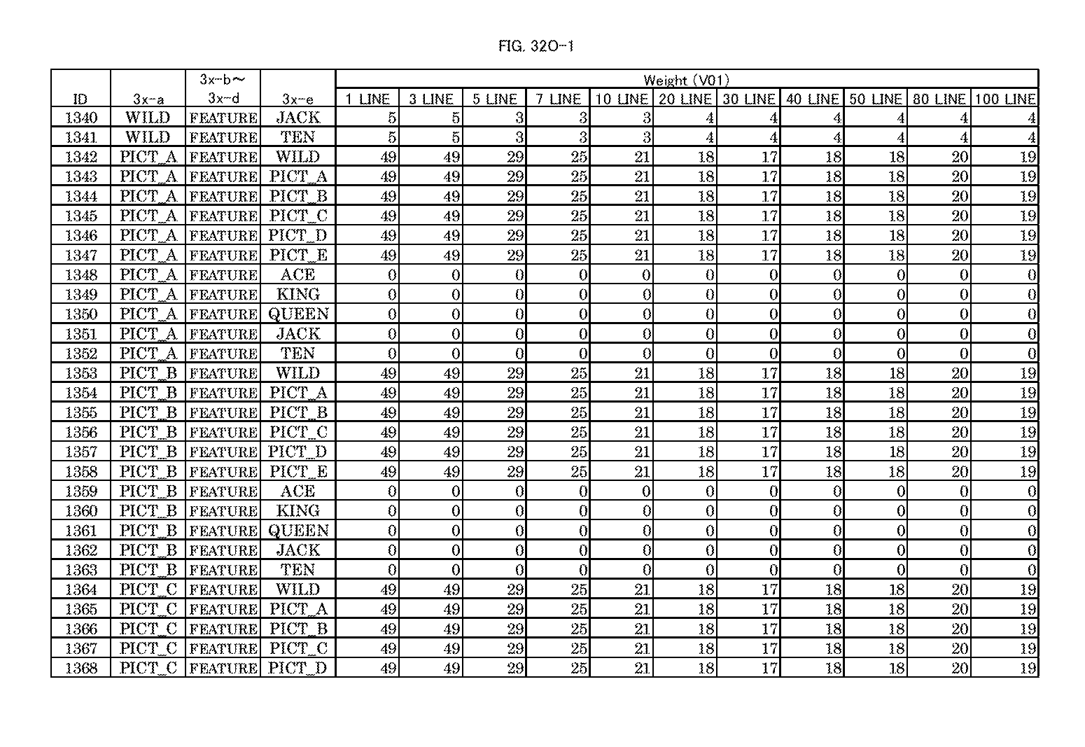

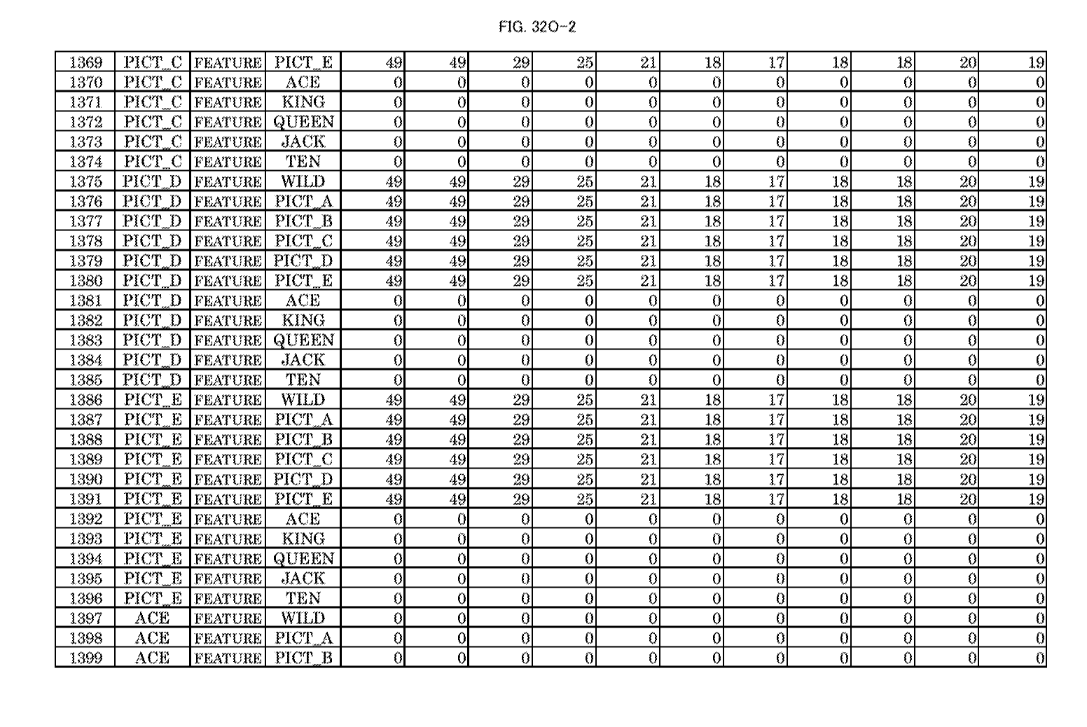

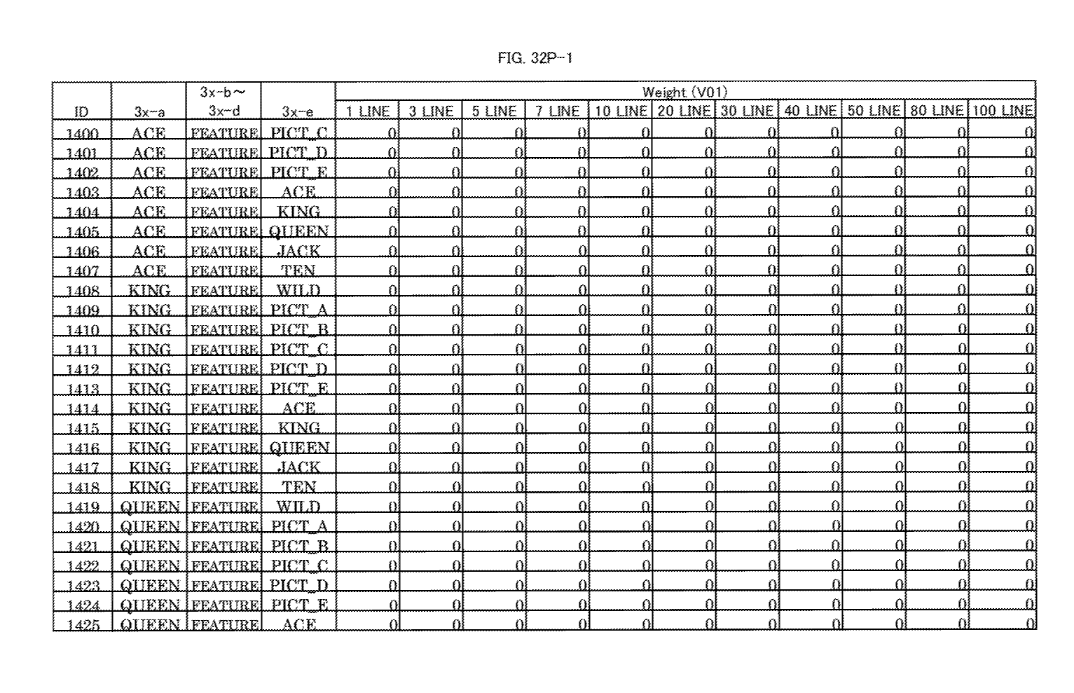

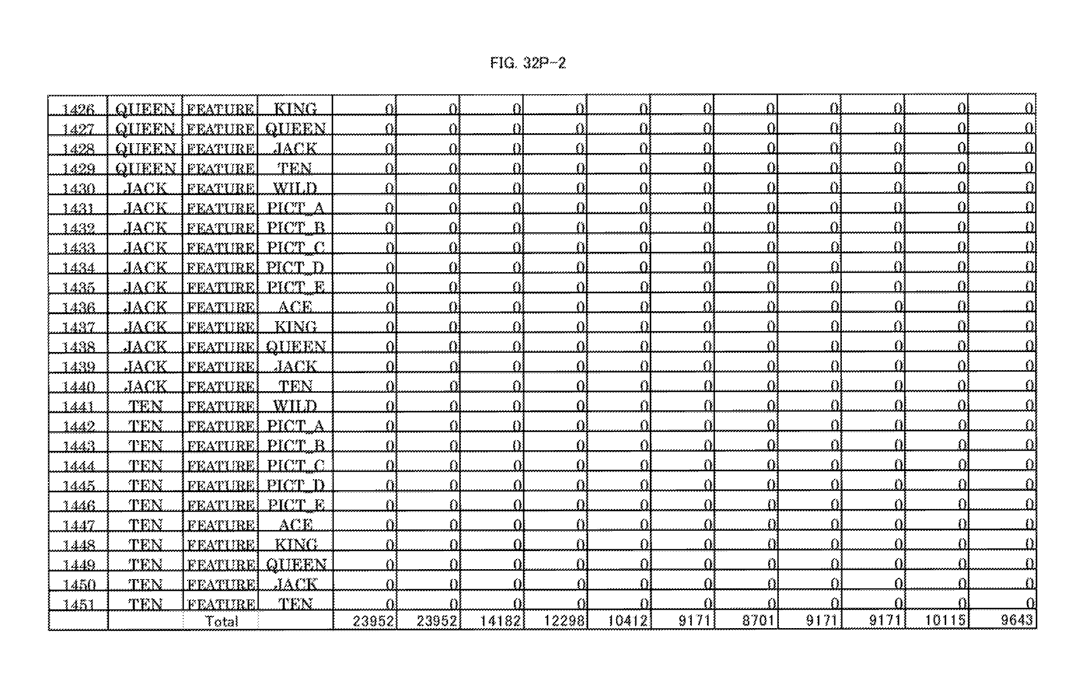

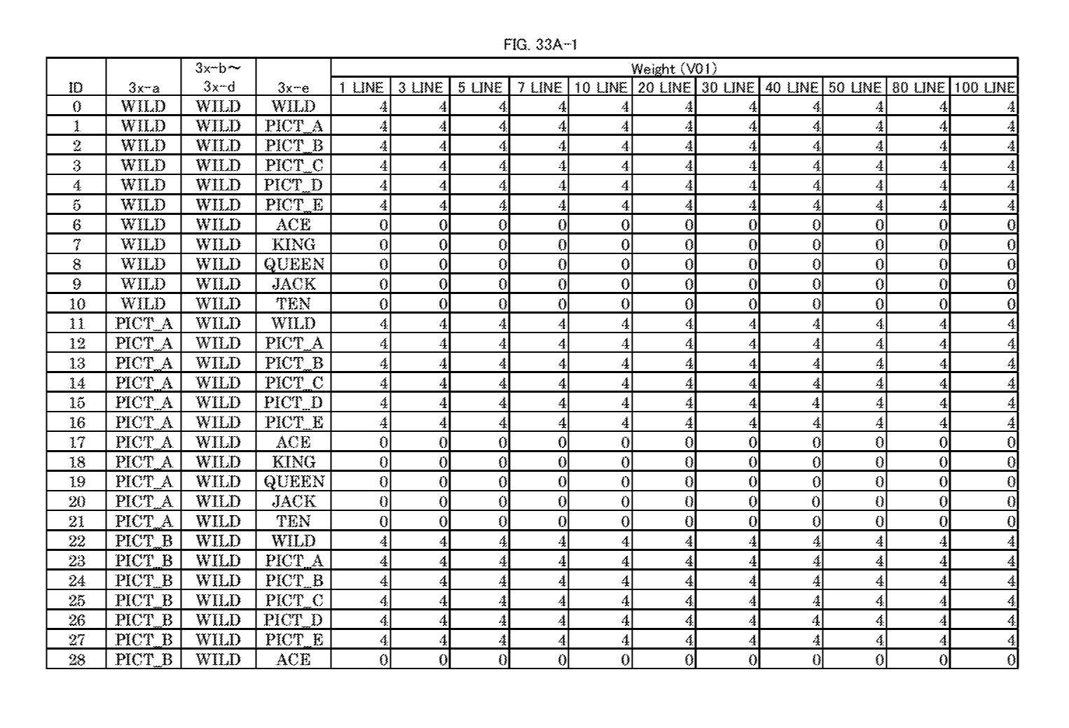

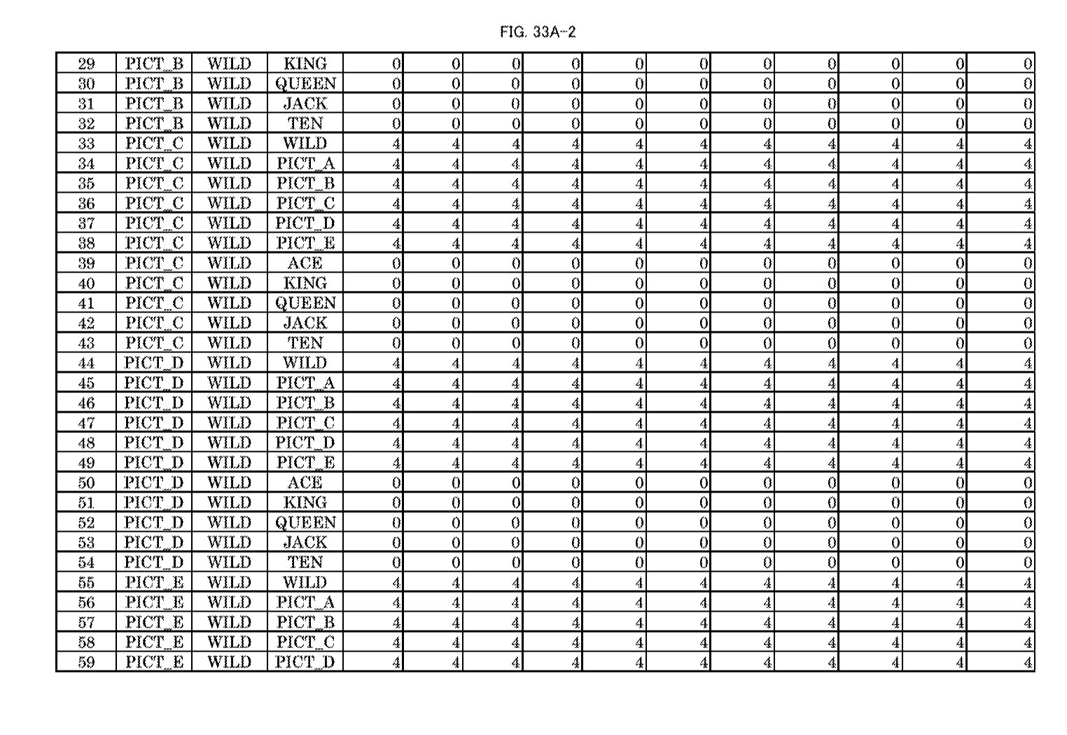

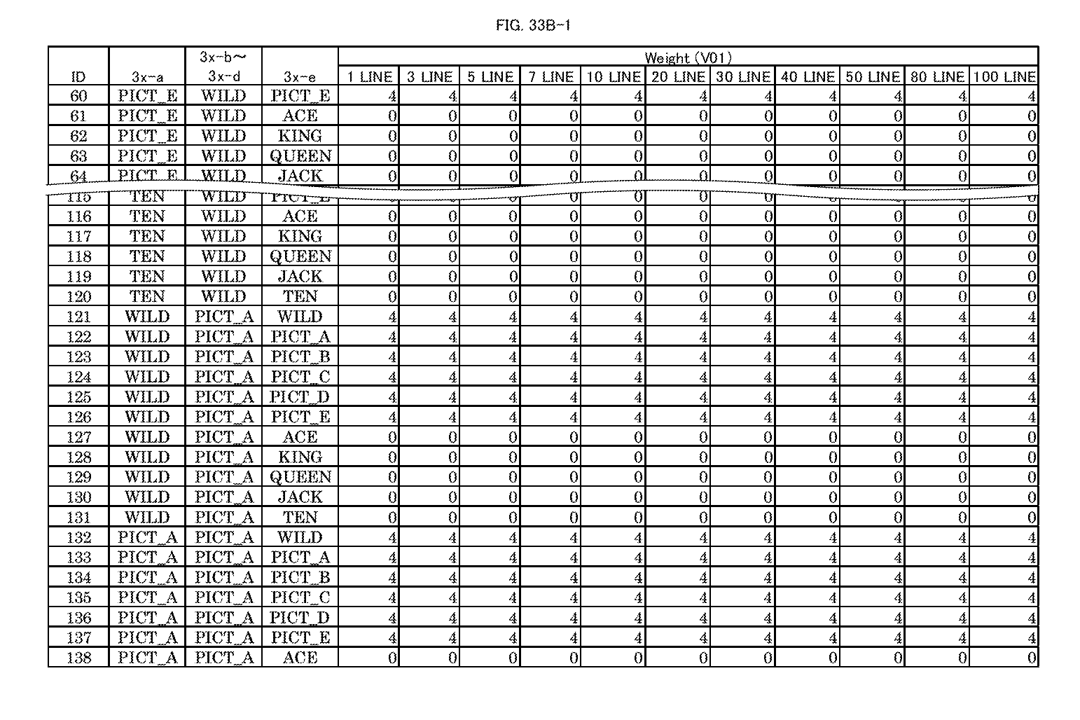

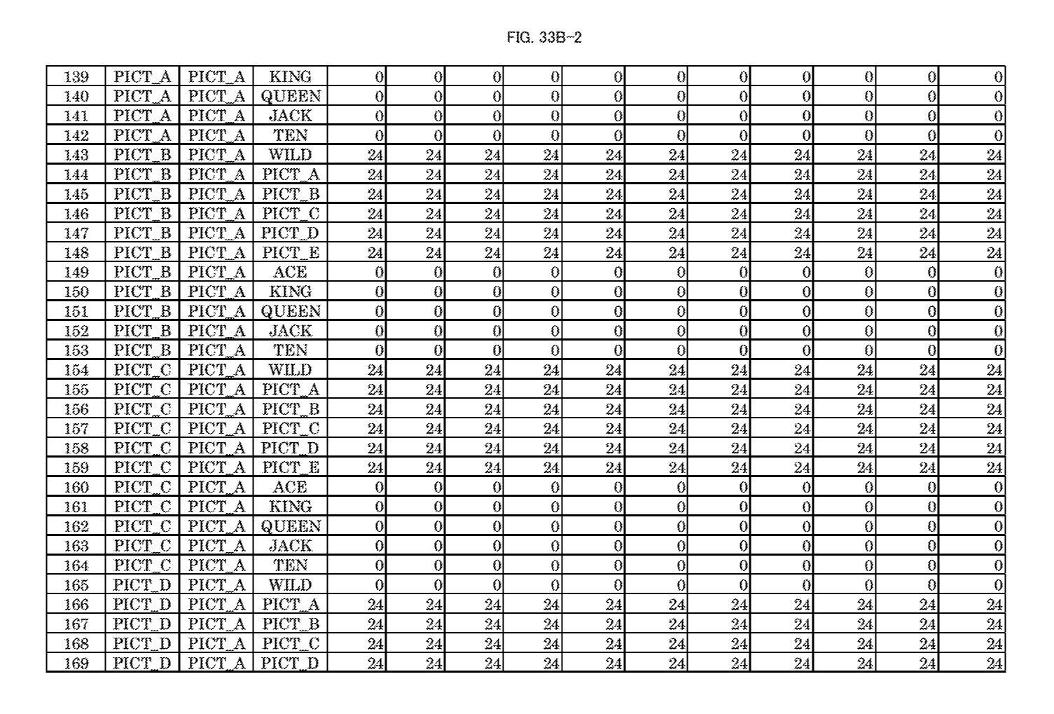

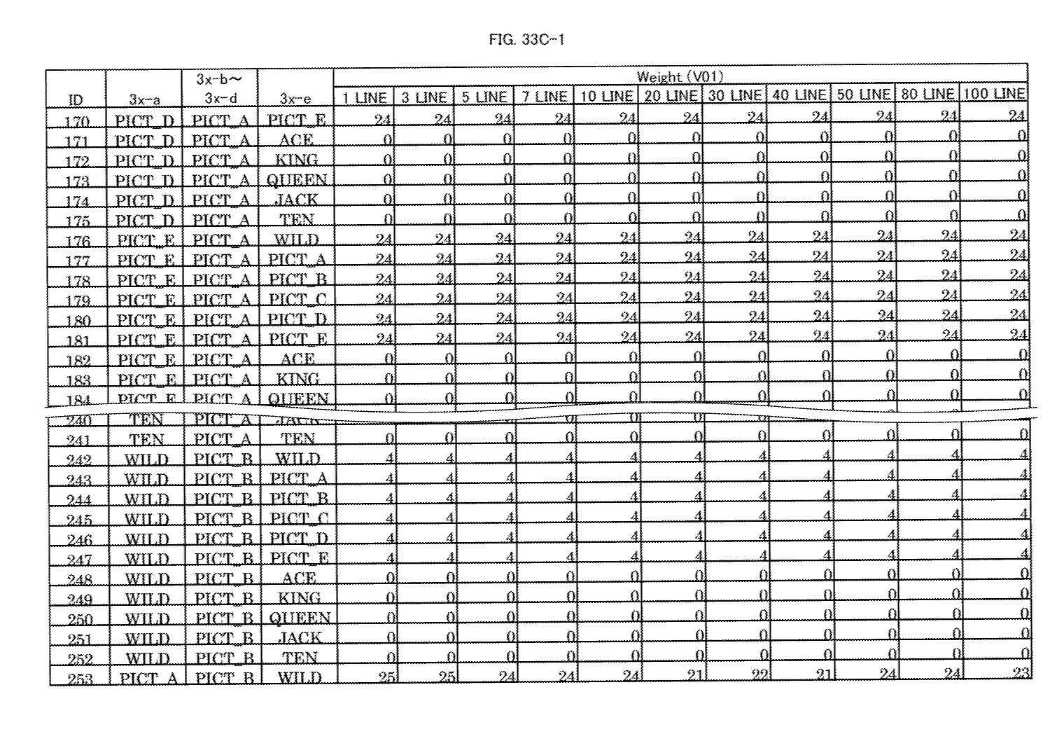

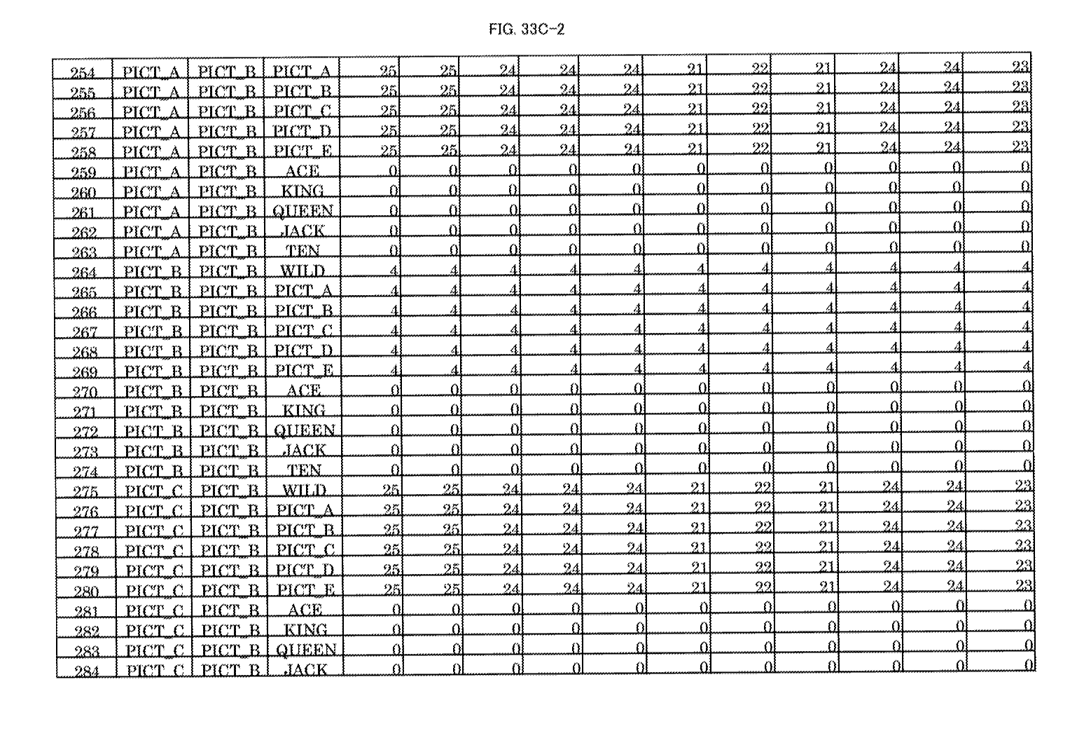

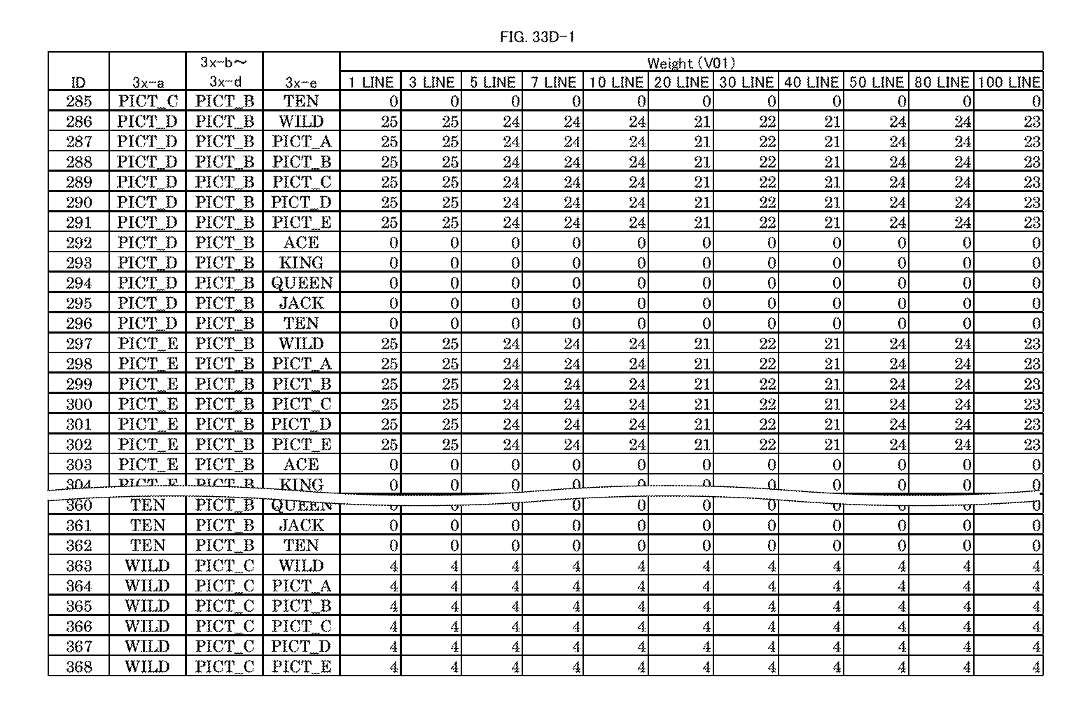

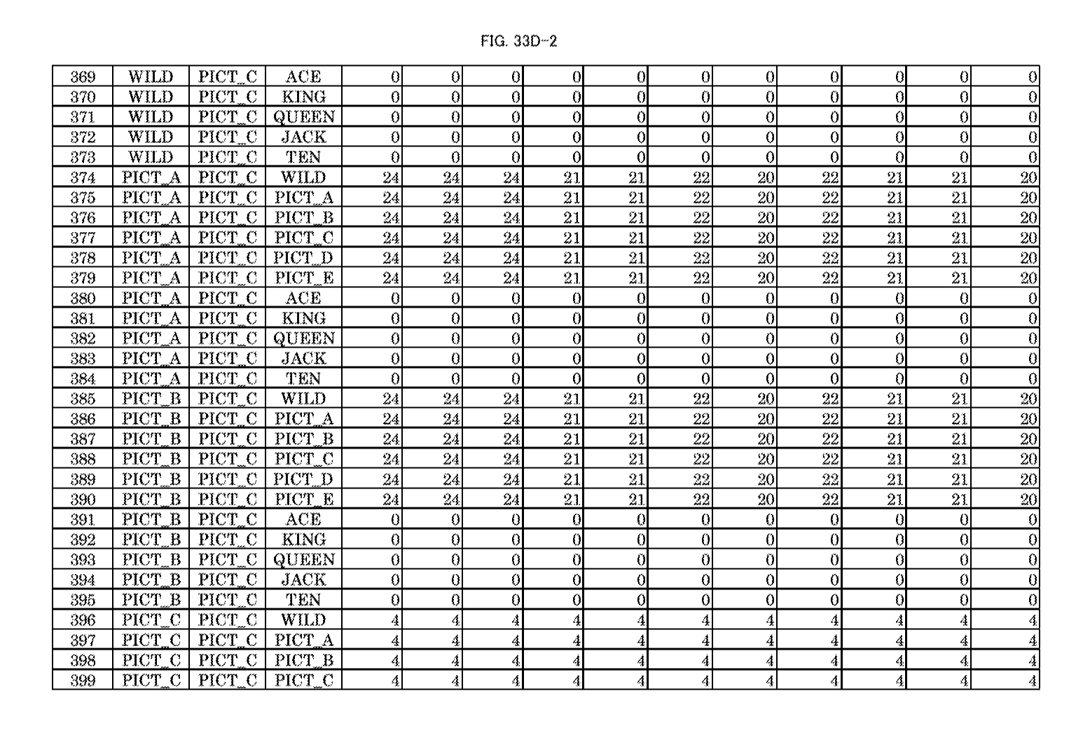

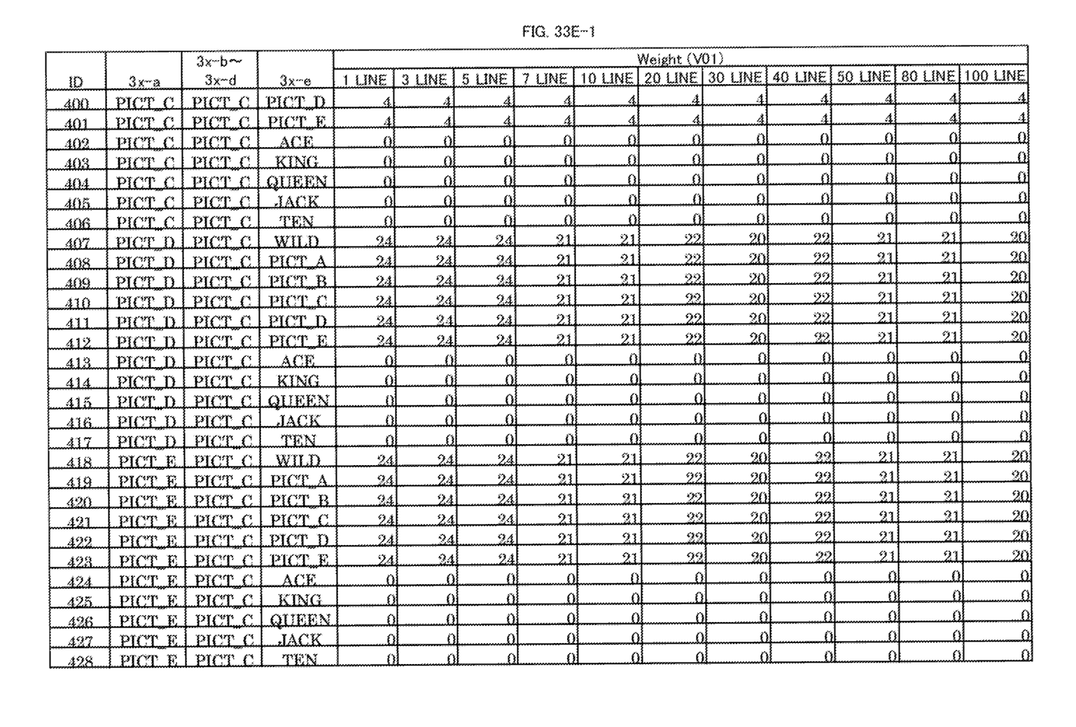

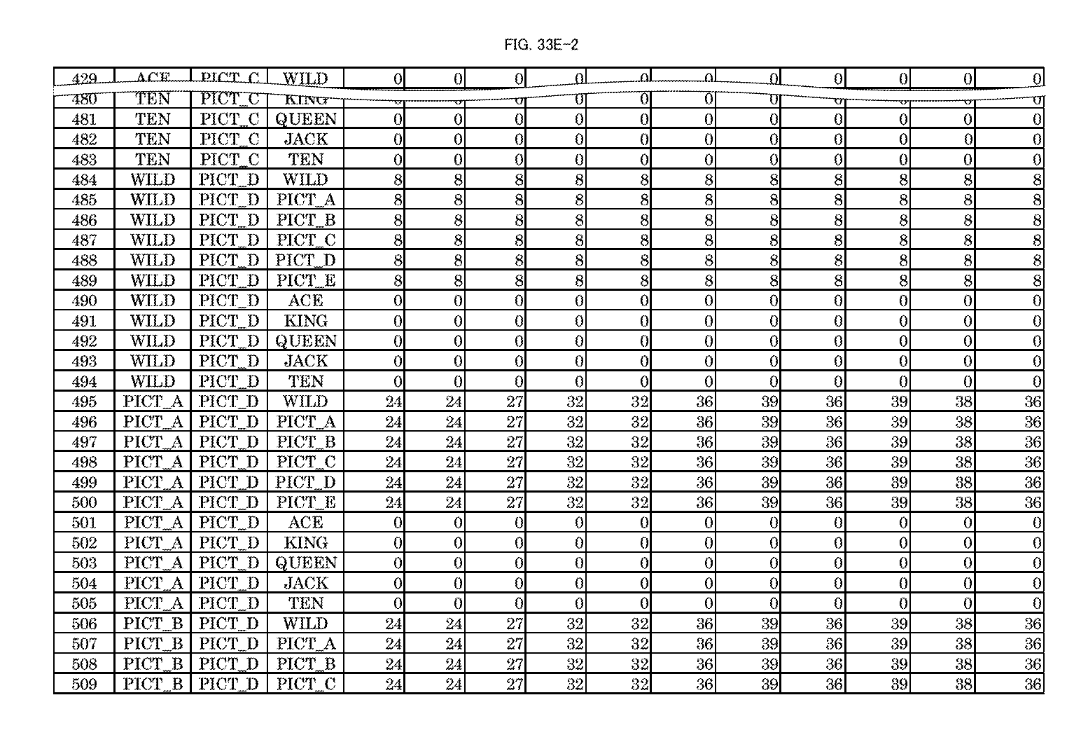

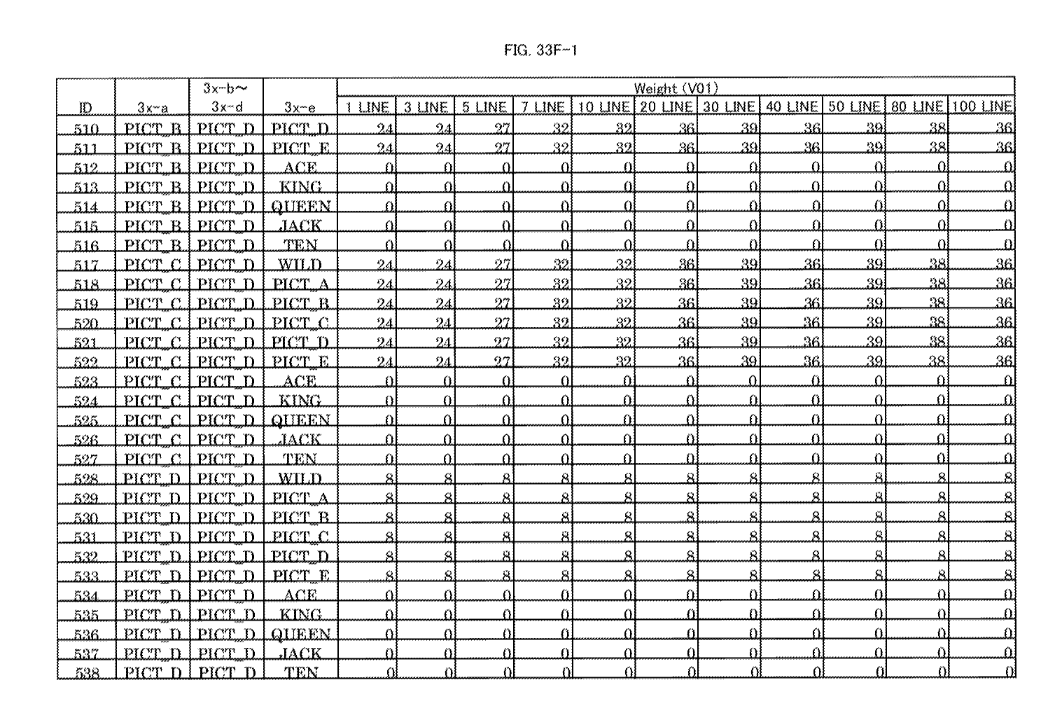

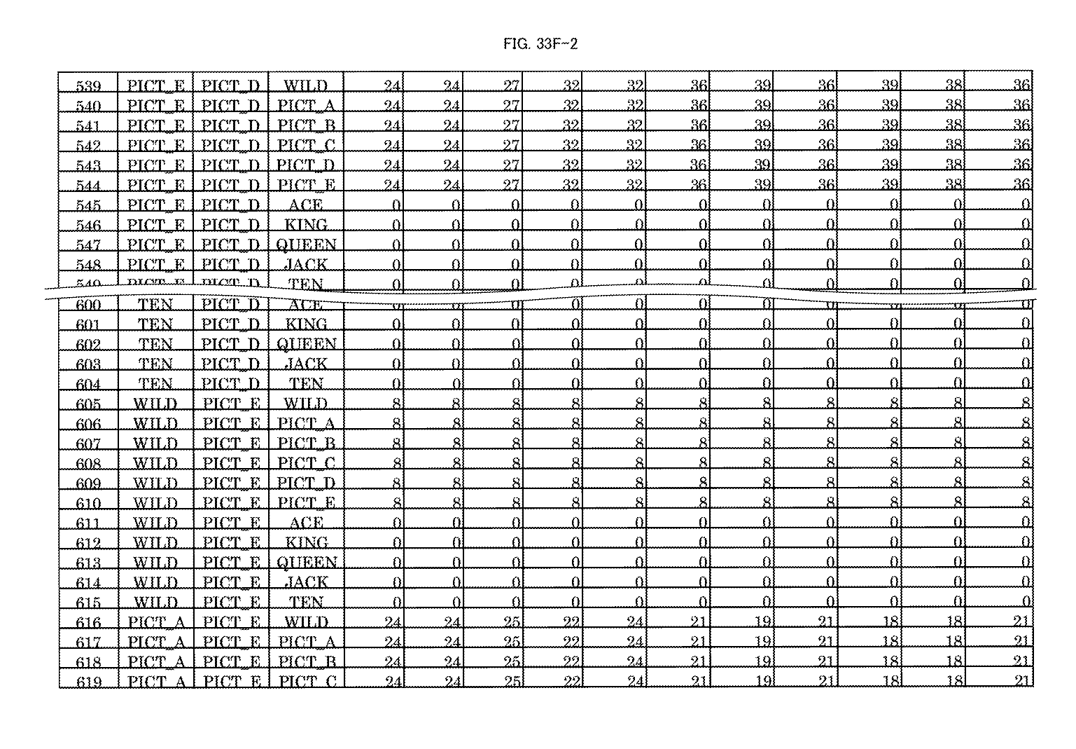

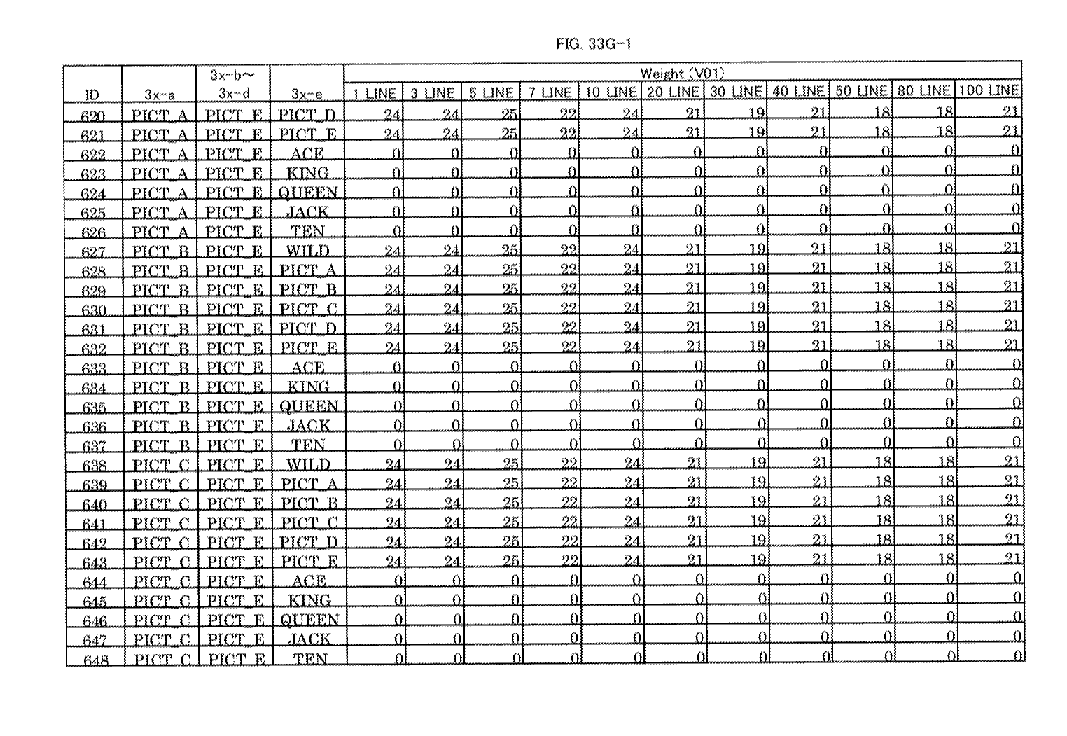

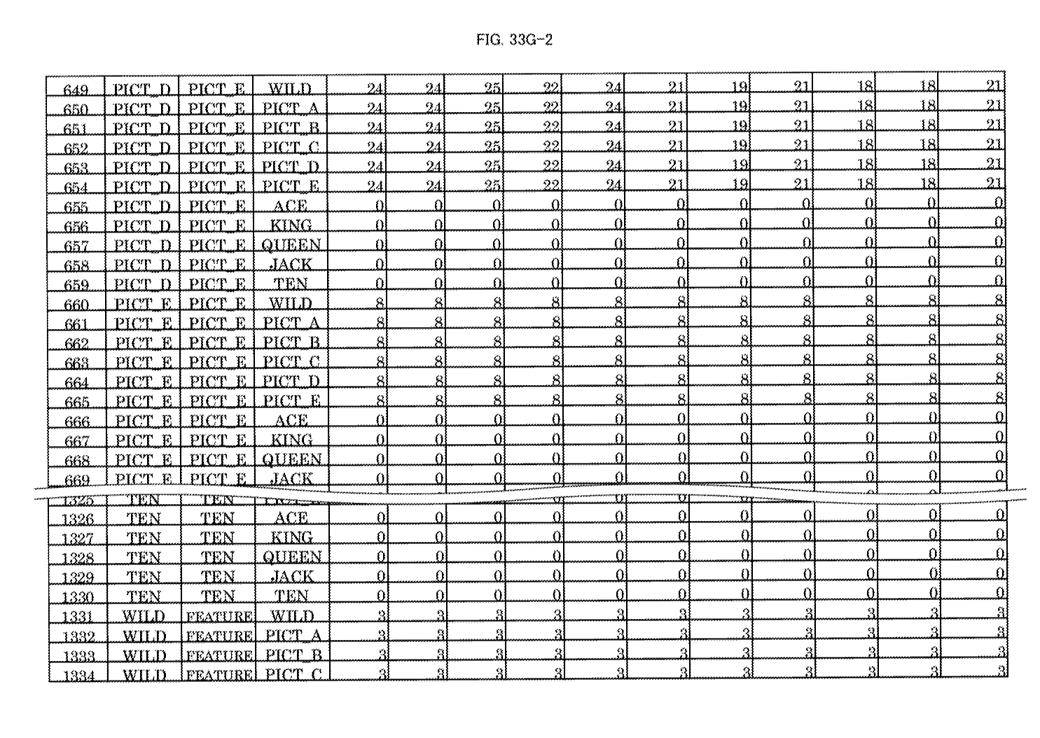

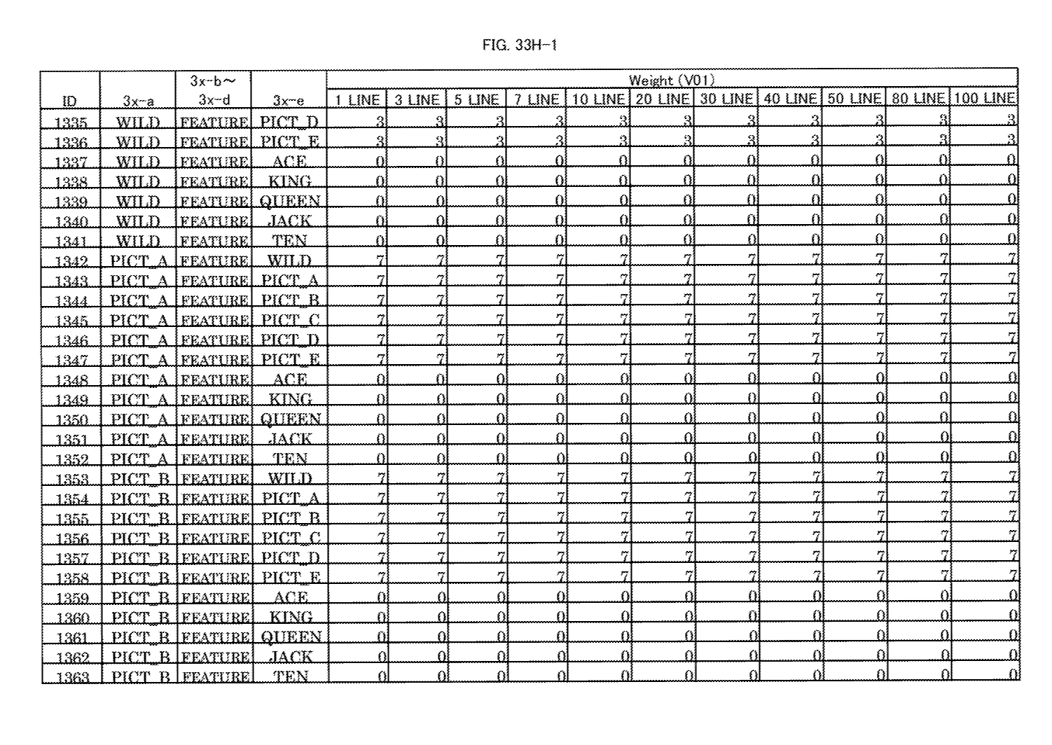

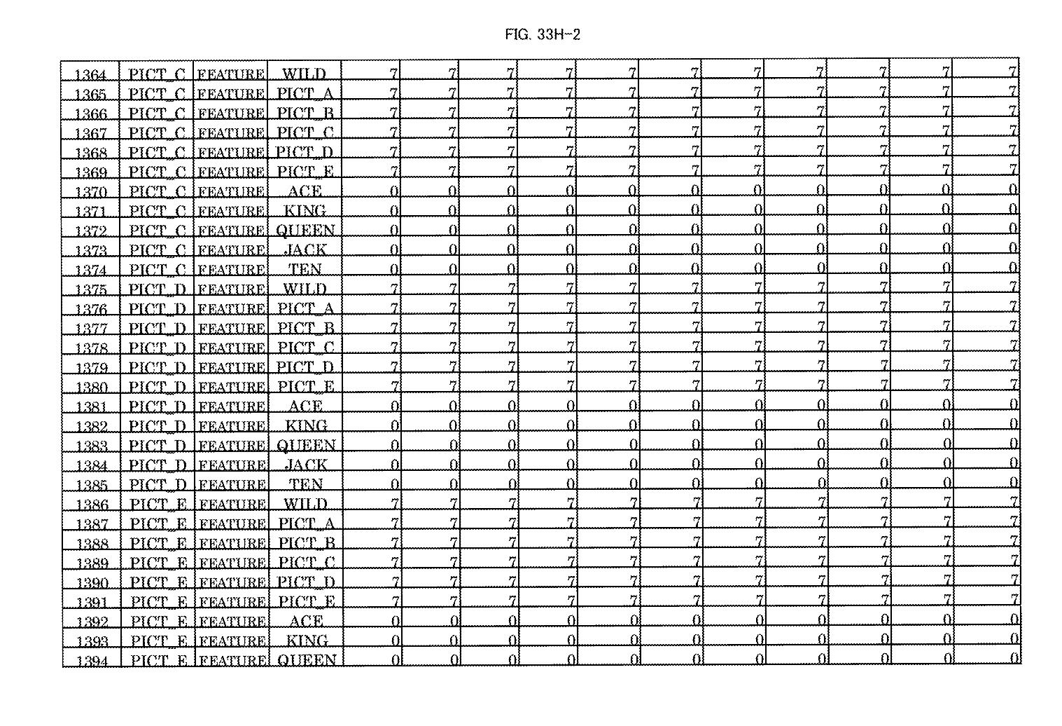

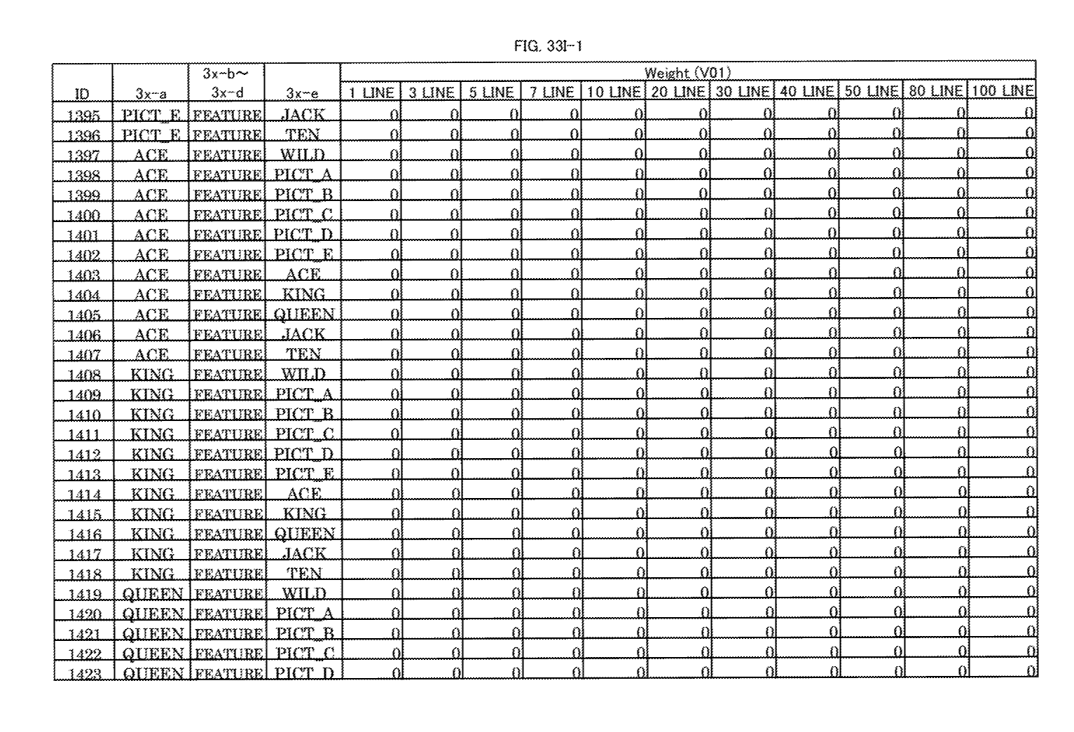

the memory further holds a symbol selection probability table (e.g., a replacement symbol determination table in FIG. 32A to 33I to be described later) that specifies probabilities to select a combination of a kind of element symbols for the first type of scroll line and a kind of element symbols for the second type of scroll lines depending on the number of paylines.

The scroll lines include a scroll line of a first type and scroll lines of a second type. The first type of scroll line is a scroll line for showing a symbol array in the first display manner and the second type of scroll lines for displaying symbol arrays in the second display manner.

The memory holds a symbol selection probability table. The symbol selection probability table specifies probabilities to select a combination of element symbols depending on the number of paylines. The combination of element symbols is a kind of symbols for the first type of scroll line and a kind of element symbols for the second type of scroll lines.

A combination of a kind of element symbols for the first type of scroll line and a kind of element symbols for the second type of scroll lines is selected together through one element symbol lottery. The lottery processing is simplified. Even if the paylines to complete winning patterns are increased because of the symbols shown in the second display manner, specifying the prizes for the winning patterns related to the individual combinations of a kind of element symbols for the first type of scroll line and a kind of element symbols for the second type of scroll line as appropriate eliminates the gap among the paylines, achieving a uniform pay rate for the player.

The aspect 1-3 of the present invention is the gaming machine in the aspect 1-2 of the present invention, in which,

the to-be replaced symbols include:
a first kind of to-be replaced symbols (e.g., CHANGE symbols to be described later) disposed on the first type of scroll line and to be shown in the first display manner, and
a second kind of to-be replaced symbols (e.g., M_CHANGE symbols to be described later) disposed on the second type of scroll line and to be shown in the second display manner; and

the symbol array reconfiguration processing of the processing (1-3) includes:
replacing the first kind of to-be replaced symbols on the first type of scroll line with the selected kind of element symbols shown in the first display manner, and
replacing the second kind of to-be replaced symbols on the second type of scroll line with the selected kind of element symbols shown in the second display manner.

The to-be replaced symbols are applicable to both of the first display manner or the second display manner. Replacing a to-be replaced symbol with an element symbol increases the paylines to complete winning patterns.

The aspect 1-4 of the present invention is the gaming machine in the aspect 1-1 of the present invention, in which,

the plurality of types of symbols further include blank symbols (e.g., BLANK symbols to be described later) that are involved with neither completion of winning patterns nor symbol replacement;

the symbol arrays include symbol arrays of a first type (e.g., normal reel strips 3n-a, 3n-b, 3n-c, 3n-d, and 3n-e to be described later) including element symbols and symbol arrays of a second type (e.g., replacement reel strips 3x-a, 3x-b, 3x-c, 3x-d, and 3x-e) including blank symbols and to-be replaced symbols;

the symbol array reconfiguration processing of the processing (1-3) is to configure the second type of symbol arrays to be displayed (e.g., replacement reel strips 3x-a, 3x-b, 3x-c, 3x-d, and 3x-e to be described later) by replacing the to-be replaced symbols (e.g., M_CHANGE symbols to be described later) on the second type of symbol arrays with element symbols selected in the element symbol lottery processing of the processing (1-2); and

the scrolling the symbol arrays in the processing (1-4) includes:
stacking the symbols on the first type of symbol arrays and the symbols on the second type of symbol arrays to be displayed in scrolling the symbol arrays,
selectively showing an element symbol on a to-be displayed symbol array of the second type in a case where an element symbol on a symbol array of the first type and the element symbol on the to-be displayed symbol array of the second type are stacked, and
selectively showing an element symbol on a symbol array of the first type in a case where the element symbol on the symbol array of the first type and a blank symbol on a to-be displayed symbol array of the second type are stacked.

Element symbols are selected through the element symbol lottery processing and the symbols on the first type of symbol arrays and the symbols on the second type of symbol arrays to be displayed are stacked in displaying the symbol arrays. Displayed symbol arrays can be different in each unit game to prevent completed winning patterns from becoming monotonous. Furthermore, since the element symbols on the second type of symbol arrays are shown selectively, the gap among the paylines can be eliminated by symbol replacement to achieve a uniform pay rate for the player.

### <<Aspects 2-1 to 2-4 of Present Invention>>

FIG. 1B is a diagram for illustrating a general representation of aspects 2-1 to 2-4 of the present invention.

The aspect 2-1 of the present invention is a gaming machine (e.g., a slot machine 10 to be described later) comprising:

a symbol display device (e.g., a lower display device 141 to be described later) capable of rearranging a plurality of types of symbols to show a game result in a display area,

a controller (e.g., a controller 100 or a processor AM 10 to be described later) capable of executing a game by scrolling symbol arrays along scroll lines of the symbol display device, each of the symbol arrays being composed of a plurality of symbols, and

a memory (e.g., a main RAM 210 to be described later) holding data of the plurality of symbols included in the symbol arrays.

The plurality of types of symbols include element symbols (e.g., WILD, PICT_A, PICT_B, PICT_C, PICT_D, PICT_E, ACE, KING, QUEEN, JACK, TEN, and FEATURE symbols to be described later) that are capable of completing a winning pattern (e.g., a pattern in FIG. 13 to be described later) and to-be replaced symbols (e.g., CHANGE and M_CHANGE symbols to be described later) that are to be replaced by element symbols;

the scroll lines include:
a scroll line of a first type (e.g., a video reel 3a or 3e to be described later), and
a plurality of scroll lines of a second type (e.g., video reels 3b to 3d to be described later) different from the first type of scroll line;

the symbol arrays include:
a symbol array for the first type of scroll line that is to be scrolled along the first type of scroll line, and
symbol arrays for the second type of scroll lines that are to be scrolled along the second type of scroll lines;

symbols included in the symbol array for the first type of scroll line are displayed in a first display manner (e.g., a normal size for one frame) to show the symbols on the scroll line;

symbols included in the symbol arrays for the second type of scroll lines are displayed in a second display manner (e.g., a size of 3×3 of nine frames) to show a plurality of symbols as one symbol over the second type of scroll lines; and

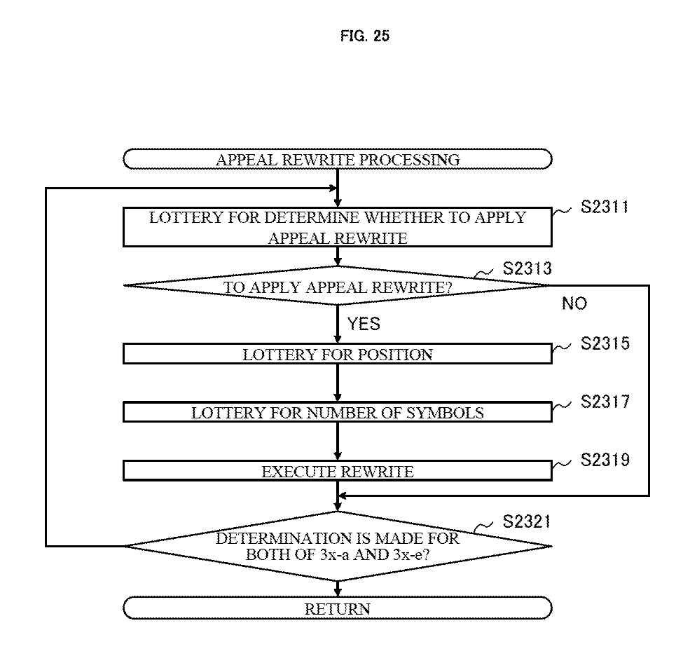

the controller is programmed to perform the following processing of:
(5-1) symbol lottery processing (e.g., symbol lottery processing in FIG. 23 to be described later) to determine to-be stopped symbols,
(5-2) element symbol lottery processing (e.g., step S2211 and S2213 in FIG. 24 to be described later) to select a kind of element symbols from a plurality of kinds of element symbols,
(5-3) replacement processing (e.g., step S2215 in FIG. 24 to be described later) to replace the to-be replaced symbols (e.g., CHANGE and M_CHANGE symbols to be described later) included in the symbol array for the first type of scroll line and the symbols arrays for the second type of scroll lines with element symbols of the kind selected in the element symbol lottery processing,
(5-4) re-array processing (e.g., appeal rewrite processing in FIG. 25) to re-array the symbol array for the first type of scroll line by consecutively disposing the same kind of element symbols as the element symbols used as replacement symbols in the replacement processing along the first type of scroll line from a base position distant from the display area by a predetermined number of symbols, and
(5-5) starting scrolling the symbol arrays along the first type of scroll line and the second type of scroll lines after executing the re-array processing.

The controller performs symbol lottery processing (5-1) to determine to-be stopped symbols. The to-be stopped symbols are symbols included in the rearranged symbols; stopping the to-be stopped symbols at predetermined positions results in showing all the symbols to be rearranged in a stopped state on the symbol display device.

The controller selects a kind of element symbols from a plurality of kinds of element symbols by lottery (5-2). The element symbols are determined based on the number of activated paylines. The element symbols to be selected can be configured differently between in the case where a small number of paylines are activated and in the case where a large number of paylines are activated.

The controller replaces the to-be replaced symbols included in the symbol array for the first type of scroll line and the symbols arrays for the second type of scroll lines with element symbols of the kind selected in the element symbol lottery processing (5-3).

The controller re-arrays the symbol array for the first type of scroll line by consecutively disposing the same kind of element symbols as the element symbols used as replacement symbols in the replacement processing along the first type of scroll line from a base position distant from the display area by a predetermined number of symbols (5-4).

The controller starts scrolling the symbol arrays along the first type of scroll line and the second type of scroll lines (5-5).

The symbol array for the first type of scroll line is re-arrayed by consecutively disposing the same kind of element symbols as the element symbols used as replacement symbols along the first type of scroll line from a base position distant from the display area of the symbol display device by a predetermined number of symbols and then, is scrolled. As a result, the element symbols are successively shown immediately after the start of the scrolling. The player becomes aware of a high possibility that the element symbols will be continuously arranged to complete a winning pattern.

The aspect 2-2 of the present invention is the gaming machine in the aspect 2-1 of the present invention, in which,

the re-array processing of the processing (5-4) includes the processing of:

(6-1) symbol re-array determination lottery processing (e.g., step S2313 to be described later) to determine whether to re-array the symbol array for the first type of scroll line with a predetermined probability of a hit, and

(6-2) re-array lottery processing (e.g., steps S2315 and S2317 to be described later) to determine a position for the base position and number of element symbols to be disposed consecutively.

Since whether to re-array the symbol array, the position of the base position, and the number of element symbols to be disposed consecutively are determined by lottery, the games can be developed variously without becoming monotonous.

The aspect 2-3 of the present invention is the gaming machine in the aspect 2-1 of the present invention, in which,

the plurality of types of symbols further include blank symbols that are involved with neither completion of winning patterns nor symbol replacement;

the symbol array for the first type of scroll line and the symbol arrays for the second type of scroll lines include:
normal symbol arrays composed of element symbols, and
replacement symbol arrays composed of blank symbols and to-be replaced symbols;

the replacement symbol arrays include a plurality of to-be replaced symbols consecutively;

the replacement processing of the processing (5-3) is to replace all the to-be replaced symbols on the replacement symbol arrays with element symbols of the kind selected in the element symbol lottery processing of the processing (5-2); and

the scrolling the symbol arrays in the processing of (5-5) is scrolling the symbol arrays along the first type of scroll line and the second type of scroll lines while stacking the symbols of the normal symbol arrays and the symbols of the replacement symbol arrays after the replacement processing.

All the consecutive to-be replaced symbols are replaced by element symbols. Accordingly, some of the element symbols will be rearranged on the symbol display device to complete multiple winning patterns simultaneously with high probability.

The aspect 2-4 of the present invention is the gaming machine in the aspect 2-2 of the present invention, in which,

the controller is programmed to further perform the following processing of:

(8-1) in a case where an entirety of an element symbol of a specific kind is shown in the display area as a result of displaying element symbols of the specific kind in the symbol arrays for the second type of scroll lines in the second display manner, performing the symbol re-array determination lottery processing to select the specific kind of element symbols with a probability higher than the predetermined probability of a hit;

(8-2) in a case of a hit in the symbol re-array determination lottery processing, performing the re-array processing to re-array the symbol array for the first type of scroll line by consecutively disposing the specific kind of element symbols along the first type of scroll line from the base position;

(8-3) scrolling the symbol arrays for the first type of scroll line while maintaining a stopped state showing the entirety of the specific kind of element symbol in the display area as a result of displaying element symbols of the specific kind in the symbol arrays for the second type of scroll lines in the second display manner; and

(8-4) when a predetermined time has passed after the processing of (8-3), stopping the symbol arrays to show the specific kind of element symbols in the symbol arrays on the first type of scroll line in the first display manner based on a result of the symbol lottery processing.

In a case where the entirety of an element symbol of a specific kind is shown in the display area as a result of displaying element symbols of the specific kind in the symbol arrays for the second type of scroll lines in the second display manner, the symbol arrays for the first type of scroll line are scrolled and stopped while maintaining the stopped state showing the entirety of the specific kind of element symbol in the display area. This configuration increases the possibility of completion of a winning pattern of the specific kind of element symbol when the scrolling of the symbol arrays of the first type of scroll line and the second type of scroll lines are stopped.

Before the stop of the scrolling of the symbol arrays of the first type of scroll line and the second type of scroll lines, the symbol array for the first type of scroll line is re-arrayed to include the specific kind of element symbols consecutively and scrolled. As a result, the element symbols are successively shown immediately after the start of the scrolling. The player becomes aware of a high possibility that the element symbols will be continuously arranged to complete a winning pattern.

In the second display manner, it is preferable that the symbol be longer in the direction along the second type of scroll line than the symbol shown in the first display manner. Since the symbol is longer in the direction along the second type of scroll line, probability to completion of a winning pattern is increased.

The aspect 2-5 of the present invention is the gaming machine in the aspect 2-4 of the present invention, in which,

the processing (8-4) includes the following processing of:

(9-1) replacing symbols in the symbol array for the first type of scroll line with the same kind of element symbols as the specific kind of element symbol the entirety of which is displayed in the second display manner in the display area in the processing of (8-3) and stopping the symbol arrays based on a result of the symbol lottery processing.

Since symbols are replaced by the same kind of element symbols as the specific kind of element symbol the entirety of which is displayed in the second display manner, winning patterns can be completed with high probability.

### <<<<Specific Overview of Slot Machine in Present Embodiment>>>>

An overview of a slot machine in the present embodiment is as follows. Details are described later.

<Video Reels 3a, 3b, 3c, 3d, and 3e>

A slot machine 10 has five video reels 3a, 3b, 3c, 3d, and 3e.

### <Normal Reel Strips and Replacement Reel Strips>

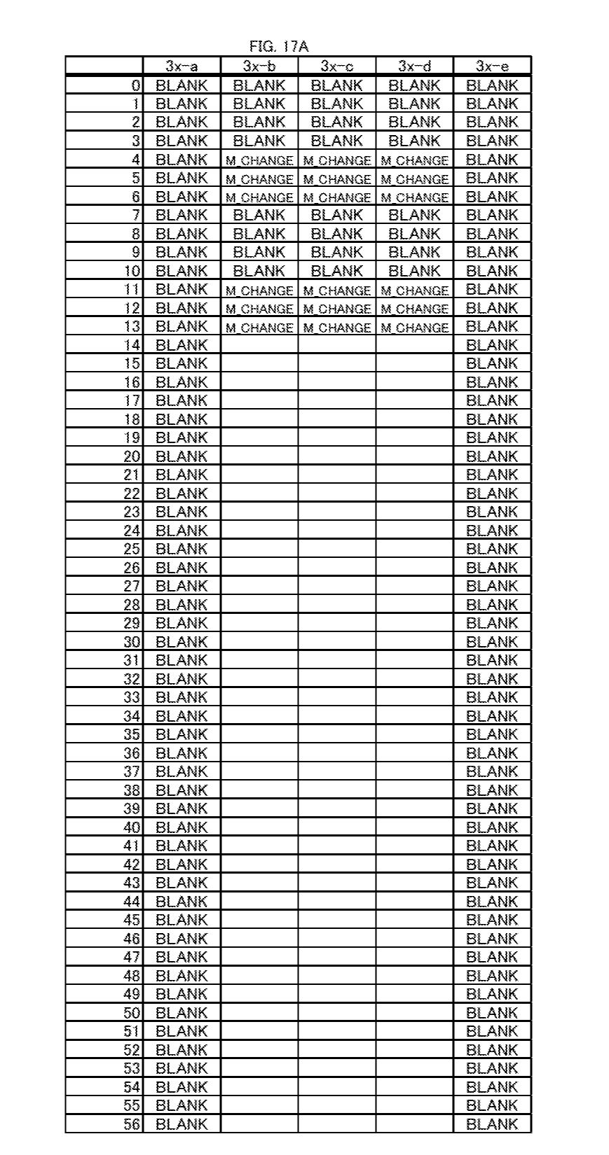

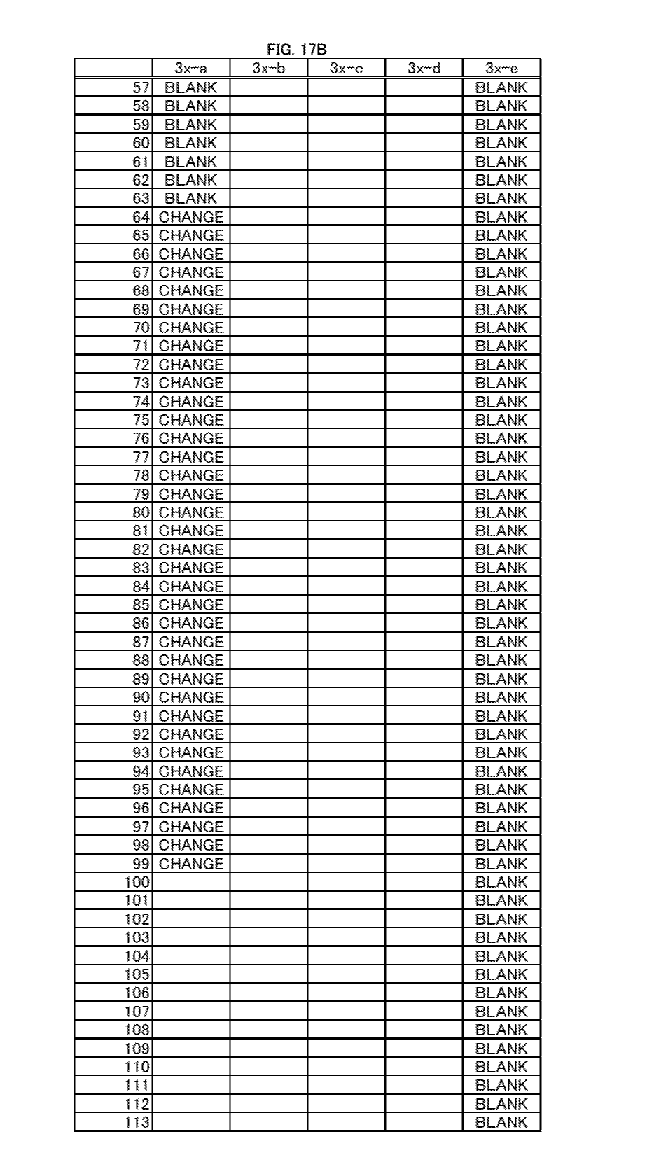

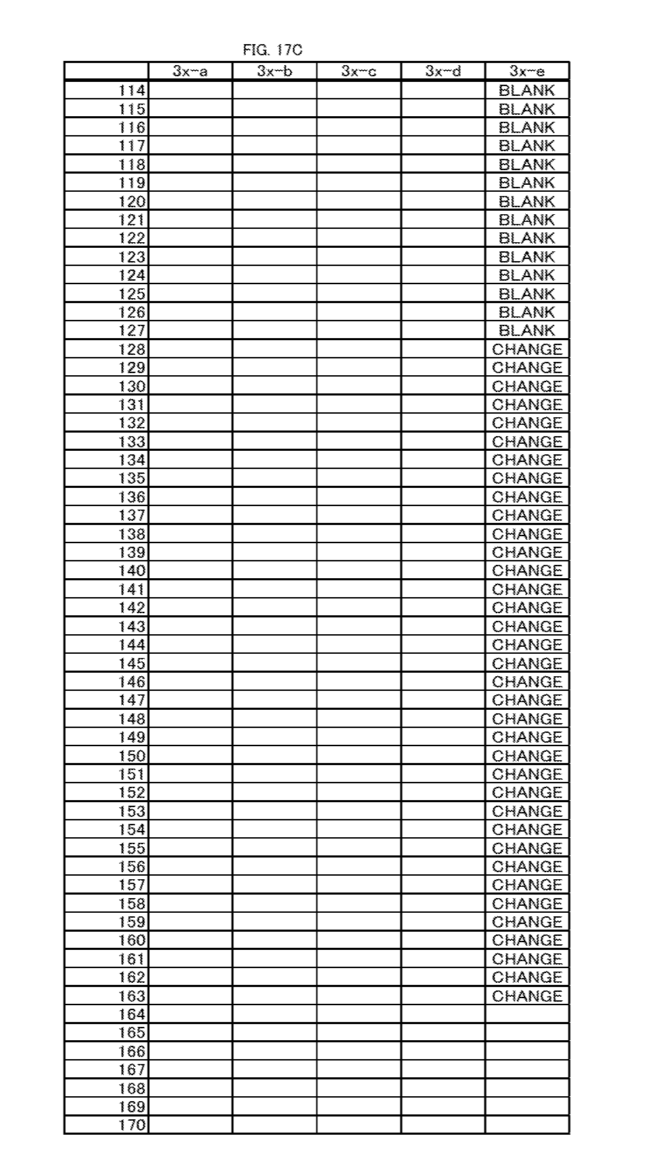

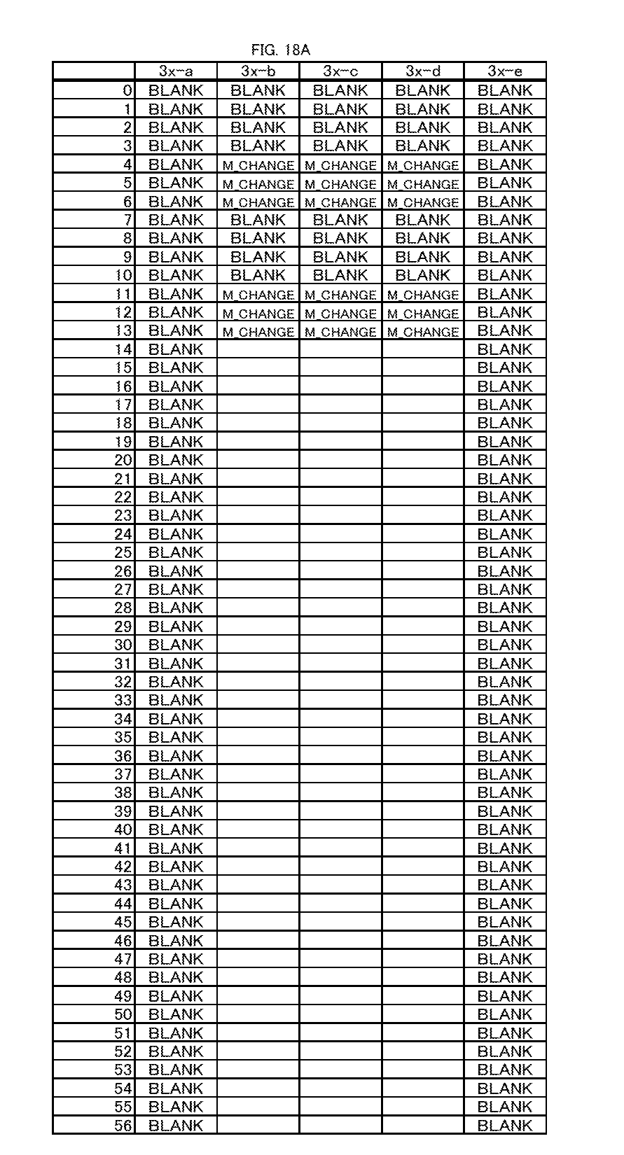

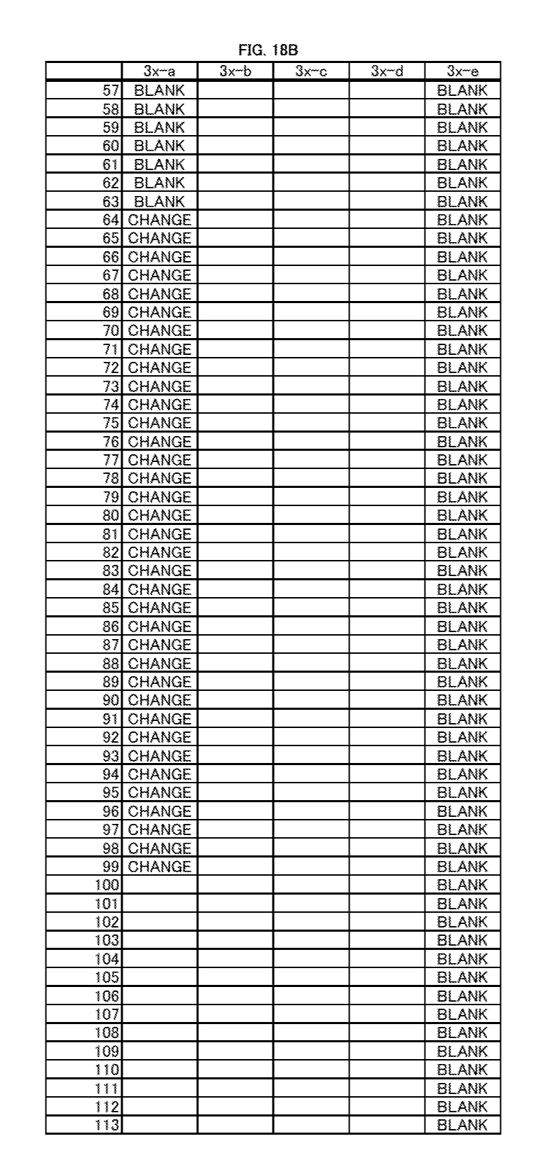

Each of the five video reels 3a, 3b, 3c, 3d, and 3e of the slot machine 10 in the present embodiment has two kinds of reel strips. The first kind of reel strips are five normal reel strips 3n-a, 3n-b, 3n-c, 3n-d, and 3n-e (see FIGS. 14A to 16). If these five reel strips do not need to be distinguished from one another, they are merely referred to as normal reel strips 3n. The second kind of reel strips are five replacement reel strips 3x-a, 3x-b, 3x-c, 3x-d, and 3x-e (see FIGS. 17A to 19C). If these five reel strips do not need to be distinguished from one another, they are merely referred to as replacement reel strips 3x.

The normal reel strips 3n-a, 3n-b, 3n-c, 3n-d, and 3n-e include different numbers of symbols from the replacement reel strips 3x-a, 3x-b, 3x-c, 3x-d, and 3x-e. The symbol forming areas of the normal reel strips 3n have the same size as the symbol forming areas of the replacement reel strips 3x. Each symbol forming area includes a symbol therein. That is to say, the sizes of one frame for a symbol (one cell) are the same between the normal reel strips 3n and the replacement reel strips 3x.

The slot machine 10 has game modes of base game mode, free game mode, and re-spin feature game mode. The normal reel strips 3n include reel strips to be used in base game mode and reel strips to be used in free game mode. The replacement reel strips 3x include reel strips to be used in base game mode and reel strips to be used in free game mode.

In base game mode, the normal reel strips 3n and the replacement reel strips 3x for base game mode are stacked to be displayed as video reels 3a, 3b, 3c, 3d, and 3e (see FIG. 38). In free game mode, the normal reel strips 3n and the replacement reel strips 3x for free game mode are stacked to be displayed as video reels 3a, 3b, 3c, 3d, and 3e (see FIG. 38).

FIG. 38 is a diagram for conceptually illustrating a part of a symbol display area 141d. The normal reel strip 3n in FIG. 38 represents one of the normal reel strips 3n-a to 3n-e. Likewise, the replacement reel strip 3x in FIG. 38 represents one of the replacement reel strips 3x-a to 3x-e. As illustrated in FIG. 38, the normal reel strip 3n and the replacement reel strip 3x are stacked to be displayed in the symbol display area 141d.

As will be described later, re-spin feature game mode can be entered from either one of base game mode and free game mode. In the case of re-spin feature game mode entered from base game mode, the normal reel strips 3n for base game mode and the replacement reel strips 3x for base game mode are used. In the case of re-spin feature game mode entered from free game mode, the normal reel strips 3n for free game mode and the replacement reel strips 3x for free game mode are used.

The five video reels 3a to 3e are displayed on a lower liquid crystal display panel 141b of a lower display unit 141. On each of the five video reels 3a to 3e, a plurality of symbols are disposed along the longitudinal direction. The plurality of symbols disposed on the five video reels 3a to 3e are displayed as images.

### <Stop Positions of Symbols>

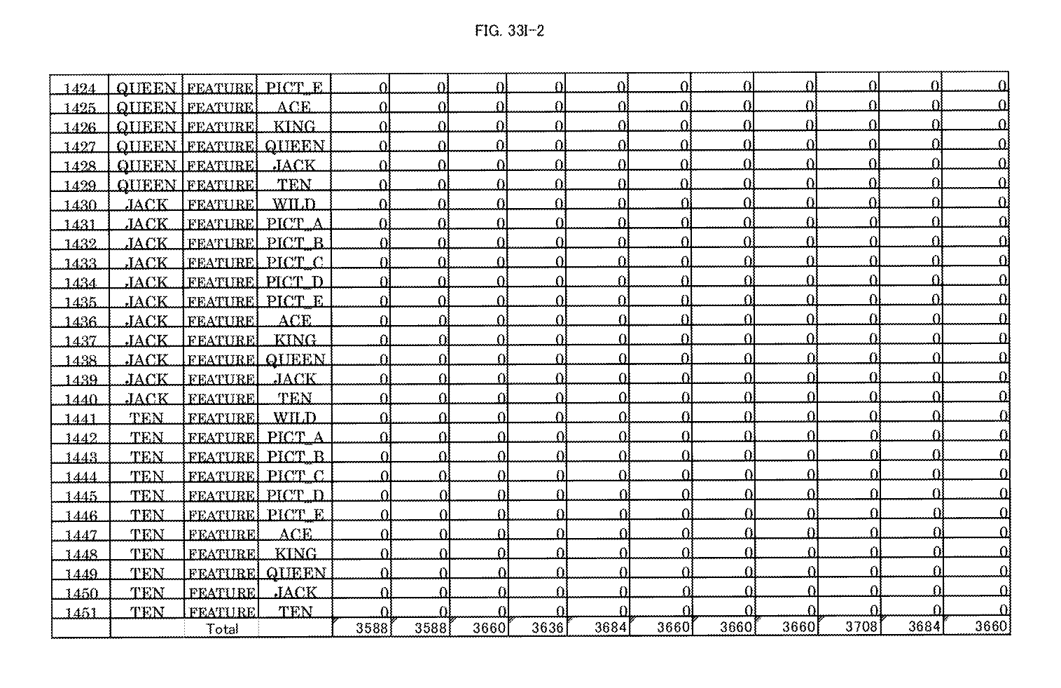

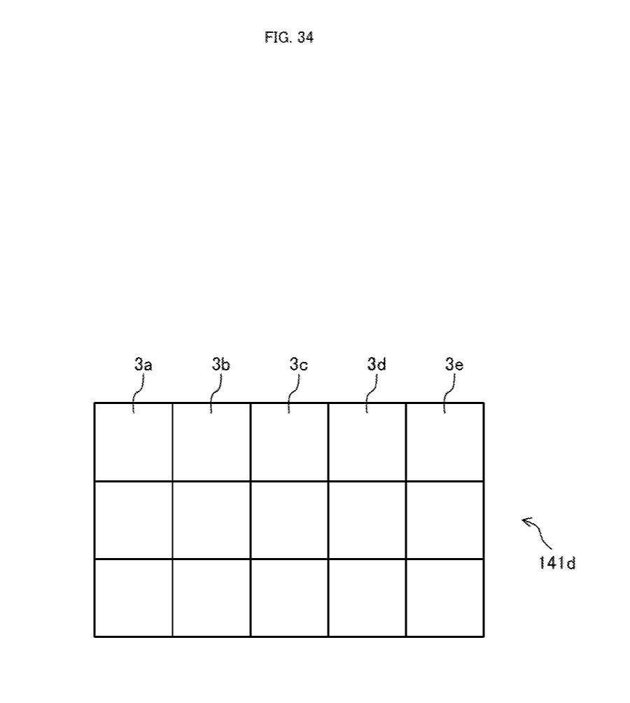

As illustrated in FIG. 34, three rows of the top row (the first row), the middle row (the second row), and the bottom row (the third row) are defined along each video reel 3 in a symbol display area 141d as stop positions for symbols. Accordingly, when the five video reels 3a to 3e (five reel strips) are stopped, 5 reels×3 rows (5 columns by 3 rows) of symbols, or 15 symbols in total, are rearranged in the symbol display area 141d.

As described above, 15 stop positions (5 reels×3 rows) are defined in the symbol display area 141d. The 15 stop positions correspond to 15 cells to show symbols (see FIG. 34). Stopping a symbol at each of the 15 stop positions (cells) rearranges 15 symbols. Rearranging 15 symbols corresponds to forming a symbol matrix.

### <Kinds of Symbols>

The slot machine 10 in the present embodiment has the following kinds of symbols: WILD (wild symbol), PICT_A, PICT_B, PICT_C, PICT_D, PICT_E, ACE, KING, QUEEN, JACK, TEN, FEATURE (trigger or retrigger symbol), CHANGE (to-be replaced symbol), M-CHANGE (to-be replaced mighty symbol), and BLANK (blank symbol).

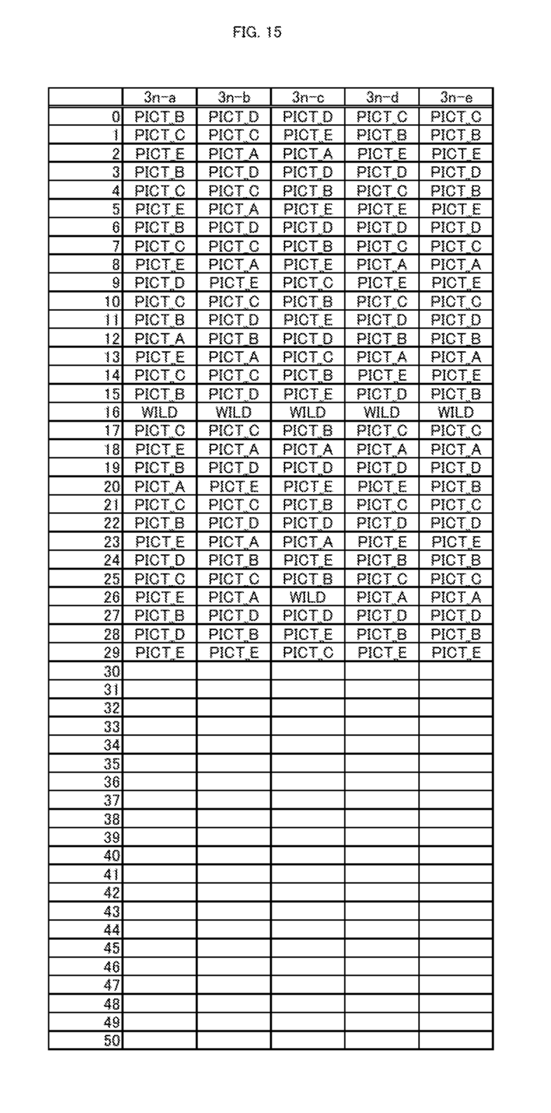

The WILD, PICT_A, PICT_B, PICT_C, PICT_D, PICT_E, ACE, KING, QUEEN, JACK, TEN, and FEATURE symbols are disposed on the normal reel strips 3n-a, 3n-b, 3n-c, 3n-d, and 3n-e (see FIGS. 14A and 14B, and FIG. 15). These kinds of symbols can be a constituent of winning patterns and referred to as element symbols (see FIG. 13).

The CHANGE symbols are disposed on two replacement reel strips 3x-a and 3x-e. The M_CHANGE symbols are disposed on three replacement reel strips 3x-b, 3x-c, and 3x-d. The BLANK symbols are disposed on the replacement reel strips 3x-a, 3x-b, 3x-c, 3x-d, and 3x-e (see FIGS. 17A to 17C, FIGS. 18A to 18C, and FIGS. 19A to 19C). The CHANGE and the M_CHANGE symbols are to be replaced by element symbols and referred to as to-be replaced symbols.

The WILD, FEATURE, CHANGE, M_CHANGE, and BLANK symbols function as special symbols. The symbols other than the special symbols are normal symbols. The normal symbols are PICT_A, PICT_B, PICT_C, PICT_D, PICT_E, ACE, KING, QUEEN, JACK, and TEN symbols. The symbols including the WILD and the FEATURE symbols in addition to these are element symbols.

The WILD is a kind of symbols that can be a substitute for another kind of symbol. A WILD symbol is replaced with another kind of symbol to make a higher-ranked winning pattern. The WILD symbol can be replaced by a symbol other than a FEATURE symbol.

The FEATURE is a kind of symbol that triggers a mode change from base game mode to free game mode. The FEATURE is also a kind of symbol that retriggers free game mode to maintain the free game mode.

In free game mode, special symbols such as FEATURE symbols or WILD symbols may be increased. The FEATURE symbols may have a function to increase the games in the free game mode.

The FEATURE symbols are scatter symbols. When a predetermined number, for example one, of FEATURE symbol is determined to appear in the symbol display area 141d in symbol lottery processing, even if a plurality of FEATURE symbols are not continuously arranged from left to right, a winning pattern is completed.

The BLANK symbols are disposed only on the replacement reel strips 3x-a to 3x-e. The BLANK symbols are not displayed in the symbol display area 141d. When a BLANK on a replacement reel strip 3x and a symbol on a normal reel strip 3n are stacked, the WILD, PICT_A, PICT_B, PICT_C, PICT_D, PICT_E, ACE, KING, QUEEN, JACK, TEN, or FEATURE symbol on the normal reel strip 3n is displayed selectively.

The CHANGE symbols (to-be replaced symbols) are disposed on two replacement reel strips 3x-a and 3x-e. The CHANGE symbols are virtual symbols to be replaced by any of the WILD, PICT_A, PICT_B, PICT_C, PICT_D, PICT_E, ACE, KING, QUEEN, JACK, and TEN symbols. The symbol display area 141d does not show a CHANGE symbol but shows one of the WILD, PICT_A, PICT_B, PICT_C, PICT_D, PICT_E, ACE, KING, QUEEN, JACK, and TEN symbol that has replaced the CHANGE symbol. A CHANGE symbol has a size of one frame for a symbol (one cell).

The M_CHANGE symbols are disposed on three replacement reel strips 3x-b, 3x-c, and 3x-d. The M_CHANGE symbols are virtual symbols to be replaced by any of the WILD, PICT_A, PICT_B, PICT_C, PICT_D, PICT_E, ACE, KING, QUEEN, JACK, TEN, and FEATURE symbols. Unlike the CHANGE symbols, the M_CHANGE symbols can be replaced by FEATURE symbols. Like the CHANGE symbols, the symbol display area 141d does not show an M_CHANGE symbol but shows one of the WILD, PICT_A, PICT_B, PICT_C, PICT_D, PICT_E, ACE, KING, QUEEN, JACK, TEN, and FEATURE symbols that has replaced the M_CHANGE symbol.

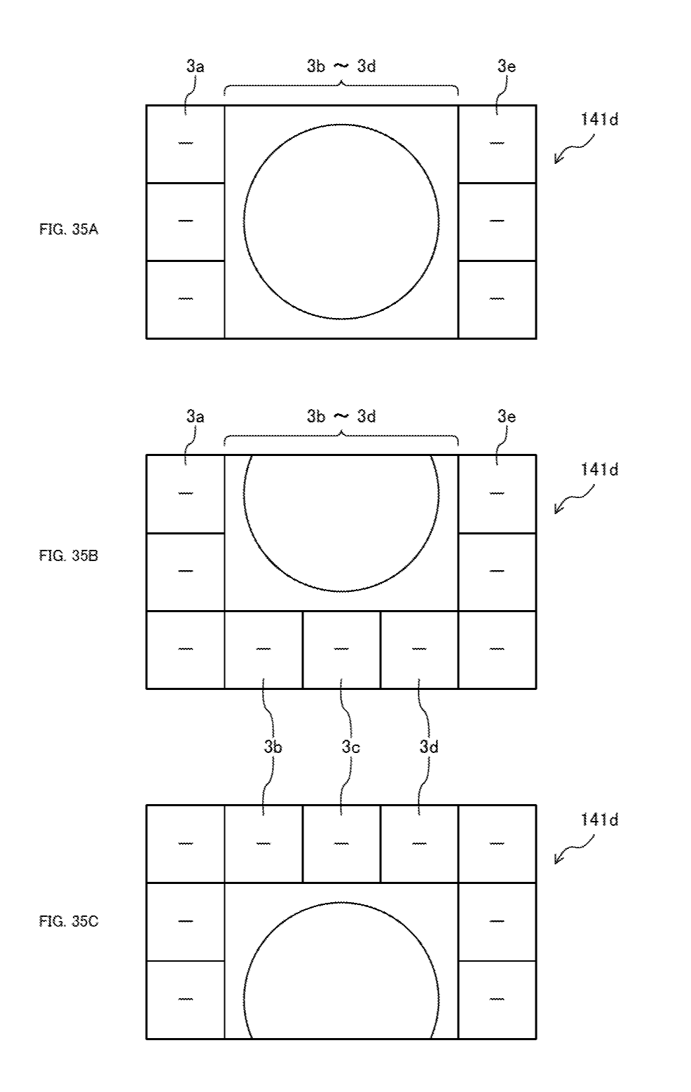

The M_CHANGE symbols are to show a mighty symbol. The mighty symbol has a width of three video reels 3b to 3d and a length of three symbols disposed along the scrolling direction (longitudinal direction) of the video reels 3b to 3d. That is to say, the mighty symbol is a symbol formed over three reels by three rows (three columns by three rows) and has a size of nine frames of symbols (nine cells) (see FIGS. 35 to 37). The M_CHANGE symbols are replaced by one kind of symbols out of the WILD, PICT_A, PICT_B, PICT_C, PICT_D, PICT_E, ACE, KING, QUEEN, JACK, TEN, and FEATURE, and a mighty symbol having a size of nine cells is shown in the symbol display area 141d.

The mighty symbol is shown over the three video reels 3b, 3c, and 3d. FIG. 35A provides an example where a mighty symbol appears on the top row, the middle row, and the bottom row on the video reels 3b to 3d to show the entirety of the mighty symbol in the symbol display area 141d. FIG. 35B provides an example where the mighty symbol appears on the top row and the middle row on the video reels 3b to 3d to show a part of the mighty symbol in the symbol display area 141d. FIG. 35C provides an example where the mighty symbol appears on the middle row and the bottom row on the video reels 3b to 3d to show a part of the mighty symbol in the symbol display area 141d.

The mighty symbol may appear partially or entirely in the symbol display area 141d depending on the result of symbol lottery processing. In FIGS. 35A to 35C, the symbols other than the mighty symbol are simplified and denoted by “-”.

As described above, the normal reel strips 3n and the replacement reel strips 3x are stacked to be displayed in any game mode of the base game mode, free game mode, and re-spin feature game mode. The replacement reel strips 3x include BLANK, CHANGE, and M_CHANGE symbols.

The CHANGE and M_CHANGE symbols are replaced by normal symbols as well as WILD and FEATURE symbols. When a normal reel strip 3n and a replacement reel 3x are stacked, the symbol that has replaced the CHANGE or M_CHANGE is shown in the symbol display area 141d selectively.

When a normal reel strip 3n and a replacement reel strip 3x are stacked, a BLANK symbol on the replacement reel strip 3x is not shown in the symbol display area 141d and the symbol disposed at the corresponding position on the normal reel strip 3n is selectively shown.

Although the normal reel strips 3n and the replacement reel strips 3x are stacked to be displayed as described above, the CHANGE, M_CHANGE, and BLANK symbols are not shown in the symbol display area 141d.

### <Payline>

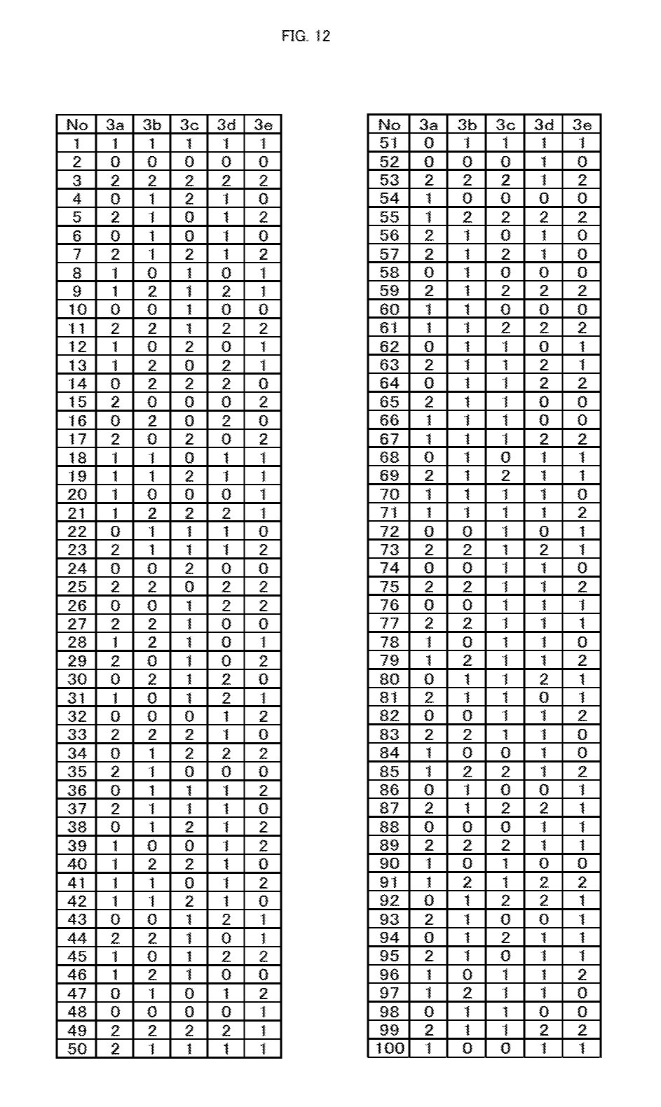

The slot machine 10 has 100 paylines in the symbol display area 141d (see FIG. 12). Whether any winning pattern is completed is determined depending on the kind and the number of symbols arranged along each payline. In the slot machine 10, paylines to be activated are selected in accordance with the multiplier to be applied to the prizes.

In FIG. 12, “0” represents the top row (first row), “1” represents the middle row (second row), and “2” represents the bottom row (third row). For example, the payline No. 5 is a payline connecting the bottom row—the middle row—the top row—the middle row—the bottom row of the video reels 3a, 3b, 3c, 3d, and 3e, respectively.

### <Multiplier of Bet>

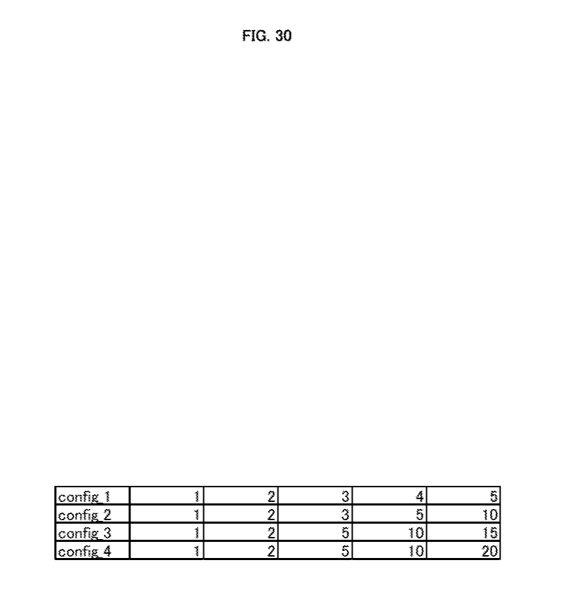

FIG. 30 is a table for providing patterns of multipliers for the prizes. FIG. 30 shows a combination of multipliers specified for each of config_1 to config_4. Hereinafter, config_1 is referred to as first configuration pattern, config_2 as second configuration pattern, config_3 as third configuration pattern, and config_4 as fourth configuration pattern.

The slot machine 10 has four configuration patterns of multipliers for the prize: (1) 1, 2, 3, 4, and 5 (the first configuration pattern), (2) 1, 2, 3, 5, and 10 (the second configuration pattern), (3) 1, 2, 5, 10, and 15 (the third configuration pattern), and (4) 1, 2, 5, 10, and 20 (the fourth configuration pattern).

These numerals are multipliers for each payline. One of the four configuration patterns is set to the slot machine 10 by, for example, the game hall staff such as casino staff.

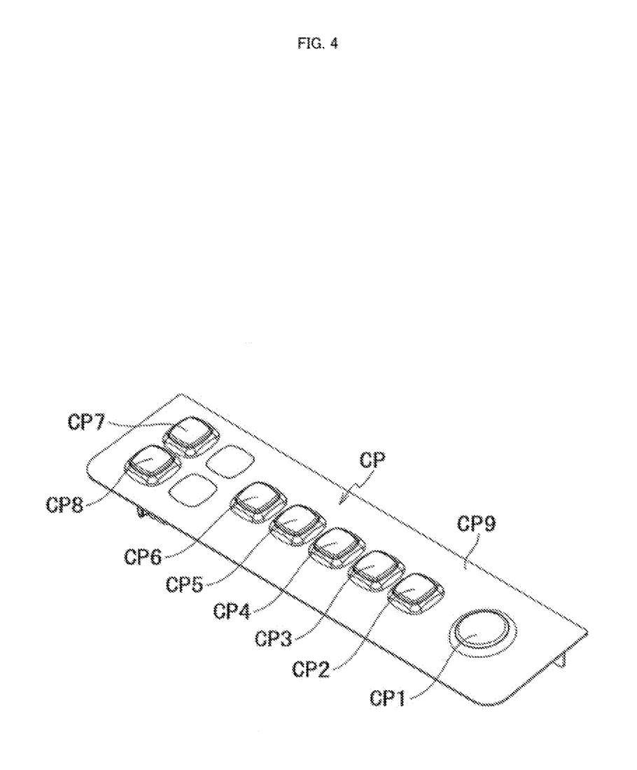

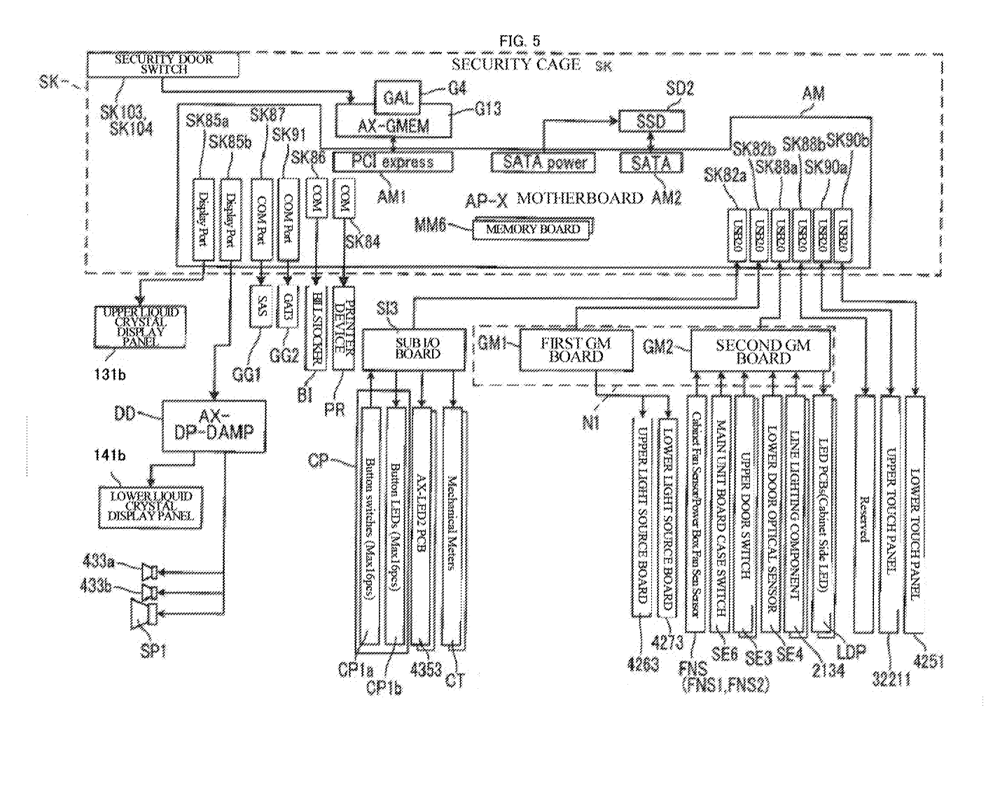

The multiplier for the prize is determined by the player through operation of one of the five operation buttons CP6, CP5, CP4, CP3, and CP2 (see FIG. 4) before starting a unit game.

According to the first configuration pattern, when the operation button CP6 is operated, the multiplier is determined to be 1. When the operation button CP5 is operated, the multiplier is determined to be 2. When the operation button CP4 is operated, the multiplier is determined to be 3. When the operation button CP3 is operated, the multiplier is determined to be 4. When the operation button CP2 is operated, the multiplier is determined to be 5.

According to the second configuration pattern, when the operation button CP6 is operated, the multiplier is determined to be 1. When the operation button CP5 is operated, the multiplier is determined to be 2. When the operation button CP4 is operated, the multiplier is determined to be 3. When the operation button CP3 is operated, the multiplier is determined to be 5. When the operation button CP2 is operated, the multiplier is determined to be 10.

According to the third configuration pattern, when the operation button CP6 is operated, the multiplier is determined to be 1. When the operation button CP5 is operated, the multiplier is determined to be 2. When the operation button CP4 is operated, the multiplier is determined to be 5. When the operation button CP3 is operated, the multiplier is determined to be 10. When the operation button CP2 is operated, the multiplier is determined to be 15.

According to the fourth configuration pattern, when the operation button CP6 is operated, the multiplier is determined to be 1. When the operation button CP5 is operated, the multiplier is determined to be 2. When the operation button CP4 is operated, the multiplier is determined to be 5. When the operation button CP3 is operated, the multiplier is determined to be 10. When the operation button CP2 is operated, the multiplier is determined to be 20.

### <Activation of Paylines>

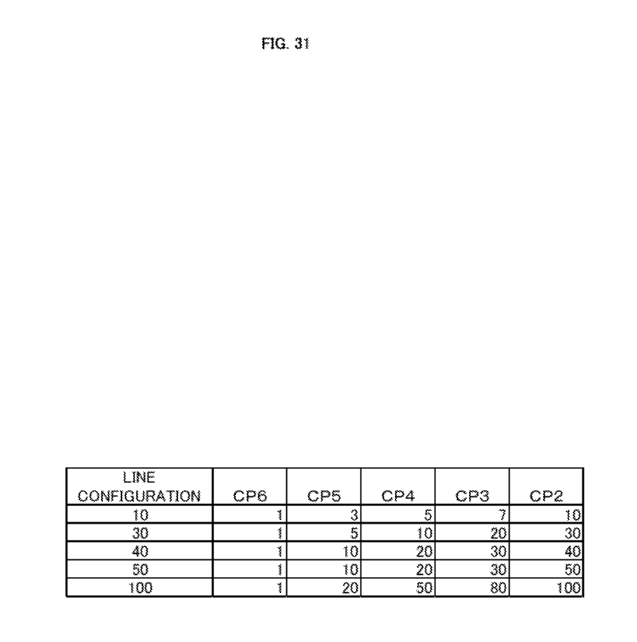

FIG. 31 is a table for providing patterns of the numbers of paylines to be activated in response to operation of the operation buttons CP6 to CP2. FIG. 31 shows a combination of the numbers of paylines to be activated specified for each of the five configurations: LINE configuration 10, LINE configuration 30, LINE configuration 40, LINE configuration 50, and LINE configuration 100.

One of the five LINE configuration patterns is set to the slot machine 10 by, for example, the game hall staff such as casino staff.

According to the LINE configuration 10, when the operation button CP6 is operated, one payline is activated. When the operation button CP5 is operated, three paylines are activated. When the operation button CP4 is operated, five paylines are activated. When the operation button CP3 is operated, seven paylines are activated. When the operation button CP2 is operated, ten paylines are activated.

According to the LINE configuration 30, when the operation button CP6 is operated, one payline is activated. When the operation button CP5 is operated, five paylines are activated. When the operation button CP4 is operated, ten paylines are activated. When the operation button CP3 is operated, 20 paylines are activated. When the operation button CP2 is operated, 30 paylines are activated.

According to the LINE configuration 40, when the operation button CP6 is operated, one payline is activated. When the operation button CP5 is operated, ten paylines are activated. When the operation button CP4 is operated, 20 paylines are activated. When the operation button CP3 is operated, 30 paylines are activated. When the operation button CP2 is operated, 40 paylines are activated.

According to the LINE configuration 50, when the operation button CP6 is operated, one payline is activated. When the operation button CP5 is operated, ten paylines are activated. When the operation button CP4 is operated, 20 paylines are activated. When the operation button CP3 is operated, 30 paylines are activated. When the operation button CP2 is operated, 50 paylines are activated.

According to the LINE configuration 100, when the operation button CP6 is operated, one payline is activated. When the operation button CP5 is operated, 20 paylines are activated. When the operation button CP4 is operated, 50 paylines are activated. When the operation button CP3 is operated, 80 paylines are activated. When the operation button CP2 is operated, 100 paylines are activated.

The MAX LINEs in the LINE configuration 10 are ten paylines; the MAX LINEs in the LINE configuration 30 are 30 paylines; the MAX LINEs in the LINE configuration 40 are 40 paylines; the MAX LINEs in the LINE configuration 50 are 50 paylines; and the MAX LINEs in the LINE configuration 100 are 100 paylines. These LINE configurations are selectable by the game hall staff such as casino staff.

Denomination (the minimum amount for a bet) can also be selected by the game hall staff within a range from 0.01 to 10 dollars.

As described above, the MAX LINEs and the denomination can be set by the game hall differently to each slot machine 10 in view of the circumstances or preference of the game hall. That is to say, the slot machine 10 has a function for the game hall (administrator) to change the MAX LINEs and the denomination; the game hall can make settings for the slot machines 10 differently for various types of players including high rollers, even though the slot machines 10 are the same model.

Accordingly, the game hall does not need to separately prepare machines for high rollers and machines for the other types of players but changes the MAX LINEs and the denomination in accordance with the results of marketing held in advance to reflect the players' preferences different depending on the hour. As a result, the game hall can save the cost to improve their business conditions.

### <Completion of Winning Pattern>

The kinds of symbols involved with winning patterns are WILD, PICT_A, PICT_B, PICT_C, PICT_D, PICT_E, ACE, KING, QUEEN, JACK, TEN, and FEATURE. These kinds of symbols are element symbols.

As to the WILD, PICT_A, PICT_B, PICT_C, PICT_D, PICT_E, ACE, KING, QUEEN, JACK, and TEN excluding the FEATURE, whether a winning pattern is completed is determined on a left-to-right basis. Whether a winning pattern is completed is determined depending on the number of a specific kind of symbols continuously arranged along each payline from left to right.

That is to say, the kind and the number of symbols arranged along a payline continuously from the leftmost video reel 3a toward the rightmost video reel 3e determine a prize. The same kind of symbols arranged along a payline continuously from the video reel 3b, 3c, or 3d do not complete any winning pattern; no prize is awarded.

Winning patterns of twelve kinds of symbols are defined as shown in FIG. 13 to be described later. Details of the winning patterns will be described later.

The FEATURE symbols are scatter symbols. Accordingly, when a specified number of FEATURE symbols are shown in the symbol display area 141d, a winning pattern is completed even if they are not continued from left to right.

### <Free Game Mode>

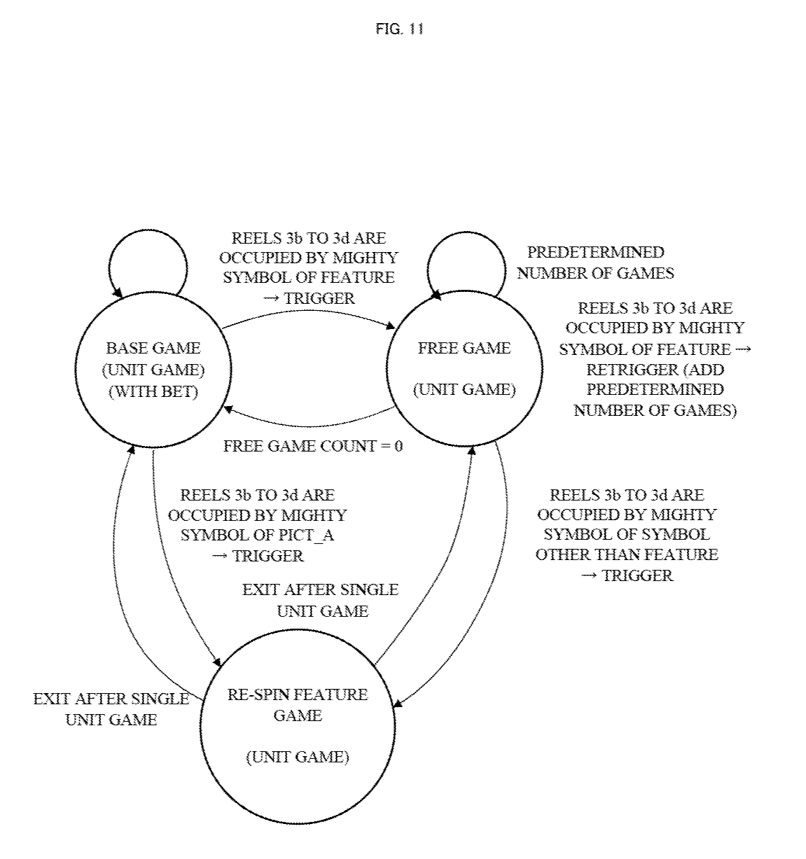

Appearance of the entirety of a mighty symbol of FEATURE over the video reels 3b to 3d in base game mode triggers free game mode (see FIG. 11). The mighty symbol is a symbol formed in the range of three reels by three rows (three columns by three rows) and has a size of nine frames (nine cells). Appearance of a part of the FEATURE symbol, instead of the entirety thereof, does not trigger free game mode.

In the free game mode, the player can play a predetermined number of unit games (free games) (see FIG. 11). The reel strips used in the free game mode are different from the reel strips used in base game mode. Appearance of the entirety of one FEATURE symbol over the video reels 3b to 3d as a mighty symbol in free game mode retriggers the free game mode (see FIG. 11). In response to the retrigger, another predetermined number of unit games are added. No upper limit is provided for the number of retriggers.

The present embodiment provides three kinds of free game modes and the slot machine 10 is configured to perform one of them. The three kinds of free game modes are different in the reel strips to be used and the number of unit games. The slot machine 10 may store the programs for all the three kinds of free game modes in the main RAM 210 and execute one of them selected by the game hall staff.

The first free game mode provides eight unit games (free games) in response to a free game trigger and provides another eight unit games (free games) in response to a free game retrigger.

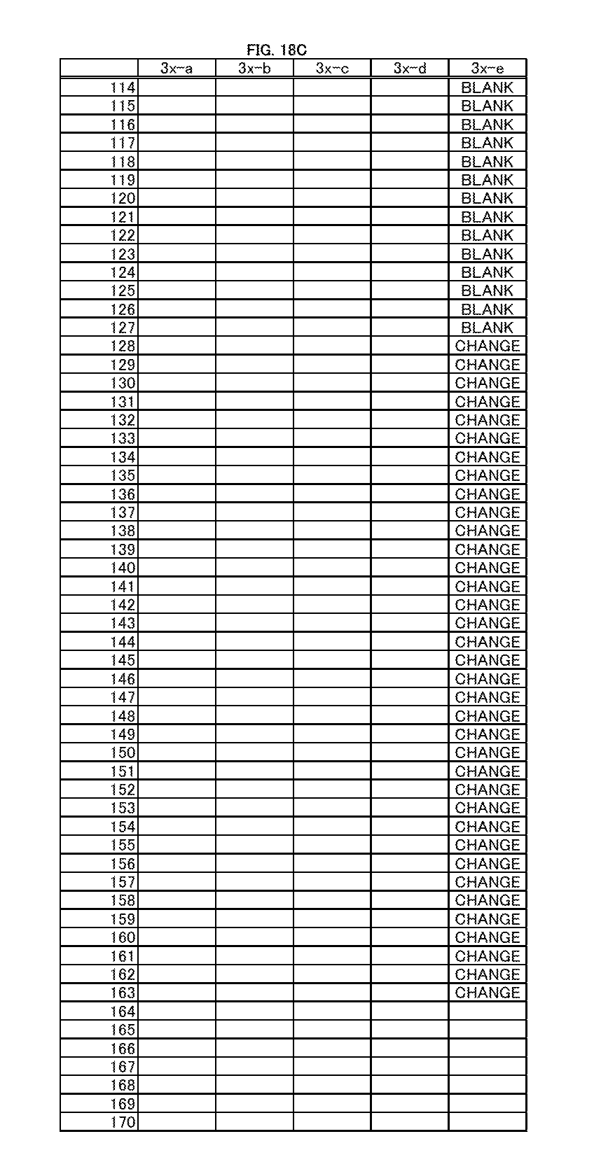

The first free game mode uses the normal reel strips 3n for free game mode shown in FIG. 15 and the replacement reel strips 3x for free game mode shown in FIGS. 18A to 18C.

The normal reel strips 3n for the first free game mode include only WILD, PICT_A, PICT_B, PICT_C, PICT_D, and PICT_E symbols as shown in FIG. 15. The replacement reel strips 3x for the first free game mode include only CHANGE, M_CHANGE, and BLANK symbols as shown in FIGS. 18A to 18C, like the replacement reel strips 3x for base game mode.

The second free game mode provides a selection game in response to completion of a free game trigger or a free game retrigger to determine the number of games and the replacement symbol determination table depending on the choice of the player. The selection game will be described later in detail.

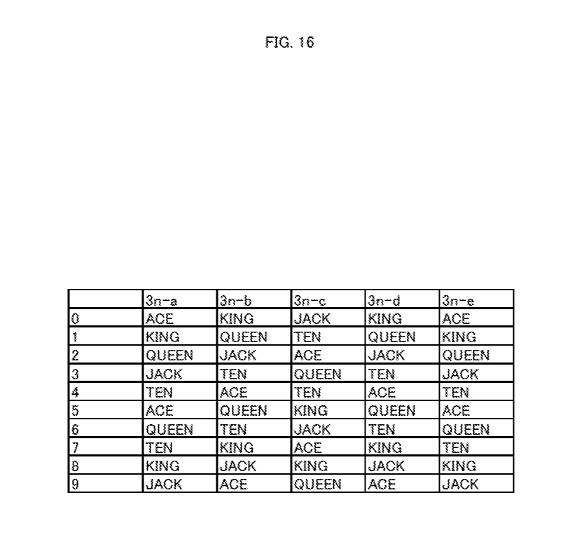

The second free game mode uses the normal reel strips 3n for free game mode shown in FIG. 16 and the replacement reel strips 3x for free game mode shown in FIGS. 18A to 18C.

The normal reel strips 3n for the second free game mode include only ACE, KING, QUEEN, JACK, and TEN symbols as shown in FIG. 16. The replacement reel strips 3x for the second free game mode include only CHANGE, M_CHANGE, and BLANK symbols as shown in FIGS. 18A to 18C, like the replacement reel strips 3x for the first free game mode.

The third free game mode provides seven unit games (free games) in response to a free game trigger and provides another seven unit games (free games) in response to a free game retrigger.

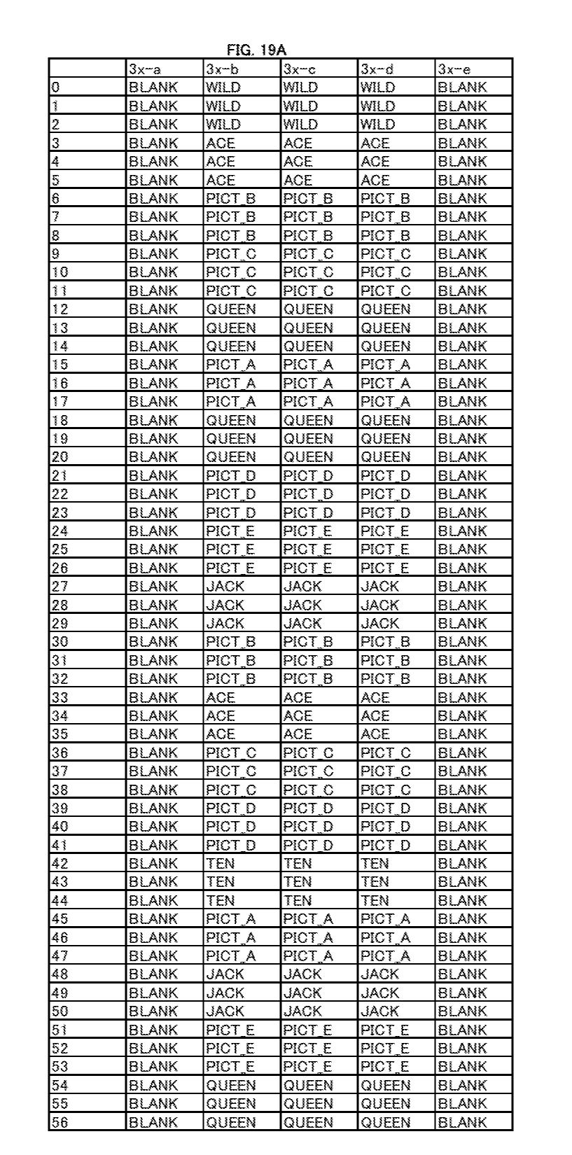

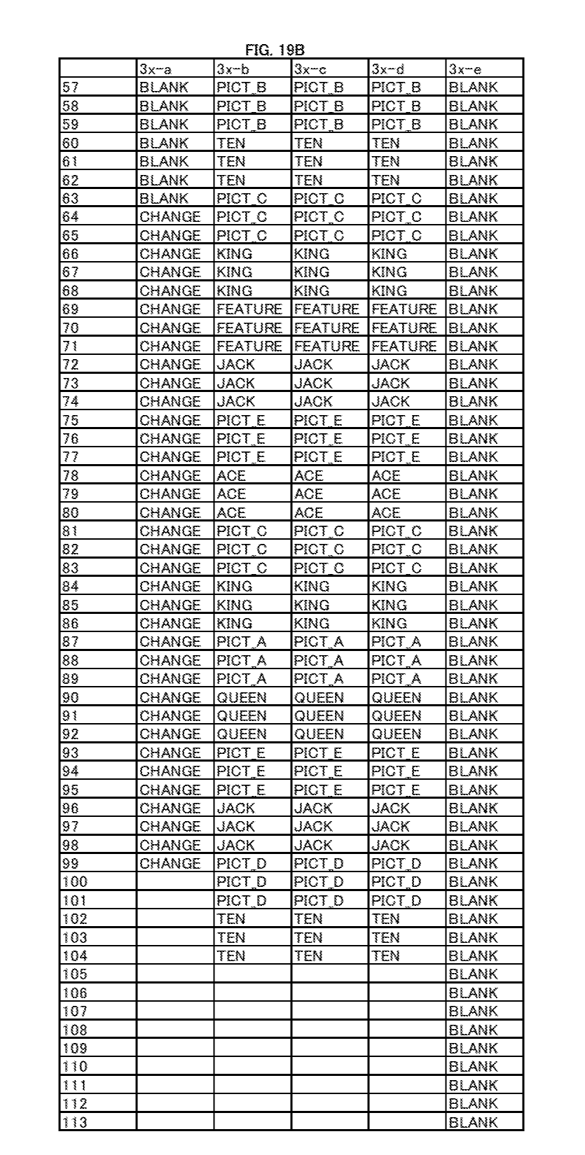

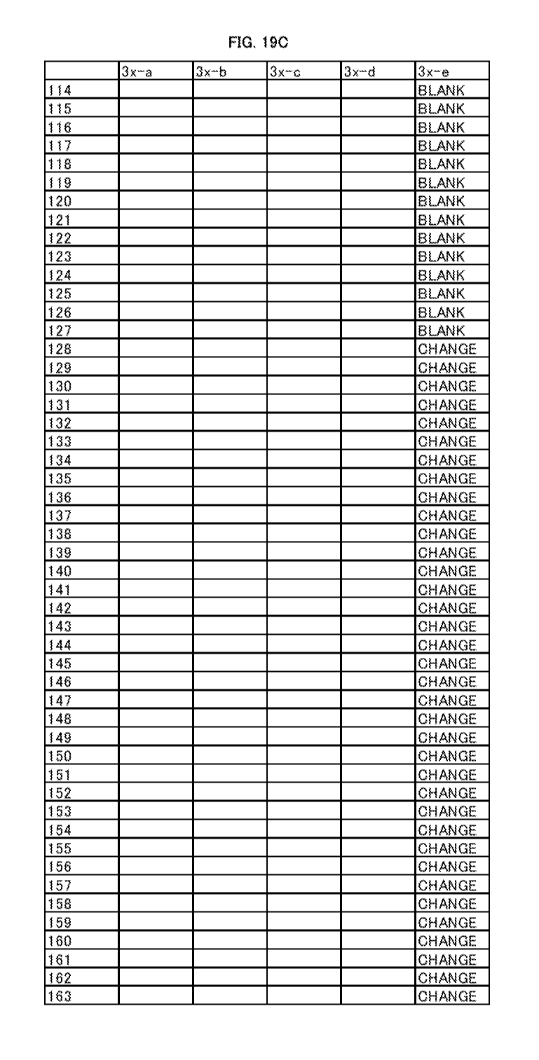

The third free game mode uses the normal reel strips 3n for free game mode shown in FIGS. 14A and 14B and the replacement reel strips 3x for free game mode shown in FIGS. 19A to 19C.

The normal reel strips 3n for the third free game mode are the same as the normal reel strips 3n for base game mode shown in FIGS. 14A and 14B. As shown in FIGS. 19A to 19C, the replacement reel strips 3x-a and 3x-e for the third free game mode include only CHANGE and BLANK symbols. The replacement reel strips 3x-b to 3x-d for the third free game mode do not include an M_CHANGE symbol and include PICT_A, PICT_B, PICT_C, PICT_D, and PICT_E, ACE, KING, QUEEN, JACK, and TEN symbols, and in addition, WILD, and FEATURE symbols. In the third free game mode, winning patterns of WILD can be completed. In the meanwhile, all the symbols on the reel strips 3x-b to 3x-d are defined to have a size of 3×3 of nine frames, so that they can be displayed as a mighty symbol.

### <Re-Spin Feature Game Mode>

Appearance of the entirety of a mighty symbol of PICT_A over the video reels 3b to 3d in base game mode triggers re-spin feature game mode (see FIG. 11). Appearance of only a part of the mighty symbol of PICT_A, instead of the entirety thereof, does not trigger re-spin feature game mode.

Appearance of the entirety of a mighty symbol of a kind other than FEATURE over the video reels 3b to 3d in free game mode triggers re-spin feature game mode (see FIG. 11). Appearance of only a part of the symbol, instead of the entirety thereof, does not trigger re-spin feature game mode.

The re-spin feature game mode provides one unit game (free game) while maintaining (holding) the state showing the mighty symbol when the re-spin feature game mode is triggered. There is no retrigger in the re-spin feature game mode; the game mode returns to the previous game mode when the one unit game is finished.

Since the re-spin feature game mode holds the mighty symbol when the re-spin feature game mode is triggered, the three video reels 3b to 3d are kept still without being spun in the display. Only the two video reels 3a and 3e are spun.

The CHANGE symbols on the replacement reel strips 3x-a and 3x-e for the two video reels 3a and 3e are replaced by the same kind of symbols as the mighty symbol held on the three video reels 3b to 3d.

### <<Outline of Symbol Replacement and Reel Strip Scroll>>

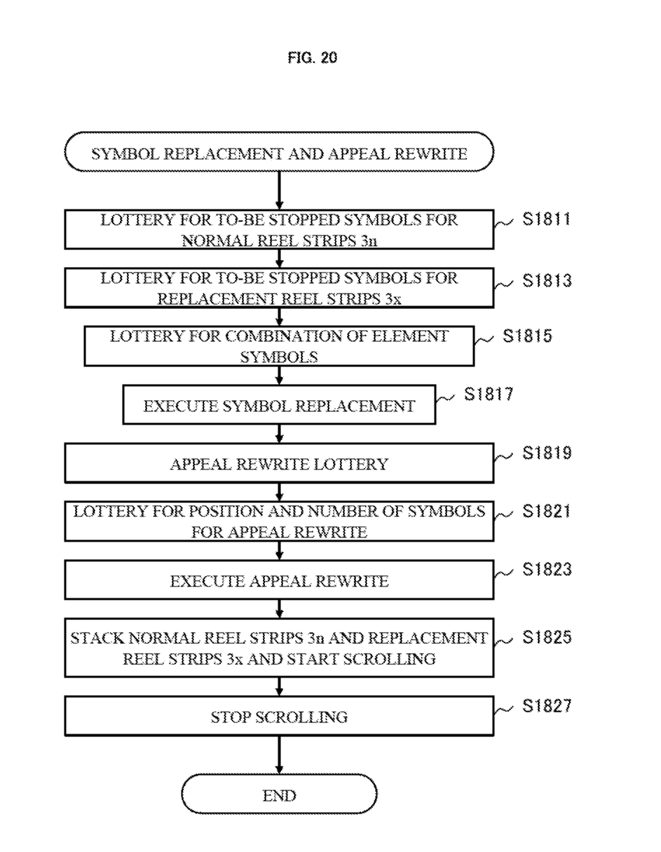

FIG. 20 is a flowchart for providing the outline of symbol replacement and reel strip scroll.

First, the slot machine 10 determines five to-be stopped symbols for the normal reel strips 3n by lottery (step S1811). That is to say, the slot machine 10 determines to-be stopped symbols for the normal reel strips 3n-a, 3n-b, 3n-c, 3n-d, and 3n-e.

Next, the slot machine 10 determines five to-be stopped symbols for the replacement reel strips 3x by lottery (step S1813). That is to say, the slot machine 10 determines to-be stopped symbols for the replacement reel strips 3x-a, 3x-b, 3x-c, 3x-d, and 3x-e.

Next, the slot machine 10 determines a combination of element symbols by lottery (step S1815). The combination of element symbols is a combination of symbols to replace the CHANGE symbols on the reel strip 3x-a, symbols to replace the CHANGE symbols on the reel strip 3x-e, and symbols to replace the M_CHANGE symbols on the reel strips 3x-b to 3x-d. The element symbols are normal symbols, WILD symbols, and FEATURE symbols. The normal symbols are PICT_A, PICT_B, PICT_C, PICT_D, and PICT_E, ACE, KING, QUEEN, JACK, and TEN symbols. Replacing the M_CHANGE symbols on the replacement reel strips 3x-b to 3x-d by the determined element symbols results in displaying the element symbols as a mighty symbol.

Next, symbol replacement is executed (step S1817). As a result, the CHANGE and M_CHANGE symbols on the replacement reel strips 3x are replaced by the element symbols determined by the lottery at step S1815. Specifically, the CHANGE symbols on the reel strips 3x-a and 3x-e are replaced by element symbols. The M_CHANGE symbols on the reel strips 3x-b to 3x-d are replaced by mighty symbols of the element symbol.

Through the symbol replacement of this step S1817, all the CHANGE and M_CHANGE symbols on the replacement reel strips 3x are replaced by element symbols, so that the replacement reel strips 3x include only the element symbols and BLANK symbols.

Next, the slot machine 10 determines whether to execute appeal rewrite by lottery (step S1819). The appeal rewrite is replacing symbols included in the replacement reel strips 3x by a specific kind of element symbols to display the specific kind of element symbols immediately after the start of scrolling. It is preferable that a plurality of consecutive symbols be rewritten with the specific kind of element symbols. Then, the specific kind of element symbols will be successively shown immediately after the start of scrolling; the player can easily recognize the element symbols and feel expectation for completion of winning patterns of the element symbol.

If the appeal rewrite is determined to be executed, the slot machine 10 determines the position and the number of symbols for the appeal rewrite by lottery (step S1821).

Next, the slot machine 10 executes appeal rewrite (step S1823). The slot machine 10 rewrites symbols on the replacement reel strips 3x with a specific kind of element symbols. The appeal rewrite is performed by rewriting the data of the symbols expanded on the video RAM.

The slot machine 10 stacks the normal reel strips 3n and the replacement reel strips 3x and starts scrolling (step S1825). As described above, the replacement reel strips 3x at this step include only element symbols and BLANK symbols.

The stacking of the normal reel strips 3n and the replacement reel strips 3x are performed as follows. In the case where the symbol on a replacement reel strip 3x is an element symbol other than a BLANK symbol, the slot machine 10 displays scrolling of a reel strip while selectively showing the symbol of the replacement reel strip 3x. The mighty symbol of the element symbol that has replaced M_CHANGEs on the replacement reel strips 3x-b to 3x-d is shown on the reel strips being scrolled. However, in the case where the symbol on a replacement reel strip 3x is a BLANK symbol, the slot machine 10 displays scrolling of a reel strip while selectively showing the symbol on the normal reel strip 3n.

The slot machine 10 stops scrolling the normal reel strips 3n and the replacement reel strips 3x (step S1827). As a result, symbols are rearranged in the symbol display area 141d to show a result of the game.

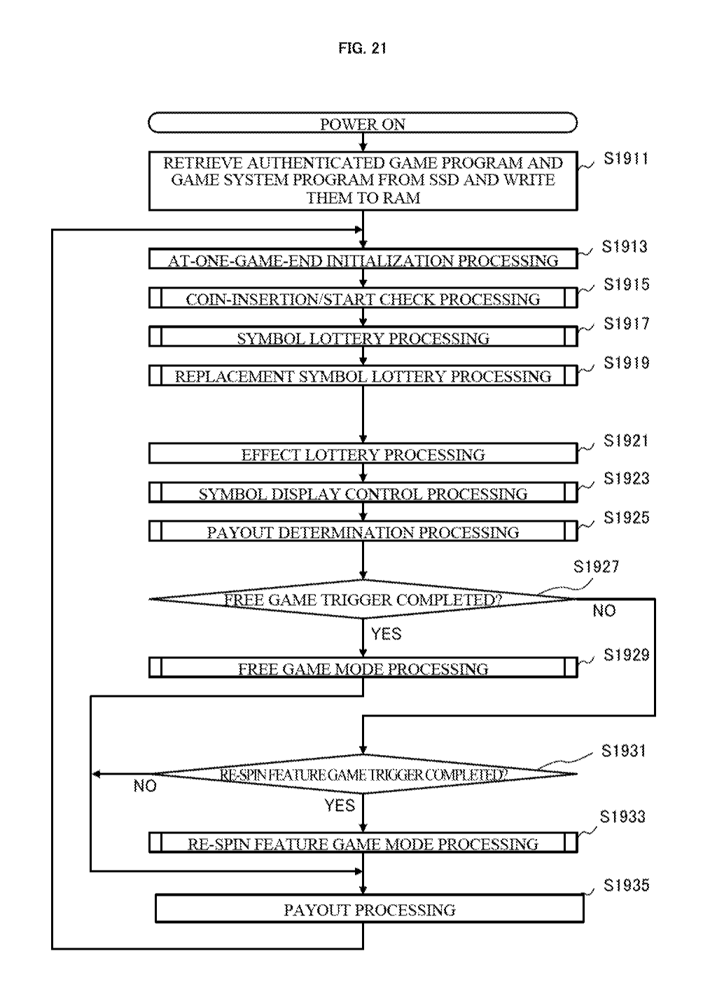

Specific processing of symbol replacement and reel strip scroll will be described later with FIGS. 21 to 29.

### <<<Overall Configuration of Slot Machine 10>>>

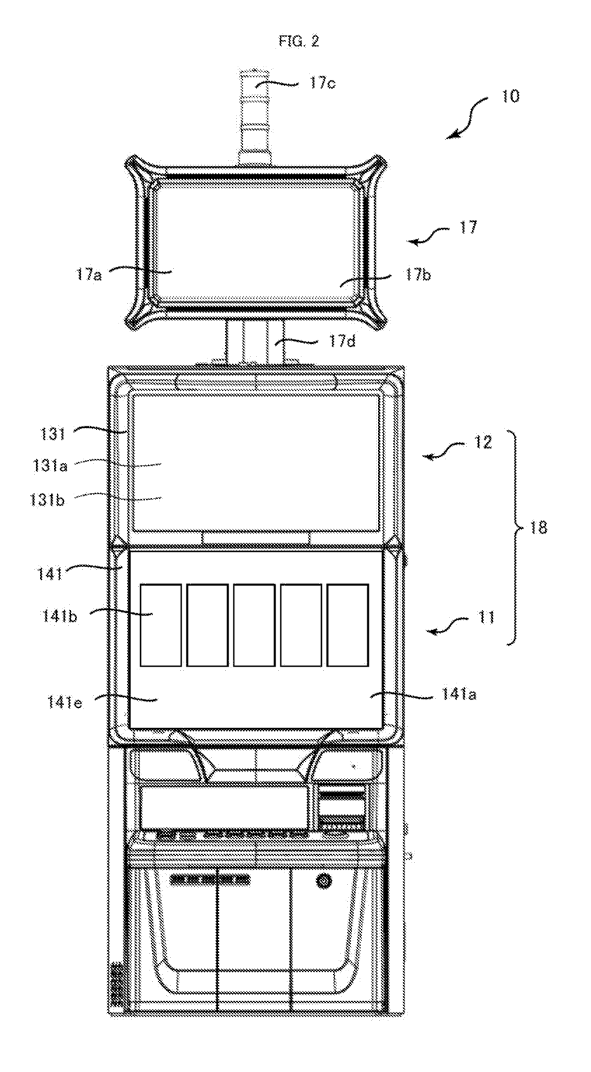

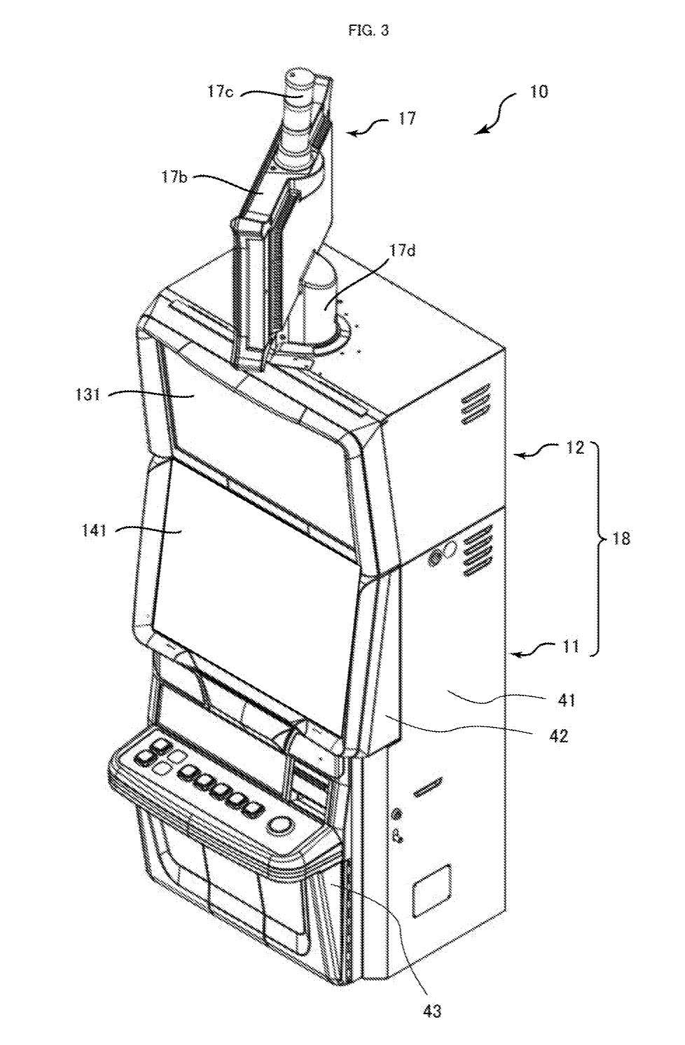

As illustrated in FIGS. 2 and 3, a slot machine 10 as a gaming machine includes a topper unit 17 and a gaming machine main body 18. The topper unit 17 is mounted on the top face of the gaming machine main body 18. The gaming machine main body 18 includes a top unit 12 and a main unit 11. The top unit 12 includes an upper display unit 131. The top unit 12 is mounted on the top face of the main unit 11. The main unit 11 includes a lower display unit 141.

The topper unit 17 has a function to draw attention to the slot machine 10 from distant places and a function to advertise the games of the slot machine 10 to distant places. The top unit 12 has a function to display the specifics of the games, a payout table, and game-related information such as rules. The main unit 11 has a function to perform the games.

In the present embodiment, the region (direction) of the slot machine 10 facing (toward) the player is referred to as front (forward), the opposite region (direction) to the front (forward) is referred to as back (backward or depth direction), the right and the left as seen from the player are respectively referred to as right (rightward) and left (leftward) of the slot machine 10. The extent between the front and the back is referred to as front-to-back, thickness, or depth; the extent between the right and the left are referred to as left-to-right or width. The extent orthogonal to the front-to-back (thickness or depth) and the left-to-right (width) are referred to as top-to-bottom or height.

### <Outline of Topper Unit 17>

The topper unit 17 is provided on the top face of the top unit 12 to be located at the highest position of the slot machine 10. The topper unit 17 has a rotary shaft standing in the direction of the height of the slot machine 10 and is rotatable within a predetermined angle in a right direction (clockwise direction) and a reverse direction (counterclockwise direction) about this rotary shaft. This structure enables the topper unit 17 to switch its position between the front position (FIG. 2) where the screen 17a for displaying information on the games faces forward and an oblique position (FIG. 3) where the screen 17a faces obliquely forward.

The front position is selected in a normal state when games are being played or the slot machine 10 is standing by to show information on the game to people (players or game hall staff) distant from the slot machine 10. The oblique position is a special position to be selected to change the indication of the topper unit 17. As shown in FIG. 3, by turning the topper unit 17 so that the right end of the topper unit 17 will come forward, the oblique position allows the operation to change the indication of the topper unit 17 from the front of the slot machine 10.

### <Specific Configuration of Topper Unit 17>

As shown in FIGS. 2 and 3, the topper unit 17 includes a topper body 17b including a screen 17a and a tower member 17c provided on the top face of the topper body 17b. The tower member 17c has a cylindrical clear resin cover and has a light emission device like an LED therein. The tower member 17c shines at the top of the slot machine 10 in a single color or multiple colors to easily inform distant people of the place or the state of the slot machine 10.

The topper unit 17 has a topper support device 17d as shown in FIGS. 2 and 3. The topper support device 17d supports the topper body 17b to be horizontally rotatable within a specific angle with respect to the top unit 12.

### <Top Unit 12>

The topper unit 17 structured as described above is provided on the top of the top unit 12 as shown in FIGS. 2 and 3. The top unit 12 includes an upper display unit 131 provided on the front of the top unit 12. On the top face of the top unit 12, the topper body 17b is supported by the topper support device 17d to be horizontally rotatable within a specific angle with respect to the top unit 12.

### <Upper Display Unit 131>

The upper display unit 131 includes an upper touch panel 131a provided on the front, an upper liquid crystal display panel 131b provided behind the upper touch panel 131a, and an upper control board base 131c.

The upper liquid crystal display panel 131b displays motion picture such as a video and image data of still pictures such as characters and figures. The upper touch panel 131a transmits the images shown on the upper liquid crystal display panel 131b for the player to see the images and enables touch operations on the screen with the player's fingertip. The upper control board base 131c includes not-shown control boards for controlling the display of the upper liquid crystal display panel 131b inside thereof.

### <Main Unit 11>

The top unit 12 structured as described above is provided on the top of the main unit 11. The main unit 11 includes a lower display unit 141, an upper door unit 42, and a lower door unit 43 provided under the lower display unit 141 and on the front of the main unit 11. The upper door unit 42 and the lower door unit 43 are openable with respect to a gaming mechanism unit 41. The upper door unit 42 is structured to be allowed to open only when the lower door unit 43 is open.

### <Lower Display Unit 141>

The lower display unit 141 includes a lower touch panel 141a provided on the front, a lower liquid crystal display panel 141b provided behind the lower touch panel 141a, and a lower control board base 141c.

The lower liquid crystal display panel 141b mainly shows images of five video reels 3a to 3e. The lower liquid crystal display panel 141b also shows motion picture such as a video and image data of still pictures such as characters and figures. The lower touch panel 141a transmits the images shown on the lower liquid crystal display panel 141b for the player to see the images and enables touch operations on the screen with the player's fingertip. The lower control board base 141c includes not-shown control boards for controlling the lower liquid crystal display panel 141b inside thereof.

The lower display unit 141 has a symbol display area 141d. The images of the five video reels 3a to 3e are displayed in the symbol display area 141d. The five video reels 3a to 3e are moved or stopped in the symbol display area 141d. The five video reels 3a to 3e represent the five reel strips (five symbol arrays). That is to say, the five reel strips are moved or stopped in the symbol display area 141d. Each reel strip is formed of a plurality of symbols disposed in a line. The images of the symbols disposed on the reel strips can be displayed as video reels 3a to 3e in the symbol display area 141d.

In the present embodiment, three rows of a top row, a middle row, and a bottom row are defined in the symbol display area 141d as stop positions for the symbols on the video reels 3a to 3e. Accordingly, when the five video reels 3a to 3e (five reel strips) are stopped, 5 reels by 3 rows (5 columns by 3 rows) of symbols, or 15 symbols in total, appear (are stopped) in the symbol display area 141d. The five video reels 3a to 3e start spinning (being shuffled) upon start of a unit game. After a predetermined time, the five video reels 3a to 3e stop. As a result, 15 symbols appear (are stopped) in the symbol display area 141d and the symbols are rearranged. That is to say, each time a unit game is conducted, symbols are rearranged in the symbol display area 141d to show a result of the unit game.

The speeds and the directions in the shuffling of the five video reels 3a to 3e can be determined individually depending on the game mode and the unit game.

The symbol display area 141d has symmetric payline generation columns on the left end and the right end thereof. The payline generation column on the left end provided on the left as seen from the player has 100 payline generators. The payline generation column on the right end provided on the right as seen from the player has 100 payline generators.

Each payline generator on the left end is paired with one of the payline generators on the right end and a payline starting from the payline generator on the left end to the paired payline generator on the right end is predefined. One hundred paylines are defined in the present embodiment.

The number of paylines to be activated is determined based on the amount of bet. In the case of MAX BET or the maximum amount of bet, the MAX LINEs or the maximum number of paylines in the LINE configuration are activated. Each activated payline allows completion of winning patterns of each kind of symbols. The details of the winning patterns are described later.

Although the present embodiment describes a slot machine 10 that displays symbols with the video reels 3a to 3e, the slot machine 10 may display symbols by using a video reel system and a mechanical reel system together.

The lower liquid crystal display panel 141b has a game status indication area 141e under the symbol display area 141d. The game status indication area 141e indicates a variety of information on games such as a status of credits and details of bet.

### <Control Panel CP>

The slot machine 10 has a control panel CP. As shown in FIG. 4, the control panel CP includes a planar base plate CP9 and a plurality of operation buttons CP1 to CP8 provided on the base plate CP9. The operation button CP1 has a circular shape that is larger than the other buttons CP2 to CP8 so that the player can easily press it and easily distinguish it from the other buttons. The operation button CP1 is disposed on the rightmost area of the base plate CP9 and functions as a start button or spin button to start a game in response to a press operation.

The operation buttons CP2, CP3, CP4, CP5, and CP6 are disposed in a line at equal intervals on the left of the operation button CP1. These operation buttons CP2 to CP6 have square shapes. The rightmost operation button CP2 functions as a MAX BET button for a game to bet maximally, for example ten units of gaming value, in response to a press operation. The operation button CP3 functions as a 5BET button for a game to bet five units of gaming value in response to a press operation. The operation button CP4 functions as a 3BET button for a game to bet three units of gaming value in response to a press operation. The operation button CP5 functions as a 2BET button for a game to bet two units of gaming value in response to a press operation. The operation button CP6 functions as a 1BET button for a game to bet one unit of gaming value in response to a press operation.

The operation buttons CP7 and CP8 are disposed at the back and the front on the leftmost area of the base plate CP9. The operation button CP7 functions as a HELP button to indicate help information such as how to play games in the game status indication area 141e in response to a press operation. The operation button CP8 functions as a cashout button to return the credit by coins or printed information in response to a press operation.

### <Overall Configuration of Game System>

A game system 600 including the slot machine 10 having the above-described functions is described.

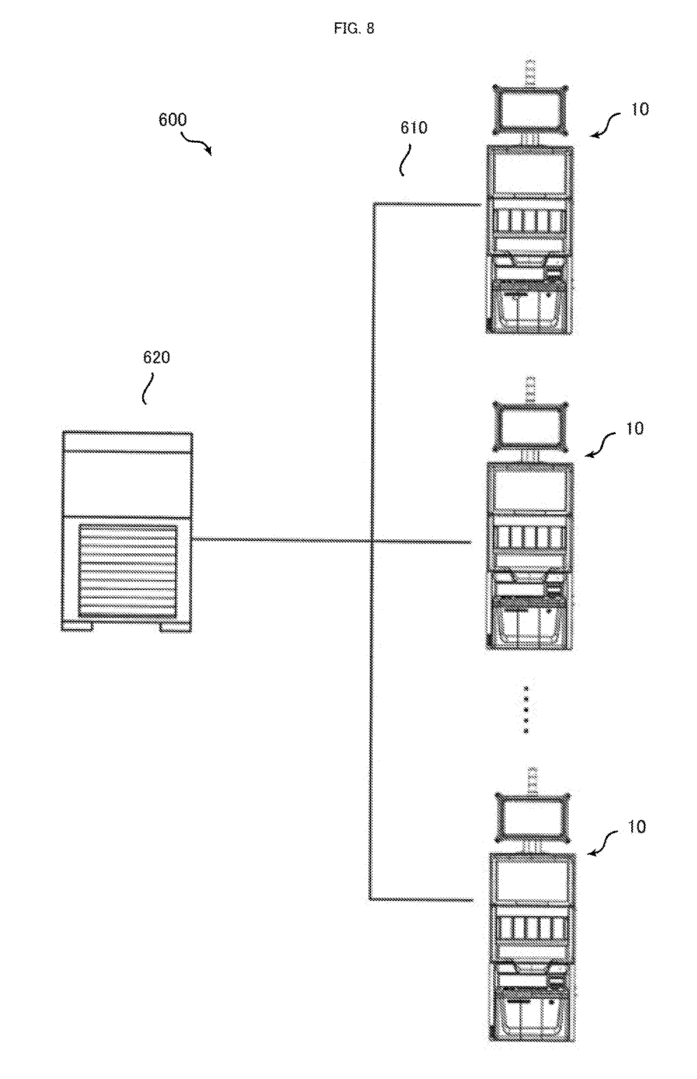

As illustrated in FIG. 8, a game system 600 includes a plurality of slot machines 10 and an external control device 620 connected with the slot machines 10 through a communication line 610.

The external control device 620 is to control the plurality of slot machines 10. In the present embodiment, the external control device 620 is a so-called hall server installed in a game hall having the plurality of slot machines 10. Each of the slot machines 10 is assigned a unique identification number; the external control device 620 identifies a slot machine 10 that sends data to the external control device 620 with the identification number. Furthermore, the external control device 620 uses the identification numbers to designate a destination in sending data to a slot machine 10.

The game system 600 may be constructed within a single game hall where various games can be conducted, such as a casino, or may be constructed among a plurality of game halls. In the case where the game system 600 is constructed in a single game hall, the game system 600 may be constructed on each floor or in each section of the game hall. The communication line 610 may be wired or wireless, and can adopt a dedicated line, an exchange line, or the like.

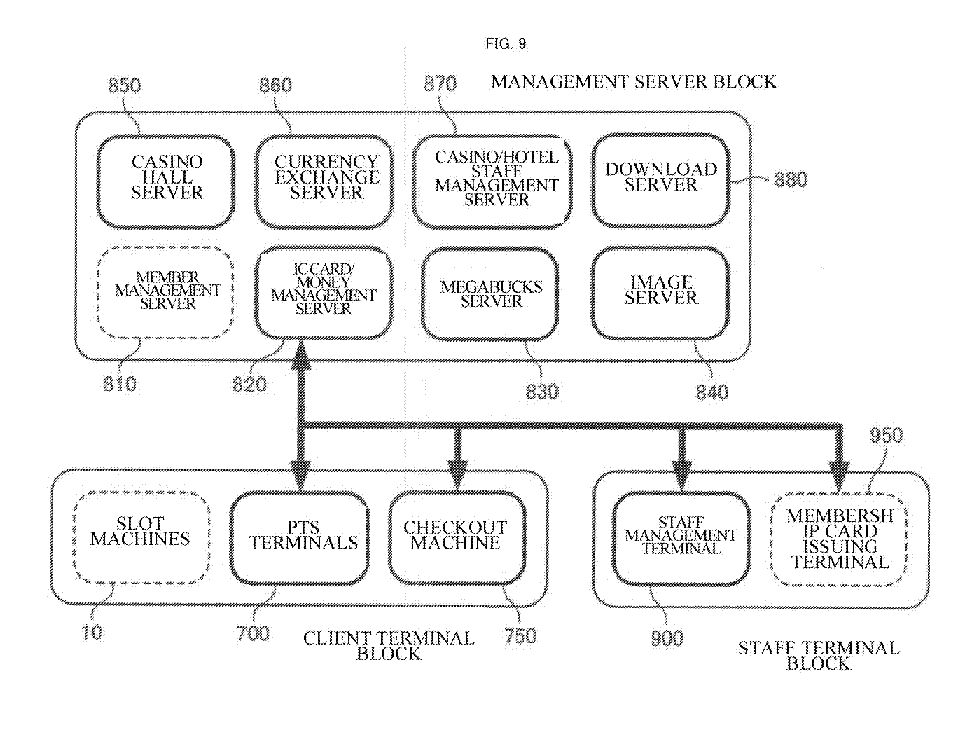

As illustrated in FIG. 9, the game system is generally grouped into the following three blocks: a management server block, a client terminal block, and a staff terminal block. The management server block includes a casino hall server 850, a currency exchange server 860, a casino/hotel staff management server 870 and a download server 880.

The casino hall server 850 is a server for managing the entire casino hall where the slot machines 10 are installed. The currency exchange server 860 is a server for generating exchange rate data based on currency exchange information. The casino/hotel staff management server 870 is a server for managing the staff working in the casino hall and/or a hotel related to the casino hall. The download server 880 is a server for downloading latest information such as information on the games and news and for notifying the players of the information through the PTS terminals 700 of the slot machines 10.

The management server block further include a member management server 810, an IC card/money management server 820, a megabucks server 830, and an image server 840.

The member management server 810 is a server for managing membership information on the players of the slot machines 10. The IC card/money management server 820 is a server for managing IC cards to be used in the slot machines 10. Specifically, the IC card/money management server 820 stores data on fractional amount of cash in association with an identification code and outputs the data on fractional amount of cash to a PTS terminal 700. The IC card/money management server 820 further generates and manages denomination rate data. The megabucks server 830 is a server for managing a megabucks, which is a kind of game that provides the total amount of bet of a plurality of slot machines 10 installed in a plurality of casino halls for an award. The image server 840 is a server for downloading latest images about the game and news and for notifying the players of the images through the PTS terminals 700 of the slot machines 10.

The client terminal block includes slot machines 10, PTS terminals 700, and a checkout machine 750. The PTS terminals 700 are attachable to the slot machines 10 and can interactively communicate with the management server 800 (see FIG. 11). The checkout machine 750 is a machine for a player to checkout by converting the money data stored in the player's IC card into cash or to store money data indicating the amount of coins or a bill in the IC card.

The staff terminal block includes a staff management terminal 900 and a membership card issuing terminal 950. The staff management terminal 900 is a terminal for the staff of the casino hall to manage the slot machines 10. Particularly in the present embodiment, the staff of the casino hall manages whether the PTS terminals 700 hold too many IC cards or are in short of IC cards. The membership card issuing terminal 950 is a terminal to be used to issue a membership card for a game player in the casino hall.

### <PTS Terminal 700>

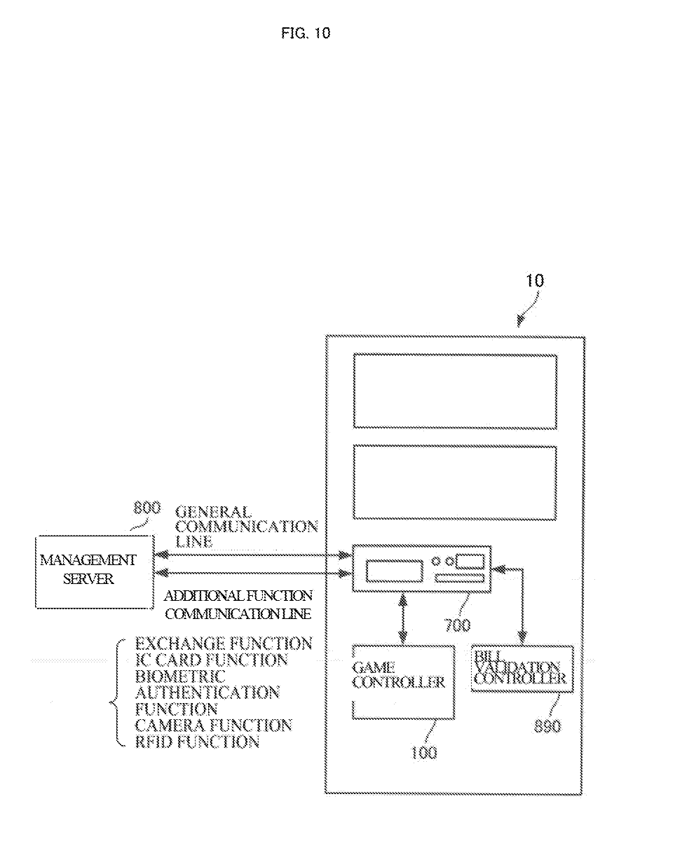

The PTS terminals 700 are included in a PTS system as illustrated in FIG. 10. A PTS terminal 700 attached to a slot machine 10 is connected with the game controller 100 and the bill validation controller 890 of the slot machine 10 to be able to communicate with each other.

The PTS terminal 700 coordinates game effects of sound and images and updates credit data through communications with the game controller 100. The PTS terminal 700 sends credit data required for checkout through communications with the bill validation controller 890.

The PTS terminal 700 is also connected with the management server 800 to be able to communicate with each other. The PTS terminal 700 communicates with the management server 800 using two communication lines: a general communication line and an additional function communication line.

The PTS terminal 700 uses the general communication line to communicate data such as money data, identification code data, and player's membership information. The PTS terminal 700 uses the additional function communication line for communications related to newly added functions. The PTS terminal 700 in the present embodiment uses the additional function communication line for communications related to the exchange function, the IC card function, the biometric authentication function, the camera function, and the RFID (radio frequency identification) function, which is a function for identifying objects using radio wave.

### <Electrical Configuration of Slot Machine 10>

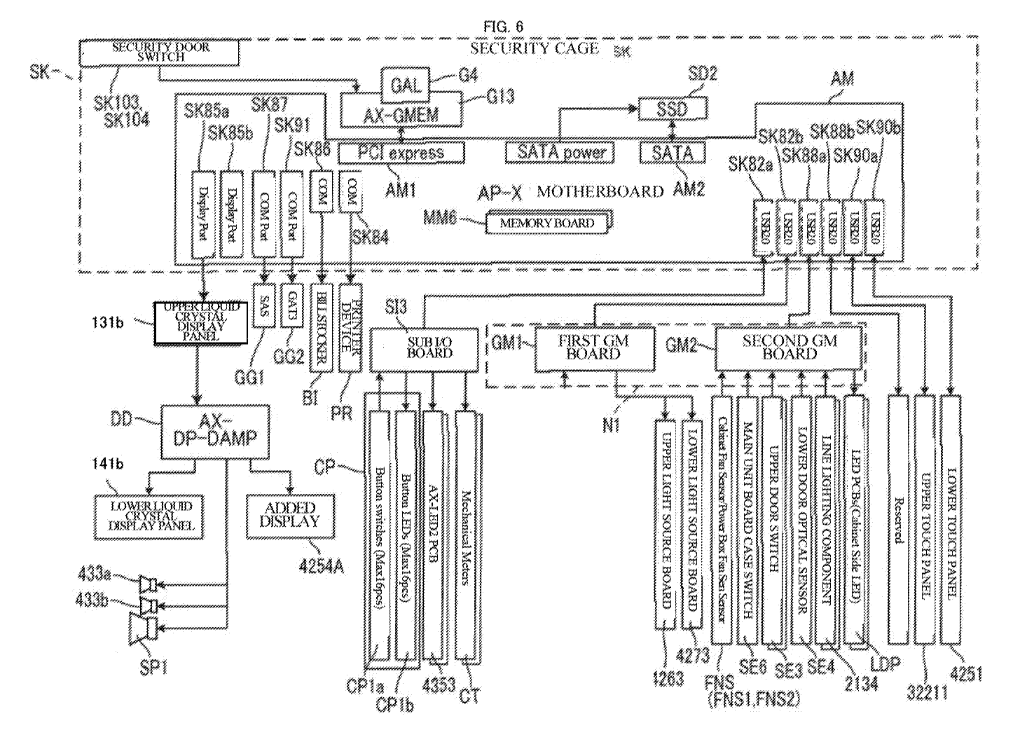

Next, the electrical configuration of the slot machine 10 is described. As illustrated in FIG. 5, the slot machine 10 employs a CPU having GPU (Graphics Processing Unit) functionality to eliminate a graphic board, which prevents unauthorized tampering through PCI Express and achieves lower power consumption and lower heating. In other words, the slot machine 10 is a gaming machine employing a CPU with integrated GPU and is configured with a motherboard including the CPU with an integrated GPU (on a single die), a PCI Express expansion slot AM1 connected with a GAL board G4 holding an authentication program, and DisplayPort connectors SK85a and SK85b connected with the GPU.

This configuration eliminates a graphic board from being connected with the PCI Express expansion slot AM1; the slot machine 10 can use the expansion slot AM1 as a dedicated terminal for authentication. The distinct looks of the dedicated connection enables the security monitoring to be easier. Furthermore, the slot machine 10 can eliminate the possible problems caused by connecting a graphic board to the PCI Express expansion slot AM1, such as unsmoothness in outputting video signals or audio signals because of an interruption to or from another board and a collision of interruptions because of the relation with another board. In addition, the slot machine 10 can use the DisplayPort connectors SK85 as dedicated terminals for video (audio) to prevent interferences with other boards. As a result, video (audio) signals can be output smoothly to be synchronized accurately with the game process.

The slot machine 10 is equipped with a motherboard having a CPU with a built-in graphics engine for implementing the GPU functionality, which lowers the possibility that a video is suspended during a game. Using the motherboard having a CPU with a built-in graphics engine, the slot machine 10 outputs video data for video effects from the graphics engine controlled by the CPU to a sub board and outputs audio signal to a sub board from the CPU. In this configuration, video data and audio data is output from the motherboard in accordance with the control of a single CPU with a built-in graphics engine; accordingly, unless the CPU malfunctions, the slot machine 10 can prevent an accident of outputting only one of the video and audio to a sub board and making the effects unclear.

The slot machine 10 may be configured to perform the followings: connecting a security board (GAL board G4) having a flash RAM holding different sizes of startup-related data such as a boot BIOS and a public key to be used to start up the slot machine 10 to the motherboard via PCI Express, detecting the size of startup-related data, transferring the startup-related data to the DRAM on the motherboard at a transfer rate suitable for the data size, and executing startup processing based on the startup-related data with the DRAM. PCI Express allows software to dynamically change transfer rate; accordingly, this configuration enables power saving when the highest speed is not necessary. Even if update of the data of the boot BIOS significantly changes the data size on the security board, the slot machine 10 can automatically set an optimum time to start up and an optimum power to be consumed.

The slot machine 10 may further be configured to detect a rise in temperature of the security board caused by transferring data and to control the transfer rate of the startup-related data based on the rise in temperature in connecting the security board having a flash RAM holding different sizes of startup-related data such as a boot BIOS and a public key to be used to start up the slot machine 10 to the motherboard via PCI Express, transferring the startup-related data to the DRAM on the motherboard, and performing startup processing based on the startup-related data with the DRAM. The rise in temperature of the security board is supposed to be proportional to the power consumption; accordingly, controlling the transfer rate so as to keep the temperature constant enables startup processing to be performed at a transfer rate with stable power consumption.

The slot machine 10 is a gaming machine that uses an SSD (SSD board SD2) holding an OS (Operating System); the slot machine 10 is equipped with an AP-X motherboard AM including a CPU and a SATA terminal (SATA board-to-board connector AM2) and an SSD connected with the SATA terminal. By connecting to the SSD via the SATA terminal and booting the OS from the SSD, the slot machine 10 eliminates the problems caused by booting the OS from a flash memory like an SD card, including a problem that a conversion adapter is required, a problem that the operation frequently becomes unstable, and a problem that the SD card is expensive. When booting the OS from a flash memory like an SD card, the flash memory needs to be recognized at the BIOS level, which does not allow some motherboards to boot the OS. However, when an SSD is used to boot the OS, the OS can be booted properly and speedily; the versatility is enhanced and programs for the gaming machine can be start up instantly.

The slot machine 10 is capable of triple display output with the motherboard having two DisplayPort terminals and a DVI output. This configuration enables high speed and large screen display and eliminates the license cost, compared to using HDMI™. The slot machine 10 further includes a DP D-AMP board DD (DisplayPort audio amplifier board) for retrieving an audio signal from DisplayPort, and amplifying and outputting the audio signal.

The slot machine 10 outputs video data and audio data during games by packets through DisplayPort to produce video and audio effects with the devices for implementing the effects. Since the video data and the audio data are output to a DisplayPort signal line, the slot machine 10 can eliminate losing one of the video data and the audio data. As a result, the slot machine 10 does not fail in sufficiently informing the player of a lottery result because of outputting only one of the video and the audio indicating a lottery result. Furthermore, this configuration allows a plurality of displays to be connected in series; accordingly, adding a display can be made easily, which facilitates design change based on the existing slot machine 10. For example, in adding a display device to the top unit 12 in addition to the upper liquid crystal display panel 131b and the lower liquid crystal display panel 141b, only connecting a signal line from the upper liquid crystal display panel 131b to the display device of the top unit 12 completes the mechanical signal line connection; in addition, easy maintenance of the display device can be attained. In the meanwhile, data transmission by packets does not require data transmission to the plurality of display devices one by one; programs can be modified easily.

The specific electrical configuration of the slot machine 10 is described. The slot machine 10 has an AP-X motherboard AM enclosed in a security cage SK. The AP-X motherboard AM includes a not-shown 4th Generation Intel® Core™ processor, so that the power management function (C state) in idling is improved. Further, a VR (voltage regulator) is integrated within the package/die of the processor to simplify the power design in the entire platform, so that low power consumption is achieved, inclusive of the motherboard. The 4th Generation Intel® Core™ processor has 20 EUs (Execution Units) as graphics execution units in a GPU core. Accordingly, compared to the 3rd Generation Intel® Core™ processor, significant performance improvement has been achieved. The 4th Generation core i-series chipset has multiple ports for SATA 6 Gb/s (SATA 3.0) of a high-speed interface and supports PCI Express 3.0 for smooth data transfer to a high-performance video card and DDR3-1600 of a high-speed memory specification.

The AP-X motherboard AM has a PCI Express expansion slot AM1, a SATA board-to-board connector AM2, a first and a second DisplayPort connectors SK85a and SK85b, a first and a second LAN jacks SK87 and SK91, a first and a second D-sub connectors SK86 and SK84, a first to a sixth USB connectors SK82a, SK82b, SK88a, SK88b, SK90a, and SK90b.

PCI (Peripheral Component Interconnect) Express is a serial transfer interface for computers that supersedes PCI. PCI Express is not physically compatible with PCI employing parallel transfer; however, PCI Express uses the same communication protocol as PCI. The smallest unit of transmission channel (called lane) used in PCI Express is capable of full duplex communications at 2.5 Gbps in simplex and at 5.0 Gbps in duplex. The effective data transfer rate is 2.0 Gbps (250 MB/s) in simplex and 4.0 Gbps (500 MB/s) in duplex because transmitting 8-bit data requires 10 bits in which 2 bits of a clock signal and other data are added. The expansion slot AM1 of the AP-X motherboard AM is a PCI Express port containing multiple lanes.

SATA (Serial AT Attachment) is an expansion of IDE (ATA) standard for connecting a computer with a storage device such as a hard disk drive or an optical drive. SATA has been developed by changing the parallel transfer employed in the ATA specifications into serial transfer, achieving high transfer rate with a simple cable.

DisplayPort is a full digital video interface and employs micro packet system utilizing embedded clocks. The micro packet system can transfer secondary digital audio data in addition to the primary video data; the system encapsulates pixel data and audio signal in a packet called micro packet. That is to say, the micro packet system divides all the video and audio into micro packets called Transfer Units and serially transfers the Transfer Units to the destination devices.

DisplayPort generates a clock from data without using an external clock signal; accordingly, speedy data transfer and feature expansion is easily available. Furthermore, since DisplayPort is a video output interface designed for digital display devices, using a liquid crystal display as a display device reduces the number of components and attains a transmission distance of approximately 15 meters.

DisplayPort defines the output side as source device and the input side as sink device. The source device and the sink device communicate with each other to automatically optimize the resolution, color depth, refresh rate, and the like. Transmission rate of video and audio data can be changed using the combinations of one, two, and four channels called lanes and two data rates of 1.62 Gbps and 2.7 Gbps. For example, the lowest rate is obtained in the configuration of one lane at 1.62 Gbps and the highest rate is 10.8 Gbps obtained in the configuration of four lanes at 2.7 Gbps. The main data channel in DisplayPort can be configured with one, two, or four high-speed SerDes lanes and the bandwidth of 2.7 Gbps or 1.62 Gbps for each lane.

DisplayPort includes an HPD (Hot Plug Detect) signal. Hot Plug Detect is used not only to check whether a display device is connected but also to establish a link. Hot Plug Detect includes a process to inform the sender of establishing a link through a process called link training; during this process, both of the sender and the receiver check whether all the four lanes are necessary. DisplayPort further has an AUX (auxiliary) channel. The AUX channel is a low-speed “side channel” and is a communication channel for managing the link in accordance with the sender's information and controlling the status and configuration. The AUX channel enables bidirectional video and audio communications.

DisplayPort does not have limitation in using multiple screens or display devices from a single digital output port or in display application and brings out the full performance of the displays with zero latency. DisplayPort is featured by Plug and Play; the user does not need to reconfigure the system manually. For example, to add a display device without using DisplayPort, a graphics card or a multi-head graphics card having a plurality of output ports needs to be added. These cards increase the power consumption and the adding the card requires complex work. Using DisplayPort eliminates these problems. As a result, DisplayPort enables addition of a display device without opening the highly confidential security cage SK of the slot machine 10.

DisplayPort can simultaneously transmit a plurality of types of data such as audio, video stream, and the like by employing the micro packet system; accordingly, a plurality of video and audio packets can be transmitted on the same cable. As a result, DisplayPort achieves utilization of picture-in-picture or a plurality of daisy-chained display devices at a link speed as fast as the hub connection with a single connection.

The daisy chain connection is a connection topology in which, among display devices having an input port and an output port of DisplayPort, the output port of the source is connected to the input port of the next display device (sink) on a single link and the output port of this sink display device, which is, in turn, regarded as a next source, is connected to the input port of the next display device (sink). In contrast, the hub connection is a connection topology in which one input port is provided with a plurality of output ports and these output ports are connected to the input ports of a plurality of display devices.

The expansion slot AM1 is connected with the AX-GMEM board G13 to be able to transmit data unidirectionally. The AX-GMEM board G13 is connected with a GAL board G4 to be able to transmit data bidirectionally to perform self-authentication of the boot BIOS with the GAL board G4. The details of the boot BIOS self-authentication are described later. The AX-GMEM board G13 is also connected with a first detection sensor SK103 and a second detection sensor SK104 for functioning as security door switches; the open/closure of the security cage door SK3 (not shown) is monitored based on the detection signals from these detection sensors SK103 and SK104.

The SATA board-to-board connector AM2 is connected with an SSD board SD2 to be able to transmit data bidirectionally. The first DisplayPort connector SK85a is connected with the upper liquid crystal display panel 131b to be able to transmit data unidirectionally. The second DisplayPort connector SK85b is connected with the DP D-AMP board DD to be able to transmit data unidirectionally. The DP D-AMP board DD is an audio amplifier board for DisplayPort and is connected with the lower liquid crystal display panel 141b and a speaker (not shown) to be able to transmit data unidirectionally.

The first LAN jack SK87 is a SAS (Serial Attached SCSI) interface and is provided for data communication with a PTS device GG1 having a SAS interface. SAS is an interface standard that has attained serial transmission in the SCSI standard. The second LAN jack SK91 is provided for data communication with a checking information processing device GG2 called GAT3. The first D-sub connector SK86 is connected with a bill stocker BI to be able to transmit data unidirectionally. The second D-sub connector SK84 is connected with a printer device PR to be able to transmit data unidirectionally.

The first USB connector SK82a is connected with a sub I/O board SI3 to be able to receive data unidirectionally. The sub I/O board SI3 is connected with up to 16 button switches CP la on the control panel CP and button LEDs CP1b. The sub I/O board SI3 is also connected with light emission boards (not shown) and counter devices CT.

The second USB connector SK82b is connected with a first GM board GM1 to be able to receive data unidirectionally. The first GM board GM1 is connected with an upper light source board 4263 and a lower light source board 4273.

The third USB connector SK88a is connected with a second GM board GM2 to be able to receive data unidirectionally. The second GM board GM2 is connected with a cabinet fan sensor FNS2 and a power box fan sensor FNS1. The fan sensors FNS output fan temperature signals indicating the temperatures of these fans. The second GM board GM2 is also connected with a main unit board case switch SE6, upper door switches SE3, a lower door optical sensor SE4, and line lighting components (2134), as well as LED boards LDP for driving the line lighting components (not shown) and illumination devices (not shown).

The fourth USB connector SK88b is used as a spare. The fifth USB connector SK90a is connected with the upper touch panel 32211 (131a) to be able to transmit data bidirectionally. The sixth USB connector SK90b is connected with the lower touch panel 4251 (141a) to be able to transmit data bidirectionally.

The AP-X motherboard AM has memory boards MM6 including DDR3 memories. The memory boards MM6 is used for OS authentication with the SSD board SD2 and other processing. The details of the OS authentication are described later.

The SSD enables the slot machine 10 to have a long life. The SSD includes a flash memory holding programs for activating and operating the slot machine 10. The slot machine 10 transfers the programs retrieved from the SSD to the DRAM on the motherboard and executes the programs on the DRAM to activate and operate the gaming machine.

Unlike an HDD, an SSD does not have a driving mechanism to spin a disk such as a bearing and a motor. For this reason, the above-described configuration considerably eliminates mechanical failures such as wear in the driving mechanism. Usually, when an SSD repeats rewrite and erasure, an oxide film acting as an insulator of the memory element of the flash memory is deteriorated by electrons. In the above-described configuration, however, most of the accesses to the SSD are to read a program. Accordingly, the deterioration of the memory element can be kept smaller than in the case of accesses including rewrite or erasure to the flash memory. For this reason, the slot machine 10 can use the SSD for a long time without wear of the memory element like in the case of accessing an HDD. As a result, the probability of occurrence of troubles, such as interruption of video or audio effects during a game, can be lowered compared with the configuration including an HDD. The SSD provides a longer life to the gaming machine.

Furthermore, the SSD enables the slot machine 10 to prevent a failure in the middle of a game. The slot machine 10 is equipped with an SSD including a flash memory holding programs for activating and operating the slot machine 10, grasps the count of write to and erasure from the SSD at predetermined intervals, such as a time of startup, and issues a request for replacement of the SSD when the count of write and erasure reaches a threshold for a failure of the memory element.

In the above-described configuration, the SSD is frequently written with some data such as startup information and data read records even if the data saving is not intentional. Accordingly, even if the SSD is used only for read accesses, the memory element is deteriorated by the use. When the gaming machine is used for a long time, the deterioration of the memory element reaches the level to be failed easily. For this reason, the slot machine 10 configured as described above issues a request for replacement of the SSD when the count of write and erasure reaches a threshold for a failure of the memory element, so that a failure in the middle of a game can be prevented.

In the present embodiment, one DisplayPort connector SK85a is connected with the upper liquid crystal display panel 131b and the other DisplayPort connector SK85b is connected with the lower liquid crystal display panel 141b via the DP D-AMP board DD to individually control the plurality of displays with the plurality of DisplayPort terminals. However, the configuration is not limited to this; a plurality of displays may be controlled with a single DisplayPort terminal.

For example, as illustrated in FIG. 6, the upper liquid crystal display panel 131b having input and output ports of DisplayPort may be daisy chained with the lower liquid crystal display panel 141b by connecting the output port of DisplayPort of the upper liquid crystal display panel 131b to the DP D-AMP board DD. Alternatively, the lower liquid crystal display panel 141b having an output port of DisplayPort may be connected with the upper liquid crystal display panel 131b. Furthermore, in adding a display, the display to be added may be connected to the output port of the upper liquid crystal display panel 131b or the lower liquid crystal display panel 141b.

### <AP-X Motherboard AM>

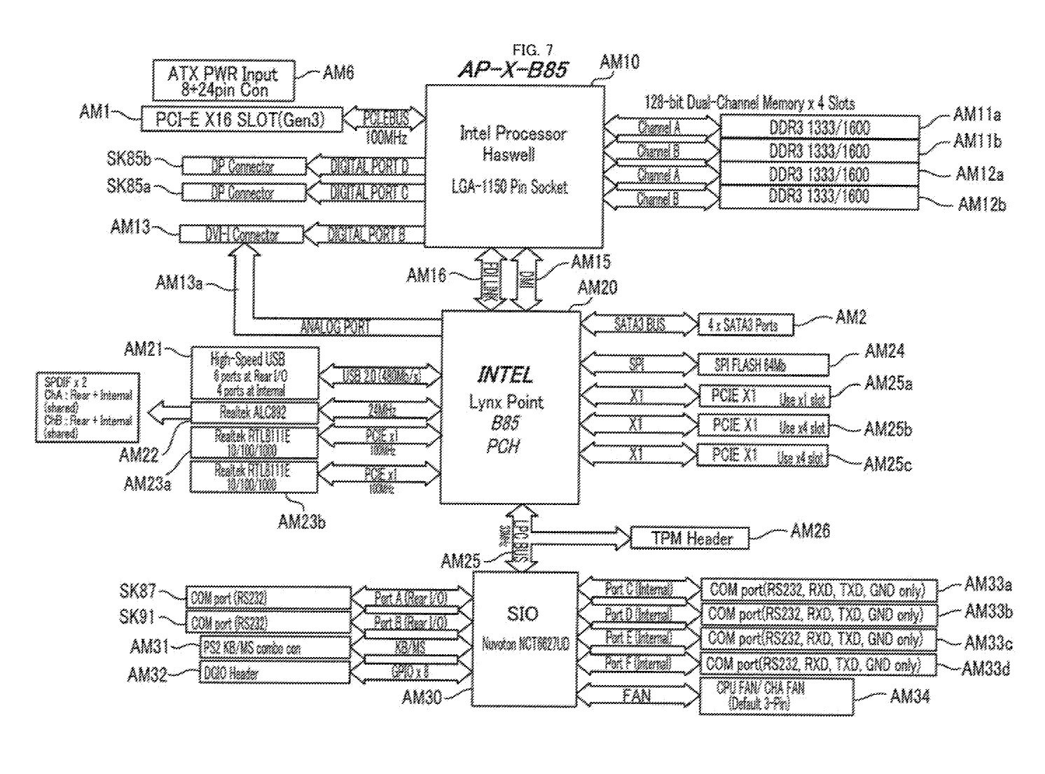

Next, the electrical configuration of the AP-X motherboard AM is described. As illustrated in FIG. 7, the AP-X motherboard AM includes a 4th Generation Intel® Core™ processor (Haswell) AM10, which has 20 EUs as graphics execution units in a GPU core. The processor AM10 is mounted on an Intel LGA 1150 CPU socket and connected with an expansion slot AM1 supporting PCIe (Gen3) x16 specifications (see FIG. 5) to be able to bidirectionally transmit data via a PCIe bus (100 MHz). The AP-X motherboard AM is supplied with power through an 8-pin and 24-pin connector AM6.

The processor AM10 is also connected with four memory slots of slots AM11a and AM12a for Channel A and slots AM11b and AM12b for Channel B to operate in 128-bit dual-channel mode to be able to transmit data bidirectionally. Each memory slot is occupied by a DDR3 SRAM of a DDR3-1333 or a DDR3-1600. The processor AM10 is further connected with DP (DisplayPort) connectors SK85a and SK85b to be able to unidirectionally transmit data via digital ports C and D. The processor AM10 is still further connected with a DVI-I connector AM13 capable of transmitting both analog and digital video signals to be able to unidirectionally transmit data via a digital port B.

The AP-X motherboard AM also includes a PCH (Lynx Point B85) AM20 of an Intel chipset. The PCH chipset AM20 is a platform controller hub in which the functions of a north bridge (MCH) to connect to the memories and graphics chips and the functions of a south bridge (ICH) to provide interfaces such as PCIe and SATA slots are integrated. The PCH chipset AM20 and the processor AM10 are connected by both of a DMI (Direct Media Interface) bus AM15 and an FDI (Flexible Display Interface) bus AM16 to be able to transmit data bidirectionally.

The PCH chipset AM20 is connected with a plurality of high-speed USB ports AM21 by USB 2.0 with a transfer rate of 480 Mb/s to be able to transmit data bidirectionally. Six of the high-speed USB ports are shown in FIG. 5 as the USB connectors SK82a, SK82b, SK88a, SK88b, SK90a, and SK90b.

The PCH chipset AM20 is also connected with an audio codec chip (Realtek ALC892) AM22 to be able to bidirectionally transmit data at 24 MHz. The audio codec chip AM 22 is connected with two SPDIF channels ChA and ChB. SPDIF is a standard for transferring digital audio signals in video or audio equipment. The PCH chipset AM20 is further connected with two network controller chips (Realtek RTL8111E 10/100/1000) AM23a and AM23b to be able to bidirectionally transmit data at 100 MHz. Furthermore, the PCH chipset AM20 is connected with the DVI-I connector AM13 to be able to unidirectionally transmit data via an analog port AM13a.

The PCH chipset AM20 is connected with four SATA 3 ports AM2 (not shown) to be able to bidirectionally transmit data via a SATA 3 bus. The PCH chipset AM20 is also connected with an SPI flash port AM24 to be able to bidirectionally transmit data at 64 Mb via an SPI (Serial Peripheral Interface) bus. The PCH chipset AM20 is further connected with a plurality of PCIe x1 slots AM25a to 25c to be able to bidirectionally transmit data via a plurality of PCIe xl buses.

The AP-X motherboard AM includes an SIO (super I/O) chip (Nuvoton NCT6627UD) AM 30. The SIO chip AM30 is an input/output controller integrated circuit for a motherboard and combines interfaces for various low-bandwidth devices. The PCH chipset AM20 and the SIO chip AM30 are connected by an LPC (Low Pin Count) bus AM25, which is a bus for connecting low-bandwidth devices (legacy devices connected by the SIO chip) to a processor, to be able to bidirectionally transmit data at 33 MHz. The LPC bus AM25 is connected with a TPM (Trusted Platform Module) header AM26 to be able to transmit data unidirectionally. The TPM is a hardware tamper-resistant security chip to ensure security.

The SIO chip AM30 is connected with RS232C COM ports SK87 and SK91 (see FIG. 5) to be able to bidirectionally transmit data via ports A and B. The SIO chip AM30 is also connected with a PS2 KB/MS combo connector AM31 to be able to bidirectionally transmit data via a KB/MS bus. The SIO chip AM30 is further connected with a DGIO header AM 32 to be able to bidirectionally transmit data via a GPIO x8 bus. The SIO chip AM30 is still further connected with RS232C, RXD, TXD, or GND COM ports AM 33a to 33d to be able to bidirectionally transmit data via internally provided ports C, D, E, and F. The SIO chip AM30 is still further connected with a fan AM34 provided for the CPU or the chassis to be able to bidirectionally transmit data via a fan bus. The fan AM34 is usually connected to a 3-pin connector.

In the present embodiment, the AP-X motherboard AM is referred to as controller 100 or game controller 100. The processor AM10 is referred to as main CPU 200. The DDR3 SRAM attached to a memory slot is referred to as main RAM 210. Furthermore, an SSD device SD1 is referred to as auxiliary storage device 220.

### <<State Transitions of Games>>

FIG. 11 is a diagram for illustrating state transitions in the slot machine 10. Specifically, FIG. 11 is a diagram for illustrating transitions among base game mode, free game mode, and re-spin feature game mode.

The slot machine 10 offers unit games basically in base game mode. When a trigger (event) for free game mode occurs in base game mode, the game mode changes to free game mode. When a trigger (event) for re-spin feature game mode occurs in base game mode or free game mode, the game mode changes to re-spin feature game mode.

As illustrated in FIG. 11, the base game mode repeats a unit game until a free game trigger or a re-spin feature game trigger is completed. The base game mode is a game mode to provide unit games under the condition where gaming media such as medals are spent (bet). In the base game mode, an award in the amount in accordance with the prize for the winning pattern is paid out when one of the winning patterns illustrated in FIG. 13 is completed.

### <Free Game Mode>

Three kinds of free game modes are provided; the slot machine 10 is configured to perform one of the three kinds. The three kinds of free game modes are different from each other in the reel strips to be used and the number of unit games to be provided.

Completion of a winning pattern of FEATURE in base game mode triggers free game mode. Specifically, determination to display a mighty symbol of FEATURE on the top row, the middle row, and the bottom row of the video reels 3b to 3d to show the entirety of the mighty symbol of FEATURE in the symbol display area 141d completes the winning pattern of FEATURE.

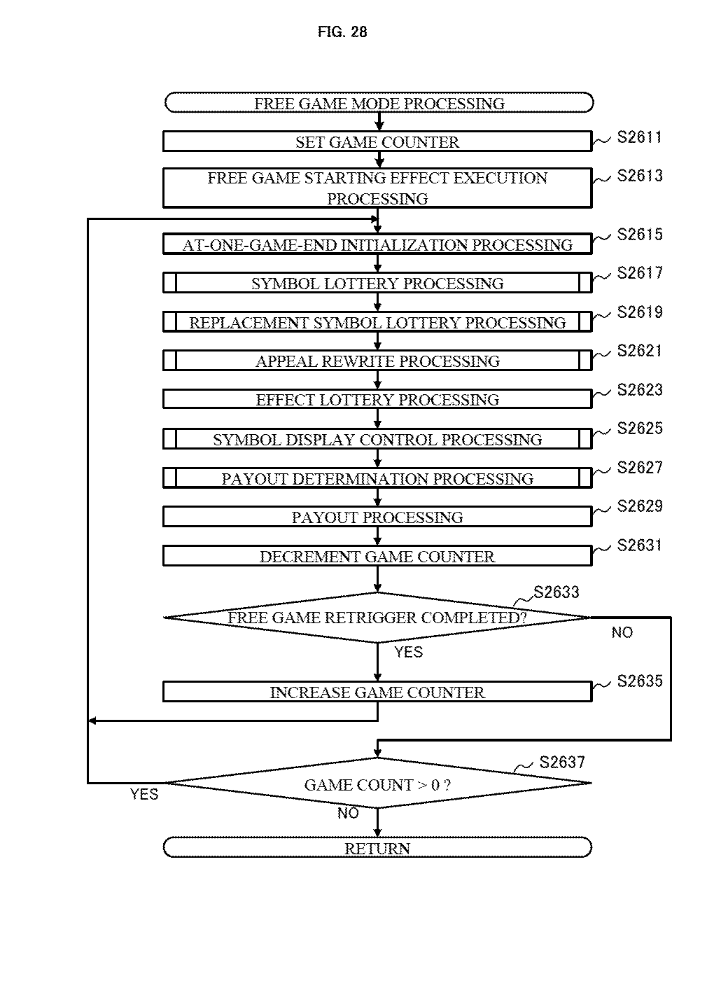

In response to the free game trigger, the game mode changes to free game mode. Free games are conducted through the processing in FIG. 28 to be described later and an award is paid out depending on the prize.

In free game mode, each unit game can be started without spending gaming media. The player can play a predetermined number of unit games in free game mode.

In response to a free game retrigger in free game mode, the game mode is maintained in the free game mode. Completion of a winning pattern of FEATURE in free game mode retriggers the free game mode. The requirements to complete a retrigger is the same as the requirements to complete a trigger; determination to show a mighty symbol of FEATURE on the top row, the middle row, and the bottom row of the video reels 3b to 3d, which means to show the entirety of the mighty symbol of FEATURE in the symbol display area 141d, completes the winning pattern of FEATURE. The retriggering the free game mode results in adding another predetermined number of unit games.

When all the unit games are finished, the game mode returns from free game mode to base game mode.

### <Re-Spin Feature Game Mode>

Completion of a winning pattern of PICT_A in base game mode triggers re-spin feature game mode. Specifically, determination to show a mighty symbol of PICT_A on the top row, the middle row, and the bottom row of the video reels 3b to 3d, which means to show the entirety of the mighty symbol of PICT_A in the symbol display area 141d, completes the winning pattern of PICT_A.

Completion of a winning pattern of any symbol other than FEATURE in free game mode triggers re-spin feature game mode. Specifically, determination to show a mighty symbol of any symbol other than FEATURE on the top row, the middle row, and the bottom row of the video reels 3b to 3d, which means to show the entirety of the mighty symbol of the symbol other than FEATURE in the symbol display area 141d, completes the winning pattern of the symbol other than FEATURE.

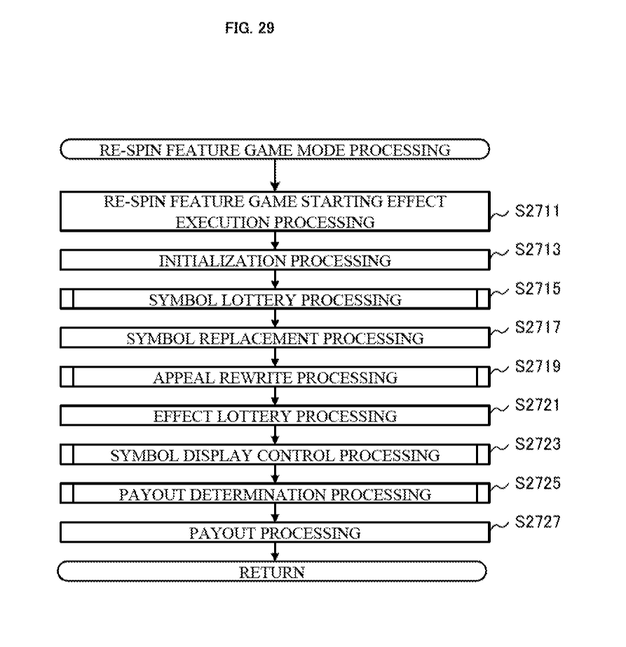

In response to the re-spin feature game trigger, the game mode changes to re-spin feature game mode. A re-spin feature game is conducted through the processing in FIG. 29 to be described later.

Re-spin feature game mode provides a free game to be conducted while maintaining (holding) the state showing the mighty symbol when the re-spin feature game mode is triggered. In the case of entering from base game mode, one unit game is conducted while maintaining the state showing the mighty symbol of PICT_A. In the case of entering from free game mode, one unit game is conducted while maintaining the state showing the mighty symbol of the symbol other than FEATURE.

In a re-spin feature game, the mighty symbol is maintained. That is to say, in order to hold the mighty symbol shown over the video reels 3b to 3d, the three video reels 3b to 3d are maintained in the stopped state without being spun and only the two video reels 3a and 3e are spun. Eventually, completion of a winning pattern is determined with the symbols shown at the stop of the two video reels 3a and 3e and the maintained mighty symbol. Accordingly, in the re-spin feature game, the symbols shown at the stop of the two video reels 3a and 3e and the maintained mighty symbol are rearranged in the symbol display area 141d.

In a re-spin feature game, the mighty symbol shown over the video reels 3b to 3d is maintained and the CHANGE symbols on the two video reels 3a and 3e are replaced by the same kind of symbols as the symbol held on the video reels 3b to 3d. Then, symbols of the same kind as the symbol held on the video reels 3b to 3d will appear with high probability when the two video reels 3a and 3e are spun and stopped.

Although the symbols to be actually shown on the video reels 3a and 3e are determined by symbol lottery processing (step S2715 in FIG. 29), the video reels 3a and 3e includes CHANGE symbols consecutively as illustrated in FIGS. 17A to 17C, FIGS. 18A to 18C, and FIGS. 19A to 19C. Accordingly, the consecutive CHANGE symbols are replaced by the same kind of symbols as the symbol held on the video reels 3b to 3d and the symbols that have replaced will appear with high probability when scrolling of the video reels 3a to 3e are stopped.

Specifically, in the case of entering from base game mode, the mighty symbol of PICT_A is held on the video reels 3b to 3d. While the mighty symbol of PICT_A is held on the video reels 3b to 3d, the remaining two video reels 3a and 3e are spun with PICT_A symbols that have replaced all the CHANGE symbols on the video reels 3a and 3e. Then, PICT_A symbols will appear at any of the stop positions on the two video reels 3a and 3e with high probability when the two video reels 3a and 3e are stopped.

As described above, although the symbols actually shown on the video reels 3a and 3e are determined by symbol lottery processing (step S2715 in FIG. 29), the video reels 3a and 3e includes CHANGE symbols consecutively as illustrated in FIGS. 17A to 17C, FIGS. 18A to 18C, and FIGS. 19A to 19C. Accordingly, the consecutive CHANGE symbols are replaced by PICT_A symbols; then, PICT_A symbols will appear with high probability when spinning of the video reels 3a and 3e is stopped.

In the case of entering from free game mode, the mighty symbol of a kind other than FEATURE is maintained. While the mighty symbol of the kind other than FEATURE is held on the video reels 3b to 3d, the two video reels 3a and 3e are scrolled with the symbols of the kind other than FEATURE that have replaced all the CHANGE symbols on the video reels 3a and 3e. Then, the same kind of symbols as the maintained symbol will appear at any of the stop positions on the two video reels 3a and 3e with high probability when the two video reels 3a and 3e are stopped.

As described above, although the symbols actually shown on the video reels 3a and 3e are determined by symbol lottery processing (step S2715 in FIG. 29), the video reels 3a and 3e includes CHANGE symbols consecutively as illustrated in FIGS. 17A to 17C, FIGS. 18A to 18C, and FIGS. 19A to 19C. Accordingly, the consecutive CHANGE symbols are replaced by the same kind of symbols as the maintained symbol; then, replaced symbols will appear with high probability when spinning of the video reels 3a and 3e is stopped.

As noted from the above, a re-spin feature game is performed by spinning and stopping the two video reels 3a and 3e after replacing all the CHANGE symbols on the two video reels 3a and 3e with the same kind of symbols as the mighty symbol held on the video reels 3b to 3d. Accordingly, symbols of the same kind as the mighty symbol held on the video reels 3b to 3d will appear with high probability on the two video reels 3a and 3e, which increases the probability to complete winning patterns on multiple paylines.

There is no retrigger in the re-spin feature game mode; the game mode returns to the previous game mode when the one unit game is finished.

### <<<Paylines>>>

FIG. 12 is an example of a payline definition table for defining the paylines employed in the slot machine 10. The slot machine 10 has 100 paylines. The 100 paylines are defined with the fifteen stop positions in the symbol display area 141d. Whether a winning pattern is completed is determined depending on the number and the kind of symbols arranged along a payline.

The payline definition table in FIG. 12 defines paylines formed by connecting the top row, the middle row, and the bottom row of the five video reels 3a to 3e in the lower display unit 141. In FIG. 12, “0” represents the symbol stop position at the top row (the first row); “1” represents the symbol stop position at the middle row (the second row); and “2” represents the symbol stop position at the bottom row (the third row).

For example, the payline No. 1 in FIG. 12 is 1-1-1-1-1, which represents a payline connecting the middle row-the middle row-the middle row-the middle row-the middle row of the video reels 3a, 3b, 3c, 3d, and 3e, respectively. The payline No. 5 in FIG. 12 is 2-1-0-1-2, which represents a payline connecting the bottom row-the middle row-the top row-the middle row-the bottom row of the video reels 3a, 3b, 3c, 3d, and 3e, respectively.

As illustrated in FIG. 31, the number of paylines to be activated out of the 100 paylines is determined in accordance with the operation button (one of CP6 to CP2) operated by the player. Each of the five LINE configurations of LINE configuration 10, LINE configuration 30, LINE configuration 40, LINE configuration 50, and LINE configuration 100 in FIG. 31 indicates the number of paylines associated with each of the operation buttons CP6 to CP2. The LINE configuration can be set by the game hall staff.

<In the Case where LINE Configuration 10 is Set>

Operating the operation button CP6 activates one payline. Operating the operation button CP5 activates three paylines. Operating the operation button CP4 activates five paylines. Operating the operation button CP3 activates seven paylines. Operating the operation button CP2 activates ten paylines.

<In the Case where LINE Configuration 30 is Set>

Operating the operation button CP6 activates one payline. Operating the operation button CP5 activates five paylines. Operating the operation button CP4 activates ten paylines. Operating the operation button CP3 activates 20 paylines. Operating the operation button CP2 activates 30 paylines.

<In the Case where LINE Configuration 40 is Set>

Operating the operation button CP6 activates one payline. Operating the operation button CP5 activates ten paylines. Operating the operation button CP4 activates 20 paylines. Operating the operation button CP3 activates 30 paylines. Operating the operation button CP2 activates 40 paylines.

<In the Case where LINE Configuration 50 is Set>

Operating the operation button CP6 activates one payline. Operating the operation button CP5 activates ten paylines. Operating the operation button CP4 activates 20 paylines. Operating the operation button CP3 activates 30 paylines. Operating the operation button CP2 activates 50 paylines.

<In the Case where LINE Configuration 100 is Set>

Operating the operation button CP6 activates one payline. Operating the operation button CP5 activates 20 paylines. Operating the operation button CP4 activates 50 paylines. Operating the operation button CP3 activates 80 paylines. Operating the operation button CP2 activates 100 paylines.

### <Setting of MAX LINEs>

According to the LINE configuration 10, the MAX LINEs are ten paylines; according to the LINE configuration 30, the MAX LINEs are 30 paylines; according to the LINE configuration 40, the MAX LINEs are 40 paylines; according to the LINE configuration 50, the MAX LINEs are 50 paylines; and according to the LINE configuration 100, the MAX LINEs are 100 paylines. These LINE configurations are selectable by the game hall staff such as casino staff, through the setting panel of the slot machine 10.

### <Setting of Denomination>

Denomination (the minimum amount for a bet) can also be selected for the slot machine 10 within a range from 0.01 to 10 dollars, by the game hall staff through the setting panel of the slot machine 10.

### <Settings Specific to Game Hall>

The game hall can determine the MAX LINEs and the denomination for each slot machine 10 differently in view of the circumstances or preference of the game hall. That is to say, the slot machine 10 has a function for the game hall (administrator) to change the MAX LINEs and the denomination; the game hall can make settings for slot machines 10 differently for various types of players including high rollers, even though they are the same model.

Accordingly, the game hall does not need to separately prepare machines for high rollers and machines for the other types of players but changes the MAX LINEs and the denomination in accordance with the results of marketing held in advance to reflect the players' preferences different depending on the hour. As a result, the game hall can save the cost to improve their business conditions.

### <<<Payout Table>>>

FIG. 13 is an example of a payout table. The payout table in FIG. 13 defines winning patterns of 12 kinds of symbols and prizes for the winning patterns.

The payout table indicates relations among the kind of the symbols constituting a winning pattern, the number of the kind, and the prize. The number of the kind equals the number of constituent symbols of the winning pattern that are continuously arranged from left to right along the payline.

As mentioned above, the slot machine 10 in the present embodiment determines whether a winning pattern is completed on a left-to-right basis, except for FEATURE symbols. Accordingly, the prize is determined depending on the kind and the number of symbols continuously arranged along a payline.

The first winning patterns are patterns where two to five WILD symbols are continuously arranged. For example, the prize for five continuously arranged WILD symbols is defined as 250.

A WILD symbol is a symbol to substitute for another symbol to make a higher-ranked winning pattern. When a winning pattern is completed with the other substitute symbol of the WILD symbol, a prize for the winning pattern is determined. In the present embodiment, however, a WILD symbol cannot substitute for a FEATURE symbol.

The second winning patterns are patterns where two to five PICT_A symbols are continuously arranged. For example, the prize for continuously arranged five PICT_A symbols is defined as 50.

As mentioned above, when appearance of a mighty symbol of PICT_A is determined in symbol lottery processing in base game mode, re-spin feature game mode is triggered. Accordingly, if appearance of a mighty symbol of PICT_A is determined in symbol lottery processing, benefits of both of the prize and mode change to re-spin feature game mode are provided to the player.

The third winning patterns are patterns where three to five PICT_B symbols are continuously arranged. For example, the prize for continuously arranged five PICT_B symbols is defined as 40.

The fourth winning patterns are patterns where three to five PICT_C symbols are continuously arranged. For example, the prize for continuously arranged five PICT_C symbols is defined as 30.

The fifth winning patterns are patterns where three to five PICT_D symbols are continuously arranged. For example, the prize for continuously arranged five PICT_D symbols is defined as 25.

The sixth winning patterns are patterns where three to five PICT_E symbols are continuously arranged. For example, the prize for continuously arranged five PICT_E symbols is defined as 20.

The seventh winning patterns are patterns where three to five ACE symbols are continuously arranged. For example, the prize for continuously arranged five ACE symbols is defined as 14.

The eighth winning patterns are patterns where three to five KING symbols are continuously arranged. For example, the prize for continuously arranged five KING symbols is defined as 13.

The ninth winning patterns are patterns where three to five QUEEN symbols are continuously arranged. For example, the prize for continuously arranged five QUEEN symbols is defined as 12.

The tenth winning patterns are patterns where three to five JACK symbols are continuously arranged. For example, the prize for continuously arranged five JACK symbols is defined as 11.

The eleventh winning patterns are patterns where three to five TEN symbols are continuously arranged. For example, the prize for continuously arranged five TEN symbols is defined as 10.

The twelfth winning pattern is a pattern where one FEATURE symbol is shown. As described above, the FEATURE symbols are scatter symbols. Accordingly, continuous arrangement of FEATURE symbols is not a requirement to complete a winning pattern but the number of FEATURE symbols shown in the symbol display area 141d determines whether the twelfth winning pattern is completed. The prize for appearance of one FEATURE symbol is defined as 1.

As mentioned above, when appearance of a mighty symbol of FEATURE is determined in symbol lottery processing in base game mode, free game mode is triggered. Accordingly, if appearance of a mighty symbol of FEATURE is determined in symbol lottery processing, benefits of both of the prize and mode change to free game mode are provided to the player.

As mentioned above, when appearance of a mighty symbol of a kind other than FEATURE is determined in symbol lottery processing in free game mode, re-spin feature game mode is triggered. Accordingly, if appearance of a mighty symbol of a kind other than FEATURE is determined in symbol lottery processing, benefits of both of the prize and mode change to re-spin feature game mode are provided to the player.

### <Configuration of Reel Strips>

FIGS. 14A to 19C are charts for defining reel strips (symbol arrays) for the five video reels 3a to 3e. Digital codes representing individual kinds of symbols are stored in the main RAM 210.

FIGS. 14A to 19C indicate the individual reel strips of the five video reels 3a to 3e. The tables in FIGS. 14A to 19C specify symbols with code numbers and function as symbol determination tables to determine five to-be stopped symbols in the symbol lottery processing in FIG. 23. That is to say, the main CPU 200 extracts five random numbers to determine five code numbers and determine the five symbols corresponding to the code numbers to be the to-be stopped symbols.

The symbols shown in FIGS. 14A to 19C are selected at equal probabilities by lottery to become to-be stopped symbols.

### <Normal Reel Strips 3n and Replacement Reel Strips 3x for Base Game Mode>

FIGS. 14A and 14B provide a chart for illustrating symbol arrays of the normal reel strips 3n-a, 3n-b, 3n-c, 3n-d, and 3n-e to be used in base game mode. On the normal reel strips 3n to be used in base game mode (FIGS. 14A and 14B), WILD, PICT_A, PICT_B, PICT_C, PICT_D, PICT_E, ACE, KING, QUEEN, JACK, and TEN symbols are disposed in advance. The normal reel strip 3n-a for base game mode includes 40 symbols thereon; the normal reel strip 3n-b includes 70 symbols; the normal reel strip 3n-c includes 66 symbols; the normal reel strip 3n-d includes 64 symbols; and the normal reel strip 3n-e includes 40 symbols.

FIGS. 17A to 17C provide a chart for illustrating symbol arrays of the replacement reel strips 3x-a, 3x-b, 3x-c, 3x-d, and 3x-e to be used in base game mode. As shown in FIGS. 17A to 17C, the replacement reel strips 3x-a and 3x-e to be used in base game mode include BLANK and CHANGE symbols and the replacement reel strips 3x-b, 3x-c, and 3x-d to be used in base game mode include BLANK and M_CHANGE symbols.

The replacement reel strip 3x-a for base game mode includes 100 symbols; each of the replacement reel strips 3x-b to 3x-d includes 14 symbols; and the replacement reel strip 3x-e includes 164 symbols.

The replacement reel strip 3x-a includes BLANK symbols consecutively from No. 0 to No. 63 and CHANGE symbols consecutively from No. 64 to No. 99.

Each of the replacement reel strips 3x-b to 3x-d includes BLANK symbols consecutively from No. 0 to No. 3, M_CHANGE symbols consecutively from No. 4 to No. 6, BLANK symbols consecutively from No. 7 to No. 10, and M_CHANGE symbols consecutively from No. 11 to No. 13.

The replacement reel strip 3x-e includes BLANK symbols consecutively from No. 0 to No. 127 and CHANGE symbols consecutively from No. 128 to No. 163.

As noted from the above, on the replacement reel strips 3x, BLANK, CHANGE, and M_CHANGE symbols are disposed consecutively. As will be described later, the CHANGE symbols and the M_CHANGE symbols are replaced by the same kind of element symbols. Accordingly, the element symbols are disposed consecutively and the consecutive element symbols will appear in the symbol display area 141d with high probability, which increases the probability to complete winning patterns.

CHANGE symbols are disposed on the replacement reel strips 3x-a and 3x-e. The CHANGE symbols are virtual symbols to be replaced by one kind of element symbols selected from WILD, PICT_A, PICT_B, PICT_C, PICT_D, PICT_E, ACE, KING, QUEEN, JACK, and TEN symbols. The CHANGE symbols are replaced by the element symbols in internal processing; they are not displayed in the symbol display area 141d to be seen by the player.

M_CHANGE symbols are disposed on the replacement reel strips 3x-b, 3x-c, and 3x-d. The M_CHANGE symbols are virtual symbols to be replaced by one kind of element symbols selected from WILD, PICT_A, PICT_B, PICT_C, PICT_D, PICT_E, ACE, KING, QUEEN, JACK, TEN, and FEATURE symbols. The M_CHANGE symbols are replaced by the element symbols in internal processing; they are not displayed in the symbol display area 141d to be seen by the player.

The M_CHANGE symbols are to display a mighty symbol. The mighty symbol has a size of nine frames (three reels by three rows of cells) of symbols for one symbol. The M_CHANGE symbols are replaced by a kind of element symbols and the symbols that have replaced are displayed as a mighty symbol having the size of nine frames (nine cells) (see FIGS. 35 to 37)

As shown in FIG. 17A, M_CHANGE symbols are disposed at No. 4 to 6 (for nine frames) and No. 11 to 13 (for nine frames) on each of the replacement reel strips 3x-b, 3x-c, and 3x-d. The M_CHANGE symbols in the nine frames are unified to be one mighty symbol in each of the area of No. 4 to 6 (for nine frames) and the area of No. 11 to 13 (for nine frames). For example, in the case where the M_CHANGE symbols are replaced by PICT_A symbols, all the symbols of No. 4 to 6 (nine frames) and No. 11 to 13 (nine frames) are replaced by PICT_A symbols. When M_CHANGE symbols are replaced by PICT_A symbols, mighty symbols of PICT_A occupying nine frames are displayed. It should be noted that, depending on the progress of games, the mighty symbol may be divided and displayed in the form of a plurality of normal-sized symbols (see FIG. 36)

### <Normal Reel Strips 3n and Replacement Reel Strips 3x for First Free Game Mode>

FIG. 15 is a chart for illustrating symbol arrays of the normal reel strips 3n-a, 3n-b, 3n-c, 3n-d, and 3n-e to be used in the first free game mode. On the normal reel strips 3n to be used in the first free game mode, WILD, PICT_A, PICT_B, PICT_C, PICT_D, and PICT_E symbols are disposed in advance. Each of the normal reel strips 3n-a to 3n-e for the first free game mode includes 30 symbols thereon.

FIGS. 18A to 18C provide a chart for illustrating symbol arrays of the replacement reel strips 3x-a, 3x-b, 3x-c, 3x-d, and 3x-e to be used in the first free game mode. Like FIGS. 17A to 17C, the replacement reel strips 3x-a and 3x-e to be used in the first free game mode includes BLANK and CHANGE symbols and the replacement reel strips 3x-b, 3x-c, and 3x-d include BLANK and M_CHANGE symbols.

The replacement reel strip 3x-a for the first free game mode includes 100 symbols; each of the replacement reel strips 3x-b to 3x-d includes 14 symbols; and the replacement reel strip 3x-e includes 164 symbols.

Each of the replacement reel strips 3x for the first free game mode includes BLANK, CHANGE, and M_CHANGE symbols consecutively. The CHANGE and M_CHANGE symbols have the same functions as the CHANGE and M_CHANGE symbols on the replacement reel strips 3x for base game mode.

### <Normal Reel Strips 3n and Replacement Reel Strips 3x for Second Free Game Mode>

FIG. 16 is a chart for illustrating symbol arrays of the normal reel strips 3n-a, 3n-b, 3n-c, 3n-d, and 3n-e to be used in the second free game mode. On the normal reel strips 3n to be used in the second free game mode, ACE, KING, QUEEN, JACK, and TEN symbols are disposed in advance. Each of the normal reel strips 3n-a to 3n-e for the second free game mode includes ten symbols thereon.

FIGS. 18A to 18C provide a chart for illustrating symbol arrays of the replacement reel strips 3x-a, 3x-b, 3x-c, 3x-d, and 3x-e to be used in the second free game mode. The replacement reel strips 3x-a, 3x-b, 3x-c, 3x-d, and 3x-e for the second free game mode are the same as the replacement reel strips 3x-a, 3x-b, 3x-c, 3x-d, and 3x-e for the first free game mode.

### <Normal Reel Strips 3n and Replacement Reel Strips 3x for Third Free Game Mode>

FIGS. 14A and 14B provide a chart for illustrating symbol arrays of the normal reel strips 3n-a, 3n-b, 3n-c, 3n-d, and 3n-e to be used in the third free game mode. The normal reel strips 3n to be used in the third free game mode are the same as the normal reel strips 3n to be used in base game mode.

FIGS. 19A to 19C provide a chart for illustrating symbol arrays of the replacement reel strips 3x-a, 3x-b, 3x-c, 3x-d, and 3x-e to be used in the third free game mode. The replacement reel strip 3x-a for the third free game mode includes 100 symbols thereon; each of the replacement reel strips 3x-b to 3n-d includes 105 symbols; and the replacement reel strip 3x-e includes 164 symbols.

The replacement reel strip 3x-a includes BLANK symbols consecutively from No. 0 to No. 63 and CHANGE symbols consecutively from No. 64 to No. 99.

The replacement reel strip 3x-e includes BLANK symbols consecutively from No. 0 to No. 127 and CHANGE symbols consecutively from No. 128 to No. 163.

All the symbols on the replacement reel strips 3x-b to 3x-d are defined to have a size of nine frames (3×3) and are displayed as mighty symbols. Unlike the replacement reel strips for the first or second free game mode, the replacement reel strips 3x-b to 3x-d do not include any M_CHANGE symbol.

On the replacement reel strips 3x-b to 3x-d, WILD, PICT_A, PICT_B, PICT_C, PICT_D, PICT_E, ACE, KING, QUEEN, JACK, TEN, and FEATURE symbols are disposed consecutively so that one kind of symbols occupy 3×3 of nine frames.

### <<Description of Program>>

Now, with reference to FIGS. 21 to 29, the program to be executed by the slot machine 10 is described.

### <Main Control Processing>

FIG. 21 is a flowchart of main control processing for the slot machine 10. The game mode in this main control in FIG. 21 is base game mode.

First, when the power is supplied to the slot machine 10, the main CPU 200 retrieves the authenticated game program and game system program from the auxiliary storage device 220 (SSD device SD1) through the AX-GMEM board G13, and writes the programs into the main RAM 210 (step S1911).

Next, the main CPU 200 conducts at-one-game-end initialization processing (step S1913). For example, the main CPU 200 clears data that becomes unnecessary after each game in the working areas of the main RAM 210, such as the amount of bet and the symbols determined by lottery.

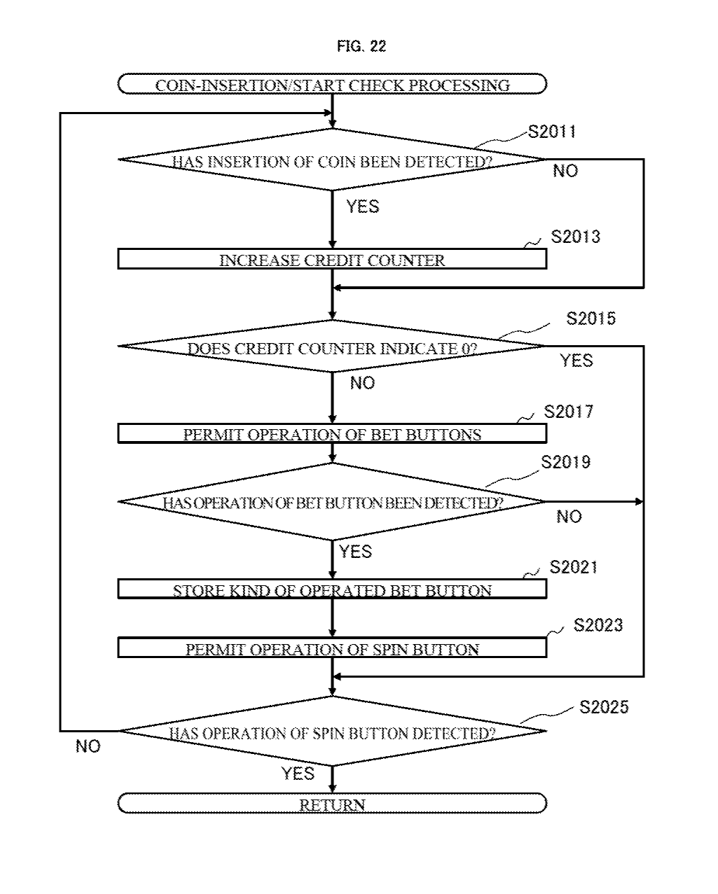

Next, the main CPU 200 performs coin-insertion/start check processing illustrated in FIG. 22 (step S1915). In the processing, whether input from any of the BET buttons (operation buttons CP2 to CP6) or the spin button (operation button CP1) has been detected is checked.

Next, the main CPU 200 conducts symbol lottery processing illustrated in FIG. 23 (step S1917). In the processing, to-be stopped symbols are determined based on the random numbers for symbol determination.

Next, the main CPU 200 conducts replacement symbol lottery processing illustrated in FIG. 24 (step S1919).

Next, the main CPU 200 conducts effect lottery processing (step S1921). Specifically, the main CPU 200 extracts a random number for determination of effects, and determines an effect content from the predefined plurality of effect contents by lottery, and executes the determined effect content with predetermined timing. For example, the main CPU 200 performs control to display a video for presentation effects on the upper liquid crystal display panel 131b, to output audio from a speaker (not shown), to flash a lamp (not shown), and to apply special effects to these. The upper liquid crystal display panel 131b also displays images when a free game trigger is completed or when the player selects free games thereafter.

Next, the main CPU 200 conducts symbol display control processing illustrated in FIG. 26 (step S1923). In this processing, spinning of the five video reels 3a to 3e (scrolling of the five reel strips) is started, and the to-be stopped symbols determined in the symbol lottery processing at step S1917 are stopped at predetermined positions.

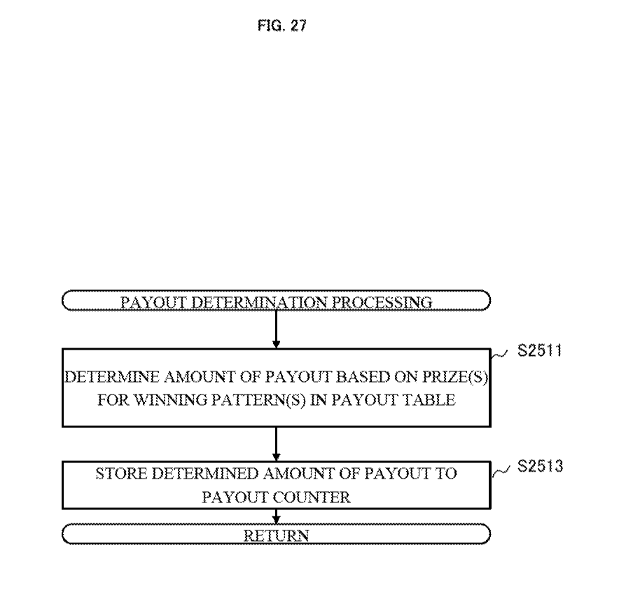

Next, the main CPU 200 conducts payout determination processing illustrated in FIG. 27 (step S1925). In the processing, an amount of payout based on the payout table (see FIG. 13) is determined depending on the winning pattern completed with the symbols arranged along the paylines, and is stored into a payout storage area (payout counter) provided in the main RAM 210.

Next, the main CPU 200 determines whether a free game trigger is completed (step S1927).

If the determination is that a free game trigger is completed, the main CPU 200 conducts free game mode processing illustrated in FIG. 28 (step S1929).

If the determination at step S1927 is that a free game trigger is not completed, the main CPU 200 determines whether a re-spin feature game trigger is completed (step S1931). If the determination is that a re-spin feature game trigger is completed, the main CPU 200 conducts re-spin feature game mode processing illustrated in FIG. 29 (step S1933).

After step S1929 or S1933 or if the determination at step S1931 is that a re-spin feature game trigger is not completed, the main CPU 200 conducts payout processing (step S1935) and returns to step S1913.

The main CPU 200 adds the value stored in the payout storage area (payout counter) to the value stored in a credit storage area (credit counter) provided in the main RAM 210. Alternatively, operations of the hopper (not shown) may be controlled to eject coins corresponding to the value stored in the payout counter from the coin payout exit. Still alternatively, operations of a ticket printer (not shown) may be controlled to issue a ticket with a barcode on which a value stored in the payout counter is recorded.

### <Coin-Insertion/Start Check Processing>

FIG. 22 is a flowchart of the coin-insertion/start check processing for the slot machine 10 according to the embodiment of the present invention.

First, the main CPU 200 determines whether or not insertion of a coin has been detected by the coin counter (step S2011).

When determining that the insertion of a coin has been detected, the main CPU 200 adds the value of the inserted coin to the value stored in the credit storage area (credit counter) (step S2013). It is to be noted that, in addition to the insertion of a coin, the main CPU 200 may determine whether or not insertion of a bill has been detected with a bill validator (e.g., the PTS terminal 700), and when determining that the insertion of a bill has been detected, the main CPU 200 may add a value corresponding to the amount of bill to the value stored in the credit counter.

After executing step S2013 or when determining in step S2011 that no insertion of a coin has been detected, the main CPU 200 determines whether or not the credit counter indicates zero (step S2015).

When determining that the credit counter indicates a non-zero value, the main CPU 200 permits operation of the BET buttons (the operation buttons CP2 to CP6) (step S2017).

Next, the main CPU 200 determines whether or not operation of any of the BET buttons (the operation buttons CP2 to CP6) has been detected (step S2019).

When detecting press of a BET button (one of the operation buttons CP2 to CP6) by the player with a BET switch, the main CPU 200 stores the kind of the BET button (one of the operation buttons CP2 to CP6) to the main RAM 210 (step S2021).

Next, the main CPU 200 permits operation of the spin button (step S2023).

The main CPU 200 determines whether or not operation of the spin button (the operation button CP1) has been detected (step S2025). When determining that no operation of the spin button has been detected, the main CPU 200 returns to step S2011.

When determining that operation of the spin button has been detected, the main CPU 200 exits this subroutine.

### <Symbol Lottery Processing>

FIG. 23 is a flowchart of the subroutine of symbol lottery processing.

First, the main CPU 200 extracts random numbers to determine symbols for the normal reel strips 3n-a to 3n-e (step S2111).

Next, the main CPU 200 determines to-be stopped symbols for the normal reel strips 3n-a to 3n-e with reference to the symbol determination table for normal reel strips 3n (FIGS. 14A and 14B, FIG. 15, or FIG. 16) (step S2113).

The symbol determination tables for normal reel strips 3n include the symbol determination table for normal reel strips 3n for base game mode (FIGS. 14A and 14B), and symbol determination tables for normal reel strips 3n for free game modes (FIG. 15, FIG. 16, and FIGS. 14A and 14B).

When the game mode is base game mode, the main CPU 200 refers to the symbol determination table for normal reel strips 3n for base game mode (FIGS. 14A and 14B) to determine to-be stopped symbols for the normal reel strips 3n-a to 3n-e. When the game mode is the first free game mode, the main CPU 200 refers to the symbol determination table for normal reel strips 3n for free game mode (FIG. 15) to determine to-be stopped symbols for the normal reel strips 3n-a to 3n-e. When the game mode is the second free game mode, the main CPU 200 refers to the symbol determination table for normal reel strips 3n for free game mode (FIG. 16) to determine to-be stopped symbols for the normal reel strips 3n-a to 3n-e. When the game mode is the third free game mode, the main CPU 200 refers to the symbol determination table for normal reel strips 3n for free game mode (FIGS. 14A and 14B) to determine to-be stopped symbols for the normal reel strips 3n-a to 3n-e.

The main CPU 200 stores the to-be stopped symbols for the normal reel strips 3n-a to 3n-e determined at step S2113 to the symbol storage area provided in the main RAM 210 (step S2115).

Next, the main CPU 200 extracts random numbers to determine symbols for the replacement reel strips 3x-a to 3x-e (step S2117).

Next, the main CPU 200 determines to-be stopped symbols for the replacement reel strips 3x-a to 3x-e with reference to the symbol determination table for replacement reel strips 3x (FIGS. 17A to 17C, FIGS. 18A to 18C, or FIGS. 19A to 19C) (step S2119).

The symbol determination tables for replacement reel strips 3x include the symbol determination table for replacement reel strips 3x for base game mode (FIGS. 17A to 17C), and symbol determination tables for replacement reel strips 3x for free game mode (FIGS. 18A to 18C and FIGS. 19A to 19C).

When the game mode is base game mode, the main CPU 200 refers to the symbol determination table for replacement reel strips 3x for base game mode (FIGS. 17A to 17C) to determine to-be stopped symbols for the replacement reel strips 3x-a to 3x-e. When the game mode is the first kind or the second free game mode, the main CPU 200 refers to the symbol determination table for replacement reel strips 3x for free game mode (FIGS. 18A to 18C) to determine to-be stopped symbols for the replacement reel strips 3x-a to 3x-e. When the game mode is the third free game mode, the main CPU 200 refers to the symbol determination table for replacement reel strips 3x for free game mode (FIGS. 19A to 19C) to determine to-be stopped symbols for the normal reel strips 3x-a to 3x-e.

The main CPU 200 stores the to-be stopped symbols for the replacement reel strips 3x-a to 3x-e determined at step S2119 to the symbol storage area provided in the main RAM 210 (step S2121).

Next, the main CPU 200 determines whether any winning pattern is completed with reference to the payout table in FIG. 13, based on the to-be stopped symbols stored in the symbol storage areas through the processing of steps S2115 and S2121 (step S2123). The main CPU 200 determines a prize associated with the number of the kind if some winning pattern is completed.

### <Replacement Symbol Lottery Processing>

FIG. 24 is a flowchart of the subroutine of replacement symbol lottery processing. The replacement symbol lottery processing is to determine element symbols to replace all the to-be replaced symbols (CHANGE and M_CHANGE symbols) disposed on the replacement reel strips 3x.

First, the main CPU 200 extracts a random number for symbol determination (step S2211).

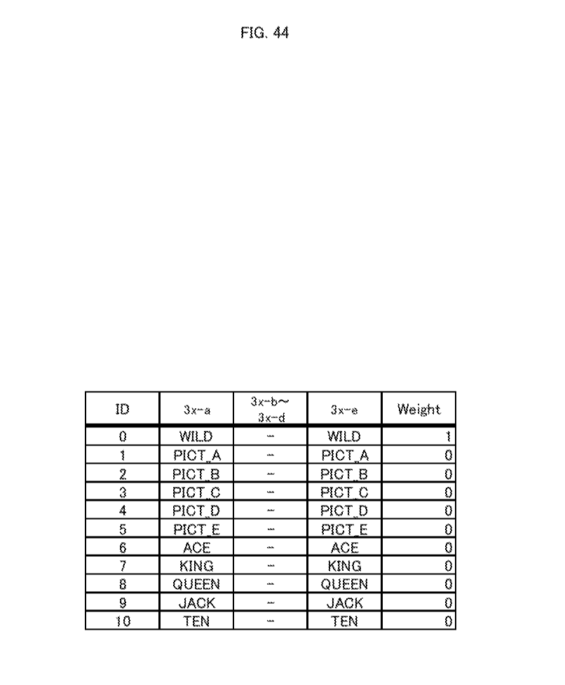

Next, the main CPU 200 determines a combination of element symbols with reference to a replacement symbol determination table (FIGS. 32A to 32P, FIG. 33A to 33I, FIG. 42, or FIG. 44) (step S2213).

Specifically, the main CPU 200 determines a combination of the kind of the element symbols to replace the CHANGE symbols on the replacement reel strips 3x-a, the kind of the element symbols to replace the M_CHANGE symbols on the replacement reel strips 3x-b to 3x-d, and the kind of the element symbols to replace the CHANGE symbols on the replacement reel strips 3x-e at step S2213.

The replacement symbol determination tables include a replacement symbol determination table for base game mode (FIGS. 32A to 32P) and replacement symbol determination tables for free game mode (FIGS. 33A to 33I, FIG. 42, and FIG. 44).

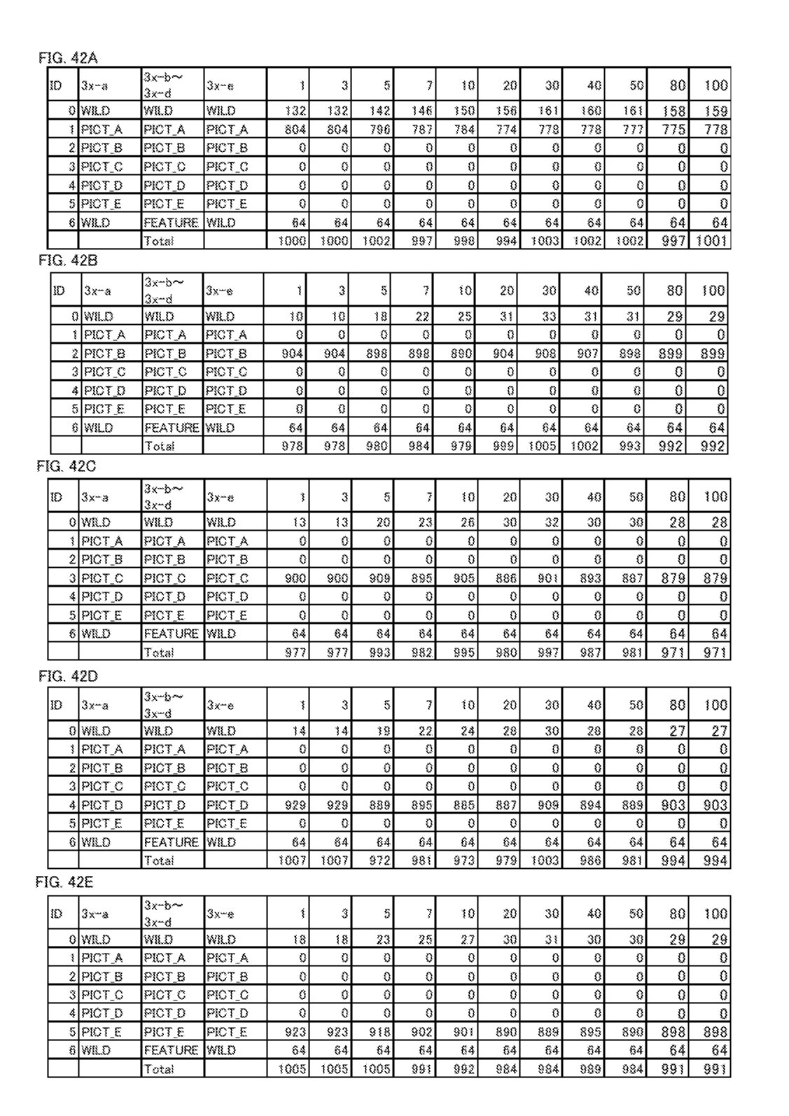

The processing of step S2213 is as follows: when the game mode is base game mode, the main CPU 200 refers to the replacement symbol determination table for base game mode (FIGS. 32A to 32P) to determine a combination of element symbols. When the game mode is the first free game mode, the main CPU 200 refers to the replacement symbol determination table for free game mode (FIGS. 33A to 33I) to determine a combination of element symbols. When the game mode is the second free game mode, the main CPU 200 refers to the replacement symbol determination table for free game mode (FIG. 42) to determine a combination of element symbols. When the game mode is the third free game mode, the main CPU 200 refers to the replacement symbol determination table for free game mode (FIG. 44) to determine a combination of element symbols.

Accordingly, the processing of step S2211 is as follows: when the game mode is base game mode, the main CPU 200 extracts a random number to be used with the replacement symbol determination table for base game mode. When the game mode is free game mode, the main CPU 200 extracts a random number to be used with the replacement symbol determination table for free game mode.

Specifically, when the game mode is base game mode, the main CPU 200 extracts a random number from the range described below at step S2211.

In the case where one payline is activated, an integer is selected out of 1 to 23952 as random number. In the case where three paylines are activated, an integer is selected out of 1 to 23952 as random number. In the case where five paylines are activated, an integer is selected out of 1 to 14182 as random number.

In the case where seven paylines are activated, an integer is selected out of 1 to 12298 as random number. In the case where ten paylines are activated, an integer is selected out of 1 to 10412 as random number. In the case where 20 paylines are activated, an integer is selected out of 1 to 9171 as random number. In the case where 30 paylines are activated, an integer is selected out of 1 to 8701 as random number.

In the case where 40 paylines are activated, an integer is selected out of 1 to 9171 as random number. In the case where 50 paylines are activated, an integer is selected out of 1 to 9171 as random number. In the case where 80 paylines are activated, an integer is selected out of 1 to 10115 as random number. In the case where 100 paylines are activated, an integer is selected out of 1 to 9643 as random number.

When the game mode is the first free game mode, the main CPU 200 extracts a random number from the range described below at step S2211.

In the case where one payline is activated, an integer is selected out of 1 to 3588 as random number. In the case where three paylines are activated, an integer is selected out of 1 to 3588 as random number. In the case where five paylines are activated, an integer is selected out of 1 to 3660 as random number.

In the case where seven paylines are activated, an integer is selected out of 1 to 3636 as random number. In the case where ten paylines are activated, an integer is selected out of 1 to 3684 as random number. In the case where 20 paylines are activated, an integer is selected out of 1 to 3660 as random number. In the case where 30 paylines are activated, an integer is selected out of 1 to 3660 as random number.

In the case where 40 paylines are activated, an integer is selected out of 1 to 3660 as random number. In the case where 50 paylines are activated, an integer is selected out of 1 to 3708 as random number. In the case where 80 paylines are activated, an integer is selected out of 1 to 3684 as random number. In the case where 100 paylines are activated, an integer is selected out of 1 to 3660 as random number.

When the game mode is the second free game mode, the main CPU 200 extracts a random number from the ranges indicated in the fields of Total in FIG. 42 at step S2211. When the game mode is the third free game mode, the main CPU 200 extracts 1 as random number at step S2211 (see the weights in FIG. 44).

The replacement symbol determination table for base game mode (FIG. 32A to 32P) and the replacement symbol determination tables for free game mode (FIG. 33A to 33I and FIG. 42) specify combinations of replacement symbols for the CHANGE symbols on the replacement reel strip 3x-a, replacement symbols for the M_CHANGE symbols on the replacement reel strips 3x-b to 3x-d, and replacement symbols for the CHANGE symbols on the replacement reel strip 3x-e and the weights of the individual combinations. The replacement symbol determination table for free game mode in FIG. 44 specifies combinations of replacement symbols for the CHANGE symbols on the replacement reel strips 3x-a and 3x-e and the weights of the individual combinations. As shown in FIGS. 19A to 19C, no M_CHANGE symbol is provided on the replacement reel strips 3x-b to 3x-d for the third free game mode. The CHANGE symbols on the replacement reel strips 3x-a and 3x-e are to be replaced.

In the replacement symbol determination tables in FIGS. 32A to 32P, FIGS. 33A to 33I, and FIG. 42, the weight 0 means that the combination will not be selected; the weight 1 means that the combination will be selected with a very small probability. In the replacement symbol determination table in FIG. 44, only the WILD shows a weight of 1 and the other symbols shows a weight of 0. That is to say, according to the replacement symbol determination table in FIG. 44, the WILD is selected each time and the CHANGE symbols on the replacement reel strips 3x-a and 3x-e are replaced by WILD symbols each time.

For example, the weights of the combination “JACK”-“PICT_A”-“PICT_C” of ID No. 223 in the replacement symbol determination table for base game mode (FIGS. 32A to 32P) is all 0; accordingly, this combination is not selected in the lottery processing.

The weights of the combination “WILD”-“WILD”-“WILD” of ID No. 0 in the replacement symbol determination table for base game mode (FIGS. 32A to 32P) are all 1; accordingly, this combination “WILD”-“WILD”-“WILD” is selected as follows.

In the case where one payline is activated, this combination is determined with a probability of 1/23952. In the case where three paylines are activated, this combination is determined with a probability of 1/23952. In the case where five paylines are activated, this combination is determined with a probability of 1/14182.

In the case where seven paylines are activated, this combination is determined with a probability of 1/12298. In the case where ten paylines are activated, this combination is determined with a probability of 1/10412. In the case where 20 paylines are activated, this combination is determined with a probability of 1/9171. In the case where 30 paylines are activated, this combination is determined with a probability of 1/8701.

In the case where 40 paylines are activated, this combination is determined with a probability of 1/9171. In the case where 50 paylines are activated, this combination is determined with a probability of 1/9171. In the case where 80 paylines are activated, this combination is determined with a probability of 1/10115. In the case where 100 paylines are activated, this combination is determined with a probability of 1/9643.

The weights of the combination “PICT_B”-“PICT_D”-“PICT_D” of ID No. 510 in the replacement symbol determination table for base game mode (FIGS. 32A to 32P) are 244, 244, 179, 143, 168, 143, 130, 142, 139, 133, and 153; accordingly, this combination “PICT_B”-“PICT_D”-“PICT_D” of ID No. 510 is selected as follows.

In the case where one payline is activated, this combination is determined with a probability of 244/23952. In the case where three paylines are activated, this combination is determined with a probability of 244/23952. In the case where five paylines are activated, this combination is determined with a probability of 179/14182.

In the case where seven paylines are activated, this combination is determined with a probability of 143/12298. In the case where ten paylines are activated, this combination is determined with a probability of 168/10412. In the case where 20 paylines are activated, this combination is determined with a probability of 143/9171. In the case where 30 paylines are activated, this combination is determined with a probability of 130/8701.

In the case where 40 paylines are activated, this combination is determined with a probability of 142/9171. In the case where 50 paylines are activated, this combination is determined with a probability of 139/9171. In the case where 80 paylines are activated, this combination is determined with a probability of 133/10115. In the case where 100 paylines are activated, this combination is determined with a probability of 153/9643.

The replacement symbol determination tables for free game mode (FIGS. 33A to 33I and FIG. 42) also determine a combination of element symbols. It is to be noted that the replacement symbol determination table for the third free game mode (FIG. 44) selects the WILD each time regardless of the number of activated paylines; the CHANGE symbols on the replacement reel strips 3x-a and 3x-e are replaced by WILD symbols each time.

Next, the main CPU 200 replaces all the to-be replaced symbols of CHANGE symbols and M_CHANGE symbols disposed on the replacement reel strips 3x with the combination of element symbols determined at step S2213, stores the symbols to the symbol storage area (step S2215), and exits this subroutine.

This replacement symbol lottery processing determines a combination of the kind of the element symbols to replace the CHANGE symbols on the replacement reel strip 3x-a, the kind of the element symbols to replace the M_CHANGE symbols on the replacement reel strips 3x-b to 3x-d, and the kind of the element symbols to replace the CHANGE symbols on the replacement reel strip 3x-e by one lottery.

### <Specific Example of Replacement>

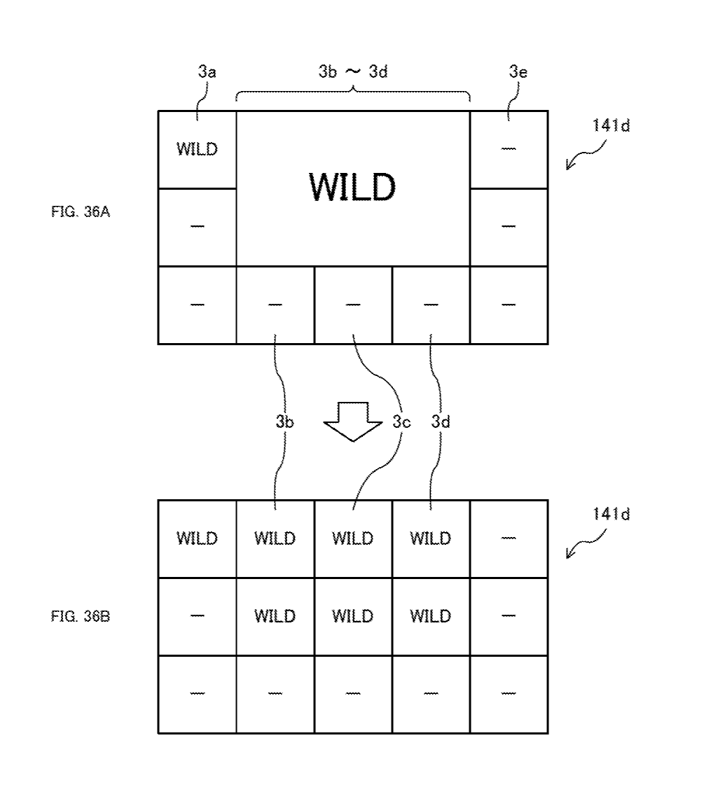

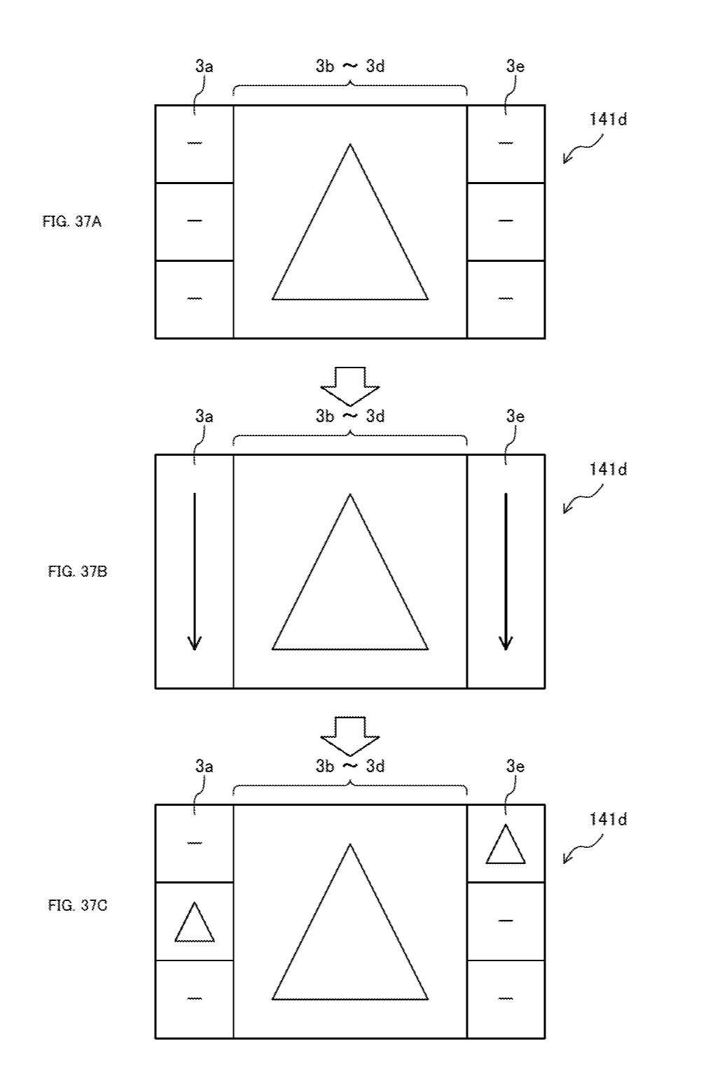

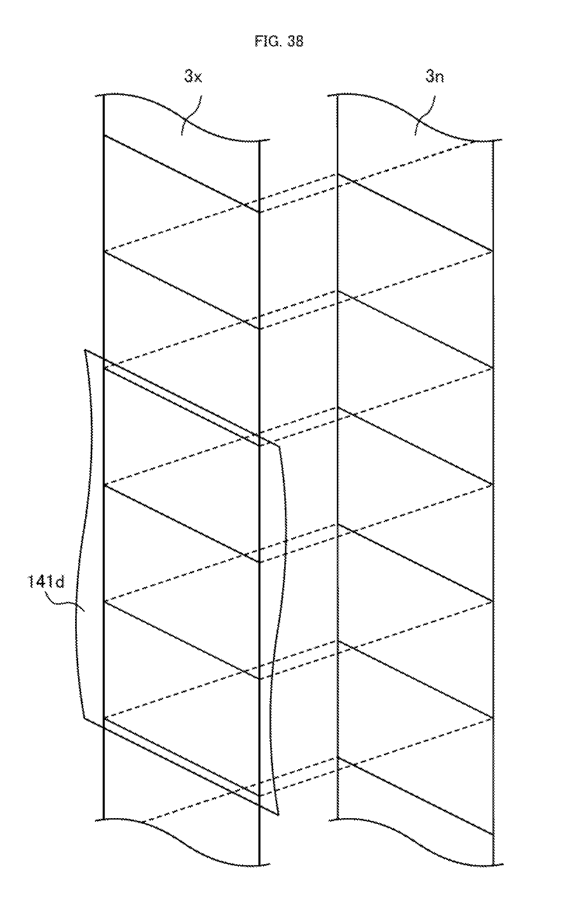

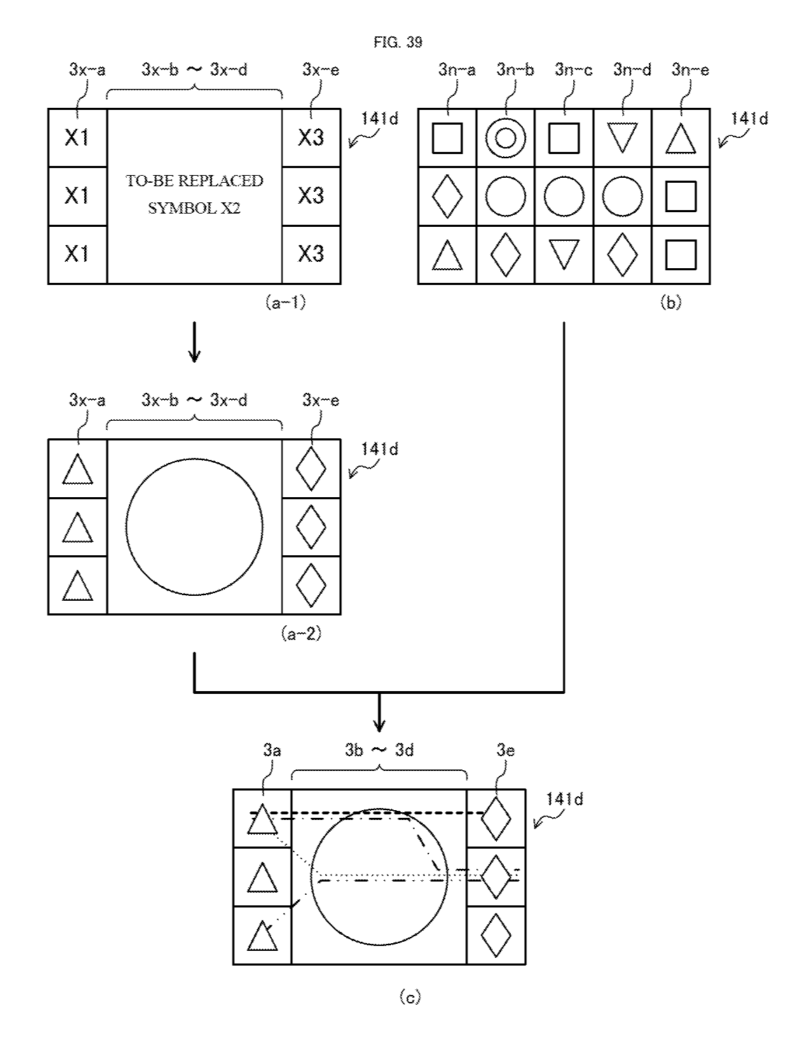

FIG. 39 is a conceptual diagram for illustrating the process of replacing symbols. FIGS. 39(a-1) and (a-2) show the replacement reel strips 3x-a to 3x-e and FIG. 39(b) shows the normal reel strips 3n-a to 3n-e.

To clearly illustrate the process of replacing symbols, FIG. 39 shows the symbols in the symbol display area 141d; however, the symbol replacement processing is performed internally before start scrolling the symbols. The CHANGE and M_CHANGE symbols to be replaced are not displayed to be seen by the player.

In FIG. 39(a-1), the to-be replaced symbols X1 on the replacement reel strip 3x-a are CHANGE symbols. The to-be replaced symbols X1 are replaced by the element symbols indicated in the column of 3x-a of the replacement symbol determination table (FIGS. 32A to 32P or FIGS. 33A to 33I).

In FIG. 39(a-1), the to-be replaced symbols X3 on the replacement reel strip 3x-e are CHANGE symbols. The to-be replaced symbols X3 are replaced by the element symbols indicated in the column of 3x-e of the replacement symbol determination table (FIGS. 32A to 32P or FIGS. 33A to 33I).

In FIG. 39(a-1), the to-be replaced symbol X2 on the replacement reel strips 3x-b to 3x-d is an M_CHANGE symbol. The to-be replaced symbol X2 is replaced by the element symbol indicated in the column of 3x-b to 3x-d of the replacement symbol determination table (FIGS. 32A to 32P or FIGS. 33A to 33I).

Through the replacement processing, the symbols are replaced by the element symbols as shown in FIG. 39(a-2). Each to-be replaced symbol X1 is replaced by an element symbol denoted by a triangle; the to-be replaced symbol X2 is replaced by an element symbol denoted by a circle; and each to-be replaced symbol X3 is replaced by an element symbol represented by a rhombus.

As described above, the to-be replaced CHANGE symbols (X1 and X3) and M_CHANGE symbol (X2) on the replacement reel strips 3x-a to 3x-e are replaced by element symbols.

In the meanwhile, as shown in FIG. 39(b), various element symbols are determined to be rearranged for the normal reel strips 3n-a to 3n-e. However, if the post-replacement element symbols on the replacement reel strips 3x and the symbols on the normal reel strips 3n are stacked, the post-replacement element symbols on the replacement reel strips 3x are selectively displayed as shown in FIG. 39(c).

### <Appeal Rewrite Processing>

FIG. 25 is a flowchart of the subroutine of appeal rewrite processing. The appeal rewrite processing is performed in all game modes of base game mode, free game modes, and re-spin feature game mode. The appeal rewrite is rewriting symbols included in symbol arrays to show a specific kind of symbols immediately after the start of scrolling. It is preferable to rewrite symbols so that a plurality of symbols of the specific kind will appear successively. After start of scrolling, the specific kind of symbols are displayed immediately and successively; the player can easily recognize the specific kind of symbols and feel expectation for completion of a winning pattern of the specific kind of symbol.

In free game mode, the specific kind of symbols are determined by lottery. In re-spin feature game mode, symbols are rewritten with the same kind of symbols as the mighty symbol held on the video reels 3b to 3d.

In the slot machine 10, the appeal rewrite is performed only for the two replacement reel strips 3x-a and 3x-e. The appeal rewrite is not performed for the remaining replacement reel strips 3x-b to 3x-d and normal reel strips 3n-a to 3n-e.

First, the main CPU 200 conducts lottery processing to determine whether to apply appeal rewrite (step S2311). The probabilities to apply the appeal rewrite in this lottery are specified so that appeal rewrite is to be applied with higher probability in re-spin feature game mode than in free game mode.

Next, the main CPU 200 determines whether to apply appeal rewrite (step S2313).

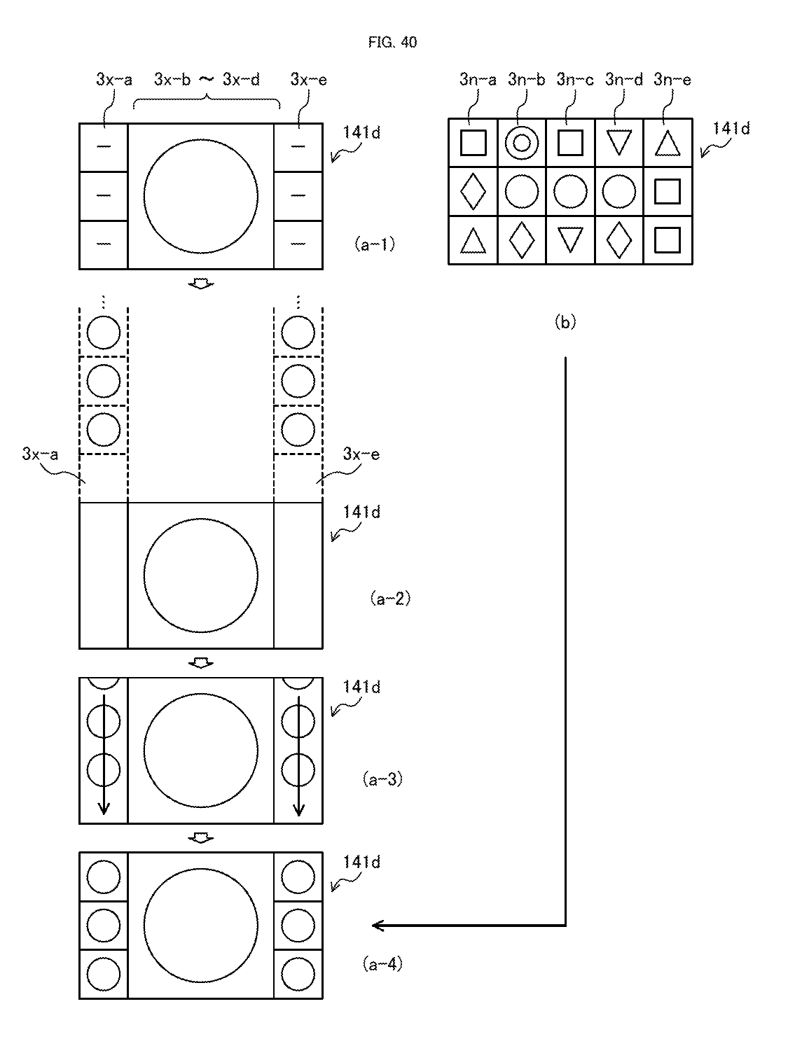

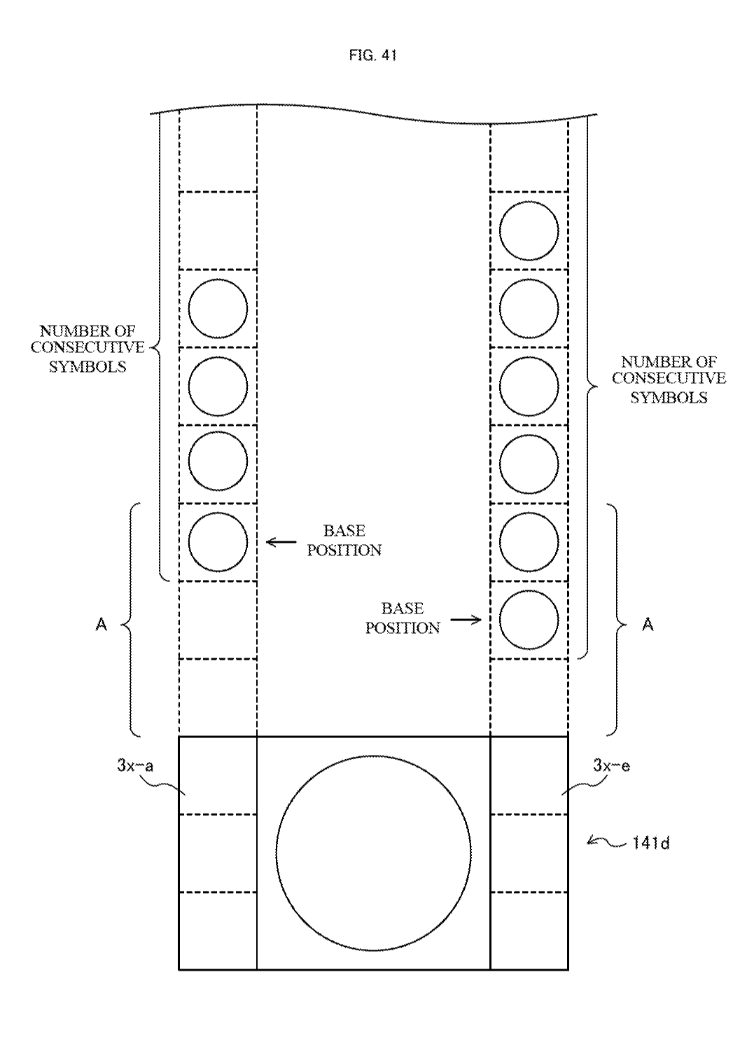

If the determination is to apply appeal rewrite, the main CPU 200 determines the base position for the rewrite by lottery (step S2315). As illustrated in FIG. 41, the base position is determined to be a position upstream with respect to the direction of scrolling and distant from the top end of the symbol display area 141d by a predetermined number of symbols along the reel strip 3x.

In the example illustrated in FIG. 41, the base position of the replacement reel strip 3x-a is the third frame from the top end of the symbol display area 141d and the base position of the replacement reel strip 3x-e is the second frame from the top end of the symbol display area 141d.

It is preferable to determine the base position based on the number of symbols disposed along the direction of scrolling in the symbol display area 141d. For example, symbols are displayed at three positions of the top row, the middle row, and the bottom row in the symbol display area 141d along the direction of scrolling as described with FIG. 12. In this case, the preferable position for the base position is any position within three frames upstream of the top end of the symbol display area 141d. The preferable position for the base position is any position within the range A shown in FIG. 41. Determining the base position to be the position upstream by the number of symbols disposed along the reel strip 3x in the symbol display area 141d enables the rewritten symbols to be shown in the symbol display area 141d immediately after the start of scrolling.

Since the position for the base position is determined by lottery at step S2315, the time to show the rewritten symbols can be different, so that the player can feel as if the game develops differently.

Next, the main CPU 200 determines the number of symbols to be rewritten in the appeal rewrite by lottery (step S2317). This step determines the number of symbols to be disposed consecutively in the appeal rewrite. The number of consecutive symbols can be different in each time of display, so that the player can feel as if the game develops differently.

Next, the main CPU 200 executes appeal rewrite (step S2319). In the case of free game mode, the main CPU 200 rewrites the symbols with the symbols determined by the lottery. In the case of re-spin feature game mode, the main CPU 200 rewrites the symbols with the same symbols as the maintained mighty symbol.

Next, the main CPU 200 determines whether both of the replacement reel strips 3x-a and 3x-e have been rewritten (step S2321). Performing steps S2311 to S2319 separately for the replacement reel strips 3x-a and 3x-e enables different appeal rewrite.

If the determination is that both of the replacement reel strips 3x-a and 3x-e have not been rewritten, the main CPU 200 returns to step S2311; if the determination is that both of the replacement reel strips 3x-a and 3x-e have been rewritten, the main CPU 200 exits this subroutine.

As mentioned above, the present embodiment provides an example in which appeal rewrite is applied only to the two replacement reel strips 3x-a and 3x-e; however, the appeal rewrite can be applied to the other replacement reel strips 3x or normal reel strips 3n.

### <Symbol Display Control Processing>

FIG. 26 is a flowchart of symbol display control processing for the slot machine 10.

The main CPU 200 stacks the normal reel strips 3n-a to 3n-e and the replacement reel strips 3x-a to 3x-e and starts scrolling the reel strips in the symbol display area 141d of the lower display unit 141 (step S2411).

The slot machine 10 stacks the normal reel strip 3n-a and the replacement reel strip 3x-a, stacks the normal reel strip 3n-b and the replacement reel strip 3x-b, stacks the normal reel strip 3n-c and the replacement reel strip 3x-c, stacks the normal reel strip 3n-d and the replacement reel strip 3x-d, and stacks the normal reel strip 3n-e and the replacement reel strip 3x-e to display the reels. When the stacked normal reel strips 3n and replacement reel strips 3x are displayed and there is no need to distinguish between the normal reel strips 3n and the replacement reel strips 3x, the reels are merely referred to as video reels 3a to 3e.

When the symbols are scrolled in the symbol display area 141d, the CHANGE and M_CHANGE symbols on the replacement reel strips 3x have been replaced by element symbols through the replacement symbol lottery processing in FIG. 24.

If an element symbol on a replacement reel strip 3x that has replaced a CHANGE or M_CHANGE symbol and an element symbol on a normal reel strip 3n are stacked, the element symbol on the replacement reel strip 3x is displayed selectively. If a BLANK symbol on a replacement reel strip 3x and an element symbol on a normal reel strip 3n are staked, the element symbol on the normal reel strip 3n is displayed selectively.

The main CPU 200 stops part of the video reels 3a to 3e based on the to-be stopped symbols stored in the symbol storage area in the main RAM 210 at steps S2115 and S2121 (step S2413).

The main CPU 200 determines whether all the video reels 3a to 3e have been stopped (step S2415).

If the determination is that all the video reels 3a to 3e have not been stopped, the main CPU 200 returns to step S2413.

If the determination is that all the video reels 3a to 3e have been stopped, the main CPU 200 stores all the rearranged symbols to the main RAM 210 (step S2417).

Next, the main CPU 200 determines whether any winning pattern is completed with reference to the payout table in FIG. 13, based on the symbols stored in the symbol storage area (step S2419) and exits this subroutine. If some winning pattern is completed, the main CPU 200 determines a prize associated with the number of the kind.

### <Payout Determination Processing>

FIG. 27 is a flowchart of the subroutine of payout determination processing.

First, the main CPU 200 determines the amount of payout based on the prize(s) for the completed winning pattern(s) based on the symbol storage area and payout table (FIG. 13) (step S2511).

Next, the main CPU 200 stores the determined amount of payout to the payout counter in the payout storage area (step S2513) and exits this subroutine.

### <Free Game Mode Processing>

FIG. 28 is a flowchart of the free game mode processing. The free game mode processing is invoked and executed at step S1929 of FIG. 21.

As described above, there are three kinds of free game modes for the free game mode. The slot machine 10 uses different reel strips and provides different number of games depending on the kind of the free game mode, achieving a wide variety in game mechanics.

In the case of the first free game mode, the normal reel strips 3n shown in FIG. 15 and the replacement reel strips 3x shown in FIGS. 18A to 18C are used. In the case of the second free game mode, the normal reel strips 3n shown in FIG. 16 and the replacement reel strips 3x shown in FIGS. 18A to 18C are used. In the case of the third free game mode, the normal reel strips 3n shown in FIGS. 14A and 14B and the replacement reel strips 3x shown in FIGS. 19A to 19C are used.

In the second free game mode, a selection game is conducted in response to completion of a free game trigger or free game retrigger.

Although the slot machine 10 in the present embodiment is capable of providing the first to the third free game modes as described above, the kind of reel strips to be used, the number of games to be played, and the selection game can be combined differently.

Each free game is a slot game (unit game) same as the game in base game mode. The slot game in the free game mode can be started without betting.

First, the main CPU 200 sets the game counter in accordance with the kind of the free game mode (step S2611). In the case of the first free game mode, the main CPU 200 sets 8 to the game counter. In the case of the third free game mode, the main CPU 200 sets 7 to the game counter. In the case of the second free game mode, the main CPU 200 sets the number of games in accordance with the result of the selection game.

Next, the main CPU 200 conducts free game starting effect execution processing (S2613). The presentation effects notify the player of entering free game mode.

Next, the main CPU 200 conducts at-one-game-end initialization processing (step S2615). For example, the main CPU 200 clears data that becomes unnecessary after each game in the working areas of the main RAM 210, such as the amount of bet and the symbols determined by lottery.

Next, the main CPU 200 conducts symbol lottery processing (step S2617). In the processing, to-be stopped symbols are determined based on random numbers for symbol determination.

Next, the main CPU 200 conducts replacement symbol lottery processing illustrated in FIG. 24 (step S2619). Through the replacement symbol lottery processing, all the to-be replaced symbols of CHANGE and M_CHANGE symbols on the replacement reel strips 3x-a to 3x-e are replaced by element symbols.

Next, the main CPU 200 conducts appeal rewrite processing illustrated in FIG. 25 (step S2621). If appeal rewrite is applied, symbols on the replacement reel strips 3x-a and 3x-e are rewritten and a specific kind of symbols are displayed on the video reels 3a and 3e in the symbol display area 141d immediately after start of scrolling the replacement reel strips 3x-a and 3x-e.

Next, the main CPU 200 conducts effect lottery processing (step S2623). Specifically, the main CPU 200 extracts a random number for determination of effects, and determines one of the effect contents from the predefined plurality of effect contents by lottery, and executes the determined effect content with predetermined timing. For example, the main CPU 200 performs control to display a video for presentation effects on the upper liquid crystal display panel 131b, to output audio from a speaker (not shown), to flash a lamp (not shown), and to apply special effects to these. When a free game trigger is completed, and when the player selects free games thereafter, the upper liquid crystal display panel 131b shows a video.

Next, the main CPU 200 conducts the symbol display control processing illustrated in FIG. 26 (step S2625). In this processing, spinning of the five video reels 3a to 3e (scrolling of the five reel strips) is started and the to-be stopped symbols determined in the symbol lottery processing of step S2617 are stopped at the predetermined positions.

Next, the main CPU 200 conducts the payout determination processing illustrated in FIG. 27 (step S2627). In this processing, the main CPU 200 determines an amount of payout for the winning pattern(s) completed with the symbols arranged along the paylines with reference to the payout table (see FIG. 13) and stores the amount to the payout storage area (payout counter) provided in the main RAM 210.

Next, the main CPU 200 conducts payout processing (step S2629).

Next, the main CPU 200 decrements the game count by one (step S2631).

Next, the main CPU 200 determines whether a free game retrigger is completed (step S2633).

If determining that a free game retrigger is completed, the main CPU 200 increases the game count depending on the kind of the free game mode (step S2635). In the first free game mode, the game count is increased by 8. In the third free game mode, the game count is increased by 7. In the second free game mode, the game count is increased in accordance with the result of the selection game.

If the determination is that a free game retrigger is not completed, the main CPU 200 determines whether the game count is more than zero (step S2637).

If the determination at step S2637 is that the game count is more than zero or after step S2635, the main CPU 200 returns to step S2615.

If the determination at step S2637 is that the game count is zero, the main CPU 200 exits this subroutine.

### <Second Free Game Mode>

In the second free game mode, a selection game is conducted in response to completion of a free game trigger or free game retrigger to determine the number of games and the replacement symbol determination table associated with the choice selected by the player.

For example, the selection game provides choices for PICT_A, PICT_B, PICT_C, PICT_D, PICT_E, and “random” for the player to select one of them.

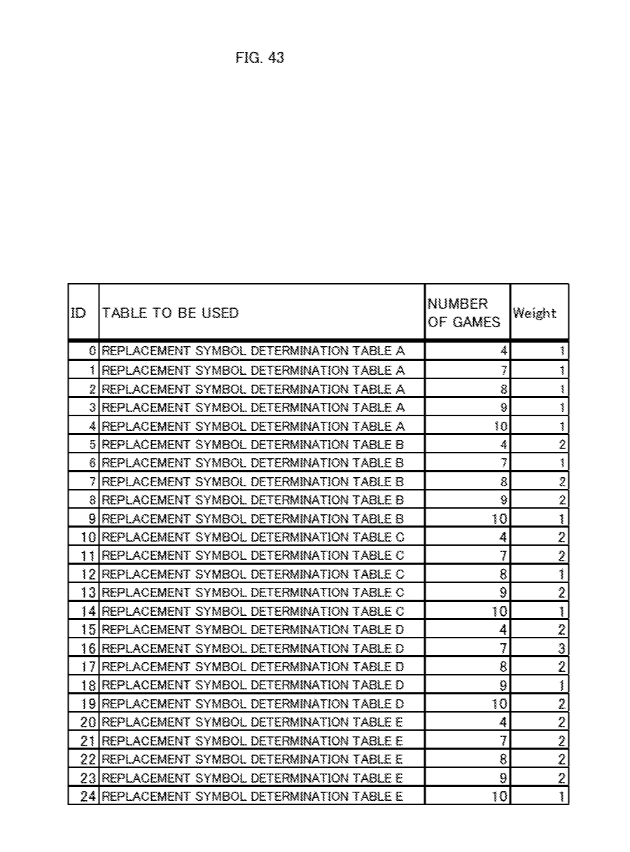

If PICT_A is selected, four games and replacement symbol determination table A (FIG. 42A) are determined. If PICT_B is selected, seven games and replacement symbol determination table B (FIG. 42B) are determined. If PICT_C is selected, eight games and replacement symbol determination table C (FIG. 42C) are determined. If PICT_D is selected, nine games and replacement symbol determination table D (FIG. 42D) are determined. If PICT_E is selected, ten games and replacement symbol determination table E (FIG. 42E) are determined. If “random” is selected, one of four, seven, eight, nine, and ten games is determined at random and one of the replacement symbol determination tables A to E is determined at random (see FIG. 43).

FIG. 43 is a table to be referred to when “random” is selected. An ID is determined with the probabilities in accordance with the weights so that one of the symbol determination tables A to E and the number of games is determined.

The replacement symbol determination tables A to E shown in FIG. 42 are tables to determine a combination of the kind of element symbols to replace the CHANGE symbols on the replacement reel strip 3x-a, the kind of element symbols to replace the M_CHANGE symbols on the replacement reel strips 3x-b to 3x-d, and the kind of element symbols to replace the CHANGE symbols on the replacement reel strip 3x-e, like the replacement symbol determination tables (FIGS. 32A to 32P and FIGS. 33A to 33I).

This configuration enables free game mode to have variation in number of games and prizes caused by replacing symbols, achieving a variety in game progress and exciting the player.

### <Re-Spin Feature Game Mode Processing>

FIG. 29 is a flowchart of re-spin feature game mode processing. The re-spin feature game mode processing is invoked and executed at step S1933 in FIG. 21.

A re-spin feature game is a slot game (unit game) same as the game in base game mode. The re-spin feature game is a kind of free slot game that can be started without betting.

In re-spin feature game mode, one unit game is conducted while the mighty symbol shown at triggering the re-spin feature game mode is maintained (held). Specifically, the slot machine 10 spins two video reels 3a and 3e to conduct one unit game while keep showing the stopped mighty symbol over the video reels 3b to 3d.

First, the main CPU 200 conducts re-spin feature game starting effect execution processing (S2711). The presentation effects notify the player of entering re-spin feature game mode.

Next, the main CPU 200 conducts at-one-game-end initialization processing (step S2713). For example, the main CPU 200 clears data that becomes unnecessary after each game in the working areas of the main RAM 210, such as the amount of bet and the symbols determined by lottery.

Next, the main CPU 200 conducts symbol lottery processing (step S2715). In the processing, to-be stopped symbols are determined based on random numbers for symbol determination.

Next, the main CPU 200 conducts symbol replacement processing (step S2717). In the symbol replacement processing, all the to-be replaced symbols of CHANGE symbols on the two replacement reel strips 3x-a and 3x-e are replaced by symbols of the kind held on the video reels 3b to 3d.

In the case where the game mode changes from base game mode to re-spin feature game mode, a mighty symbol of PICT_A is held on the video reels 3b to 3d. The processing at step S2717 replaces all CHANGE symbols of the to-be replaced symbols on the replacement reel strips 3x-a and 3x-e with PICT_A symbols.

In the case where the game mode changes from free game mode to re-spin feature game mode, a mighty symbol of a kind other than FEATURE is maintained. The processing at step S2717 replaces all CHANGE symbols of the to-be replaced symbols on the replacement reel strips 3x-a and 3x-e with the symbols of the kind other than FEATURE.

Next, the main CPU 200 conducts appeal rewrite processing illustrated in FIG. 25 (step S2719). If appeal rewrite is applied, symbols on the replacement reel strips 3x-a and 3x-e are rewritten. The symbols of the kind replaced at step S2717 are displayed on the video reels 3a and 3e in the symbol display area 141d immediately after start of scrolling the replacement reel strips 3x-a and 3x-e.

Next, the main CPU 200 conducts effect lottery processing (step S2721). Specifically, the main CPU 200 extracts a random number for determination of effects, and determines one of the effect contents from the predefined plurality of effect contents by lottery, and executes the determined effect content with predetermined timing. For example, the main CPU 200 performs control to display a video for presentation effects on the upper liquid crystal display panel 131b, to output audio from a speaker (not shown), to flash a lamp (not shown), and to apply special effects to these. When a free game trigger is completed, and when the player selects free games thereafter, the upper liquid crystal display panel 131b shows a video.

Next, the main CPU 200 conducts the symbol display control processing (step S2723). In this processing, spinning of only the two video reels 3a and 3e is started and after a predetermined time, the two video reels 3a and 3e are stopped. The processing at step S2723 controls the two video reels 3a and 3e to stop so that the to-be stopped symbols determined in the symbol lottery processing of step S2715 will stop at the predetermined positions.

As shown in FIGS. 17A to 17C, FIGS. 18A to 18C, and FIGS. 19A to 19C, the replacement reel strips 3x-a and 3x-e include CHANGE symbols consecutively. All the consecutive CHANGE symbols are replaced by symbols of the same kind as the symbol held on the video reels 3b to 3d, so that the symbols that replace the CHANGE symbols will appear with high probability when the spinning video reels 3a and 3e are stopped.

Next, the main CPU 200 conducts the payout determination processing illustrated in FIG. 27 (step S2725). In this processing, the main CPU 200 determines an amount of payout for the winning pattern(s) completed with the symbols arranged along the paylines with reference to the payout table (see FIG. 13) and stores the amount to the payout storage area (payout counter) provided in the main RAM 210.

Next, the main CPU 200 conducts payout processing (step S2727).

### <Specific Example of Appeal Rewrite in Re-Spin Feature Game Mode>

FIG. 40 is a diagram for illustrating the concept of appeal rewrite in re-spin feature game mode.

In base game mode, appearance of the entirety of a mighty symbol of PICT_A over the video reels 3b to 3d triggers re-spin feature game mode. In free game mode, appearance of the entirety of a mighty symbol of a kind other than FEATURE over the video reels 3b to 3d triggers re-spin feature game mode.

After entering re-spin feature game mode, a unit game is conducted while maintaining (holding) the state showing the mighty symbol (of an element symbol) when the re-spin feature game mode is triggered (see FIG. 40(a-1)). In the example of FIG. 40(a-1), a circular symbol is maintained as a mighty symbol.

Before start of scrolling, symbols upstream of the base position on each of the replacement reel strips 3x-a and 3x-e are rewritten with the same kind of element symbols as the maintained symbol (circular symbol) (see FIG. 40(a-2)). The base position is a position distant from the top end of the symbol display area 141d by a specific number of frames determined at step S2315 in the appeal rewrite processing in FIG. 25. The number of consecutive symbols is determined at step S2317.

Upon start of scrolling, the symbols (circular symbols) rewritten in the appeal rewrite processing are immediately displayed in the symbol display area 141d (see FIG. 40(a-3)).

When the scrolling is stopped, symbols are rearranged so that the replacement reel strips 3x-a and 3-e show a plurality of element symbols (circular symbols) and the replacement reel strips 3x-b to 3x-d show a mighty symbol of the element symbol (circular symbol) (see FIG. 40(a-4)).

In the meanwhile, symbols on the normal reel strips 3n-a to 3n-e are determined to be rearranged to show various element symbols in the symbol display area 141d as shown in FIG. 40(b). If a post-replacement element symbol on a replacement reel strip 3x and a symbol on a normal reel strip 3n are stacked, the post-replacement element symbol on the replacement reel strip 3x is selectively displayed in the symbol display area 141d as shown in FIG. 40(a-4).

### Specific Example of Symbol Display

As illustrated in FIG. 34, fifteen stop positions of five columns by three rows are defined in the symbol display area 141d. Stopping a symbol at each of the fifteen stop positions leads to rearrangement of 15 symbols. FIG. 34 omits to show the symbols but shows only the cells of the stop positions.

### Specific Example 1 of Displaying Mighty Symbol

The slot machine 10 may show a mighty symbol. The mighty symbol has a size corresponding to nine frames of symbols of three columns by three rows. FIG. 35A provides an example where the entirety of a mighty symbol is displayed in the symbol display area 141d when all the symbols are rearranged upon stop of the five video reels 3a to 3e. FIGS. 35B and 35C provide examples where a part of a mighty symbol is displayed in the symbol display area 141d. In FIGS. 35A to 35C, the mighty symbol is denoted by a big circle and the other symbols are denoted indistinguishably.

Appearance of the entirety of one FEATURE symbol as a mighty symbol in base game mode triggers free game mode. Appearance of the entirety of one PICT_A symbol as a mighty symbol in base game mode triggers re-spin feature game mode. Appearance of the entirety of one symbol other than a FEATURE as a mighty symbol in free game mode triggers re-spin feature game mode.

The free game trigger or the re-spin feature game trigger requires appearance of the entirety of the mighty symbol as shown in FIG. 35A. Accordingly, even if a part of a mighty symbol is displayed as shown in FIG. 35B or 35C, no trigger is completed.

The FEATURE is a scatter symbol. Accordingly, appearance of the entirety of a FEATURE symbol as shown in FIG. 35A completes a winning pattern, so that providing a prize is determined (see FIG. 13).

### Specific Example 2 of Displaying Mighty Symbol

There are cases to display a mighty symbol of WILD. FIG. 36A provides an example where a part of the mighty symbol of WILD is displayed in the symbol display area 141d when all the symbols are rearranged upon stop of the five video reels 3a to 3e. If the mighty symbol of WILD is displayed, the mighty symbol is divided to be shown as a plurality of normal-sized WILD symbols as illustrated in FIG. 36B; the main CPU 200 determines whether any winning pattern is completed along individual activated paylines.

As illustrated in FIG. 36A, in the case where a mighty symbol of WILD is displayed, the entirety of the mighty symbol does not need to be displayed. Determination whether any winning pattern is completed can be made even if the mighty symbol is partially displayed.

In FIGS. 36A and 36B, the WILD symbols are denoted by text and the other symbols are denoted indistinguishably.

### Specific Example 3 of Displaying Mighty Symbol

Appearance of the entirety of one PICT_A symbol as a mighty symbol in base game mode, as illustrated in FIG. 37A, triggers re-spin feature game mode. After entering re-spin feature game mode, only two video reels 3a and 3e are spun again as illustrated in FIG. 37B. The mighty symbol of PICT_A is kept shown still.

When the two video reels 3a and 3e are stopped, normal-sized PICT_A symbols are shown on the two video reels 3a and 3e as illustrated in FIG. 37C and determination whether any winning pattern is completed is made along each activated payline. In this case, the mighty symbol of PICT_A is not divided into normal-sized symbols to maintain the size of the mighty symbol.

Appearance of the entirety of a symbol of a kind other than FEATURE as a mighty symbol in free game mode triggers re-spin feature game mode. The same applies to this case; the two reels are spun as illustrated in FIGS. 37A to 37C.

In FIGS. 37A to 37C, the PICT_A symbols or the symbols of the kind other than FEATURE are denoted by triangles and the other symbols are denoted indistinguishably.

An embodiment of the present invention has been described as above.

In gaming machines, whether a winning pattern is completed is determined with the kinds and arrangement of symbols rearranged after being scrolled. If a winning pattern is completed, a prize is provided to the player. Accordingly, players expect completion of winning patterns as many as possible in playing games.

There exists a gaming machine having a reel strip with a same kind of symbols disposed consecutively to show the consecutive symbols in rearrangement (for example, refer to US Patent Application Publication No. 2014/094250). Rearranging the consecutive symbols produces possibility of simultaneous completion of winning patterns on multiple paylines. Completion of winning patterns on multiple paylines leads to more prizes; the players feel more expectation.

There exists another gaming machine having a reel strip including symbols designed to be continued along the longitudinal direction (for example, US Patent Application Publication No. 2014/094251), to increase the presentation effects. The reel strip of this gaming machine is designed in such a manner that a plurality of consecutive symbols are continuous; the reel strip can visually attract the player's interest when the reel strip is either being scrolled or stopped.

As described above, a reel strip including a plurality of consecutive symbols designed to be continuous visually attracts the player's interest. Accordingly, an approach to show a wide symbol over a plurality of reel strips can be conceived of, by extension of the foregoing.

Each payline to determine whether any winning pattern is completed is defined over a plurality of reel strips. To provide more prizes, multiple paylines are formed over the plurality of reel strips. Accordingly, a symbol laying over a plurality of reel strips has more chance to overlap with a plurality of paylines. A symbol lying over a plurality of reel strips equals the same kind of symbols aligned in a horizontal direction; appearance of such a symbol over a plurality of reel strips increases the chance to simultaneously complete multiple winning patterns on a plurality of paylines.

However, whether a winning pattern is finally completed is not determined only with the appearance of the symbol over a plurality of reel strips. Completion of a winning pattern depends on the arrangement of the symbols shown on the other reel strips. Accordingly, even if the symbol over a plurality of reel strips appears, no winning pattern may be completed. When no winning pattern is completed, the symbol shown over the plurality of reel strips is merely a visually distinctive symbol and does not contribute to the player's benefit.

The present invention is accomplished in view of the foregoing issues; an object of the present invention is to provide a gaming machine that, in response to appearance of a symbol over a plurality of reel strips, increases the chance to complete winning patterns by controlling the symbols to appear on the remaining reel strips and further notifies the player of the chance.

The fifth aspect of the present invention is a gaming machine comprising:

a symbol display device capable of rearranging a plurality of types of symbols to show a game result in a display area;

a controller capable of executing a game by scrolling symbol arrays along scroll lines of the symbol display device, each of the symbol arrays being composed of a plurality of symbols; and

a memory holding data of the plurality of symbols included in the symbol arrays.

The plurality of types of symbols include element symbols that are capable of completing a winning pattern and to-be replaced symbols that are to be replaced by element symbols;

the scroll lines include:
a scroll line of a first type, and
a plurality of scroll lines of a second type different from the first type of scroll line;

the symbol arrays include:
a symbol array for the first type of scroll line that is to be scrolled along the first type of scroll line, and
symbol arrays for the second type of scroll lines that are to be scrolled along the second type of scroll lines;

symbols included in the symbol array for the first type of scroll line are displayed in a first display manner to show the symbols on the scroll line;

symbols included in the symbol arrays for the second type of scroll lines are displayed in a second display manner to show a plurality of symbols as one symbol over the second type of scroll lines; and

the controller is programmed to perform the following processing of:
(5-1) symbol lottery processing to determine to-be stopped symbols,
(5-2) element symbol lottery processing to select a kind of element symbols from a plurality of kinds of element symbols,
(5-3) replacement processing to replace the to-be replaced symbols included in the symbol array for the first type of scroll line and the symbols arrays for the second type of scroll lines with element symbols of the kind selected in the element symbol lottery processing,
(5-4) re-array processing to re-array the symbol array for the first type of scroll line by consecutively disposing the same kind of element symbols as the element symbols used as replacement symbols in the replacement processing along the first type of scroll line from a base position distant from the display area by a predetermined number of symbols, and
(5-5) starting scrolling the symbol arrays along the first type of scroll line and the second type of scroll lines after executing the re-array processing.

The symbol array for the first type of scroll line is re-arrayed by consecutively disposing the same kind of element symbols as the element symbols used as replacement symbols along the first type of scroll line from a base position distant from the display area of the symbol display device by a predetermined number of symbols and then, is scrolled. As a result, the element symbols are successively shown immediately after the start of the scrolling. The player becomes aware of a high possibility that the element symbols will be continuously arranged to complete a winning pattern.

The sixth aspect of the present invention is the gaming machine in the fifth aspect of the present invention, in which the re-array processing of the processing (5-4) includes the processing of:

(6-1) symbol re-array determination lottery processing to determine whether to re-array the symbol array for the first type of scroll line with a predetermined probability of a hit, and
(6-2) re-array lottery processing to determine a position for the base position and number of element symbols to be disposed consecutively.

The seventh aspect of the present invention is the gaming machine in the fifth aspect of the present invention, in which,

the plurality of types of symbols further include blank symbols that are involved with neither completion of winning patterns nor symbol replacement;

the symbol array for the first type of scroll line and the symbol arrays for the second type of scroll lines include:
normal symbol arrays composed of element symbols, and
replacement symbol arrays composed of blank symbols and to-be replaced symbols;

the replacement symbol arrays include a plurality of to-be replaced symbols consecutively;

the replacement processing of the processing (5-3) is to replace all the to-be replaced symbols on the replacement symbol arrays with element symbols of the kind selected in the element symbol lottery processing of the processing (5-2); and

the scrolling the symbol arrays in the processing of (5-5) is scrolling the symbol arrays along the first type of scroll line and the second type of scroll lines while stacking the symbols of the normal symbol arrays and the symbols of the replacement symbol arrays after the replacement processing.

All the consecutive to-be replaced symbols are replaced by element symbols. Accordingly, some of the element symbols will be rearranged on the symbol display device to complete multiple winning patterns simultaneously with high probability.

The eighth aspect of the present invention is the gaming machine in the sixth aspect of the present invention, in which,

the controller is programmed to further perform the following processing of:

(8-1) in a case where an entirety of an element symbol of a specific kind is shown in the display area as a result of displaying element symbols of the specific kind in the symbol arrays for the second type of scroll lines in the second display manner, performing the symbol re-array determination lottery processing to select the specific kind of element symbols with a probability higher than the predetermined probability of a hit,

(8-2) in a case of a hit in the symbol re-array determination lottery processing, performing the re-array processing to re-array the symbol array for the first type of scroll line by consecutively disposing the specific kind of element symbols along the first type of scroll line from the base position,

(8-3) scrolling the symbol arrays for the first type of scroll line while maintaining a stopped state showing the entirety of the specific kind of element symbol in the display area as a result of displaying element symbols of the specific kind in the symbol arrays for the second type of scroll lines in the second display manner, and

(8-4) when a predetermined time has passed after the processing of (8-3), stopping the symbol arrays to show the specific kind of element symbols in the symbol arrays on the first type of scroll line in the first display manner based on a result of the symbol lottery processing.

In a case where the entirety of an element symbol of a specific kind is shown in the display area as a result of displaying element symbols of the specific kind in the symbol arrays for the second type of scroll lines in the second display manner, the symbol arrays for the first type of scroll line are scrolled and stopped while maintaining a stopped state showing the entirety of the specific kind of element symbol in the display area. This configuration increases the possibility of completion of a winning pattern of the specific kind of element symbol when the scrolling of the symbol arrays of the first type of scroll line and the second type of scroll lines are stopped.

Before the stop of the scrolling of the symbol arrays of the first type of scroll line and the second type of scroll lines, the symbol array for the first type of scroll line is re-arrayed to include the specific kind of element symbols consecutively and scrolled. As a result, the element symbols are successively shown immediately after the start of the scrolling. The player becomes aware of a high possibility that the element symbols will be continuously arranged to complete a winning pattern.

The ninth aspect of the present invention is the gaming machine in the eighth aspect of the present invention, in which,

the processing (8-4) includes the following processing of:

(9-1) replacing symbols in the symbol array for the first type of scroll line with the same kind of element symbols as the specific kind of element symbol the entirety of which is displayed in the second display manner in the display area in the processing of (8-3) and stopping the symbol arrays based on a result of the symbol lottery processing.

Since symbols are replaced by the same kind of element symbols as the specific kind of element symbol the entirety of which is displayed in the second display manner, winning patterns can be completed with high probability.

1. A gaming machine comprising:
a symbol display device capable of displaying a game result by rearranging a plurality of types of symbols using a first display manner to show a symbol on a scroll line and a second display manner to show a plurality of symbols as one symbol over a plurality of scroll lines;
a controller capable of executing a game by controlling the symbol display device to scroll symbol arrays including a plurality of symbols;
an input device capable of inputting an instruction to select one or more paylines to be activated from a plurality of paylines associated with the symbol display device; and
a memory holding data of symbols included in the symbol arrays,
wherein the plurality of types of symbols include element symbols that are capable of completing a winning pattern and to-be replaced symbols that are to be replaced by element symbols,
wherein the controller is programmed to perform the following processing of:
(1-1) symbol lottery processing to determine to-be stopped symbols;
(1-2) element symbol lottery processing to select a kind of element symbols from a plurality of kinds of element symbols based on a number of paylines activated with the input device;
(1-3) symbol array reconfiguration processing to configure symbol arrays to be displayed by replacing the to-be replaced symbols included in the symbol arrays with the element symbols selected in the element symbol lottery processing of the processing (1-2);
(1-4) starting scrolling the to-be displayed symbol arrays while showing element symbols of the kind selected in the element symbol lottery processing of the processing (1-2) in the second display manner; and
(1-5) providing a prize based on a payline that completes a winning pattern.

2. The gaming machine according to claim 1,
wherein the scroll lines include a scroll line of a first type for showing the symbols in the first display manner and scroll lines of a second type for showing at least part of the symbols in the second display manner, and
wherein the memory further holds a symbol selection probability table that specifies probabilities to select a combination of a kind of element symbols for the first type of scroll line and a kind of element symbols for the second type of scroll lines depending on the number of paylines.

3. The gaming machine according to claim 2,
wherein the to-be replaced symbols include:
a first kind of to-be replaced symbols disposed on the first type of scroll line and to be shown in the first display manner; and
a second kind of to-be replaced symbols disposed on the second type of scroll line and to be shown in the second display manner, and
wherein the symbol array reconfiguration processing of the processing (1-3) includes:
replacing the first kind of to-be replaced symbols on the first type of scroll line with the selected kind of element symbols shown in the first display manner; and
replacing the second kind of to-be replaced symbols on the second type of scroll line with the selected kind of element symbols shown in the second display manner.

4. The gaming machine according to claim 1,
wherein the plurality of types of symbols further include blank symbols that are involved with neither completion of winning patterns nor symbol replacement,
wherein the symbol arrays include symbol arrays of a first type including element symbols and symbol arrays of a second type including blank symbols and to-be replaced symbols,
wherein the symbol array reconfiguration processing of the processing (1-3) is to configure the second type of symbol arrays to be displayed by replacing the to-be replaced symbols on the second type of symbol arrays with element symbols selected in the element symbol lottery processing of the processing (1-2), and
wherein the scrolling the symbol arrays in the processing (1-4) includes:
stacking the symbols on the first type of symbol arrays and the symbols on the second type of symbol arrays to be displayed in scrolling the symbol arrays;
selectively showing an element symbol on a to-be displayed symbol array of the second type in a case where an element symbol on a symbol array of the first type and the element symbol on the to-be displayed symbol array of the second type are stacked; and
selectively showing an element symbol on a symbol array of the first type in a case where the element symbol on the symbol array of the first type and a blank symbol on a to-be displayed symbol array of the second type are stacked.
